(19) United States
(12) Patent Application Publication
(10) Pub. No.: US 2026/0294734 A1
(43) Pub. Date: Oct. 1, 2026

(54) ADJUSTABLE AMPLITUDE PERCUSSIVE THERAPY DEVICE

(71) Applicant: Nice Recovery Systems LLC, Boulder, CO (US)

(72) Inventors: Joel Meisinger, Boulder, CO (US); Michael Ross, Boulder, CO (US); Robert Marton, Yorba Linda, CA (US)

(21) Appl. No.: 19/696,721

(22) Filed: Jun. 3, 2026

Related U.S. Application Data
(63) Continuation-in-part of application No. 19/243,437, filed on Jun. 19, 2025.
Application No. 19/243,437 is a continuation-in-part of application No. 19/006,733, filed on Dec. 31, 2024.
Application No. 19/006,733 is a continuation-in-part of application No. 18/639,547, filed on Apr. 18, 2024.
Application No. 18/639,547 is a continuation-in-part of application No. PCT/US23/28834, filed on Jul. 27, 2023.
Application No. PCT/US23/28834 is a continuation of application No. 17/874,842, filed on Jul. 27, 2022, now abandoned.

(51) Int. Cl. A61H 23/00; A61H 23/02

(52) U.S. Cl. CPC A61H 23/006; A61H 23/02; A61H 23/0254; A61H 23/0263; A61H 2201/0153; A61H 2201/0165; A61H 2201/123; A61H 2201/1472; A61H 2201/149; A61H 2201/1664; A61H 2201/5053

(57) ABSTRACT

An electronic device for percussive massage therapy is described. The device includes a reciprocating member configured to move at any number of different amplitudes and frequencies. In one example of the device of the present invention, the device is configured with a number of gears which permit amplitude to be varied between a great number of amplitudes within a predetermined range. In another example of the device of the present invention, a connector box, a solenoid, a slip ring, a motor, a lead screw, a connecting rod, and a piston are provided. In this particular example, the connector box may route energy to the solenoid to cause the solenoid to engage the slip ring to allow the motor to cause rotation of the lead screw to adjust stroke of the piston.

### CROSS-REFERENCE TO RELATED APPLICATIONS

This application is a continuation-in-part application claiming priority to U.S. application Ser. No. 19/243,437, filed Jun. 19, 2025, which is based on and claims priority to U.S. application Ser. No. 19/006,733, filed on Dec. 31, 2024, which is based on and claims priority to U.S. application Ser. No. 18/639,547, filed on Apr. 18, 2024, which is based on and claims priority to PCT Application PCT/US23/28834, filed on Jul. 27, 2023, which is based on and claims priority to U.S. application Ser. No. 17/874,842, filed on Jul. 27, 2022. The aforementioned applications are hereby incorporated by reference as if fully recited herein.

### TECHNICAL FIELD

The present invention relates generally to an electronic device for massage therapy, and more particularly to a hand-held massage therapy device adapted to permit movement of a reciprocating member to be varied between a great number of different amplitudes. In one example embodiment, the device is configured with a number of gears, including a planetary gear, a ring gear, and a positioning gear permitting amplitude to be varied in real time between a plurality of amplitudes. In some alternative embodiments, the reciprocating member is adapted to vibrate to permit vibration therapy. In another example embodiment, the device is configured with a threaded stroke adjustment apparatus that may be rotated for stroke of a piston to be adjusted. In another example embodiment, the device is configured with a connector box, a solenoid, a slip ring, a motor, a lead screw, a connecting rod, and a piston. The connector box may be configured to route energy to the solenoid to cause the solenoid to engage the slip ring to allow the motor to cause rotation of the lead screw to adjust stroke of the piston.

### BACKGROUND AND SUMMARY OF THE INVENTION

Traditionally, massage therapy has been performed by hand or with non-motorized devices or apparatuses. An issue with traditional massage therapy is the human ability to engage tissues at certain speeds, ranges of motion, patterns, some combination thereof, or the like is limited. Another issue with traditional massage therapy is an individual, namely a massage therapist, is required to perform the massage therapy. The development of motorized massage machines has enabled massage therapy to occur without the same speed, range of motion, pattern, or the like restrictions present with traditional massage therapy, and without the need for an individual, such as a massage therapist, to perform the massage therapy. A non-limiting example of a motorized massage machine is a percussive therapy massage apparatus. A percussive therapy massage apparatus is an apparatus having a reciprocating member having a distal end configured to apply a force to a tissue during each reciprocation of the member. One advantage of therapy involving a percussive therapy massage apparatus (referred to herein as “percussive massage therapy”) is that a substantial number of forces to a tissue may be exerted over a short amount of time to promote certain muscle benefits.

An issue with prior art percussive massage therapy is that the prior percussive therapy massage apparatuses (referred to herein as “prior apparatuses”) are limited to either no options for varying amplitude (also referred to herein as “stroke”), or only a small, finite number of options for varying stroke, where amplitude/stroke is defined as the maximum difference in distance of the position of the front of the reciprocating member when the member is in an extended position compared to a retracted position. This issue may limit a user's ability to experience a specific desired stroke based on any number of different treatment requirements or preferences. Another issue with prior art percussive massage therapy is that the prior apparatuses generally involve many component parts operating according to largely complex gearing mechanisms, which may be loud while in operation. This issue may lead to unwanted noise levels, and high manufacturing costs and labor, repair costs and labor, energy requirements, space usage requirements, device weight, some combination thereof, or the like for the apparatuses beyond optimal parameters. Yet another issue with prior apparatuses is that prior apparatuses lack combined real time stroke and frequency adjustment control, where frequency is defined as the number of pulses or percussions (achieved when the reciprocating member moves from a retracted position to an extended position and back to a retracted position) occurring in a certain amount of time. This issue may limit a user's ability to adjust stroke and frequency during treatment to, for example, maintain muscle comfort during treatment, increase forces applied to tissues after loosening up the tissues with smaller and/or less prevalent forces to maximize treatment efficiency, some combination thereof, or the like. Yet another issue with prior apparatuses is that prior apparatuses lack components adapted to mitigate impacts on tissue (e.g., to reduce the risk of tissue damage). Yet another issue with prior apparatuses is that the prior apparatuses lack the functionality to adjust stroke automatically without manual user input.

The aforementioned shortcomings speak to the need for a percussive therapy device configured with adjustable amplitude and adjustable frequency, wherein adjustments may occur in real time, including for example, during an ongoing therapy session without need of stopping the ongoing operation of the device to change settings.

The aforementioned shortcomings also speak to the need for a cost-effective, user friendly percussive therapy device involving optimal component parts operating at low noise levels, permitting tissue impact mitigation, and allowing stroke to be adjusted automatically.

It is an object of the present invention to provide a lightweight, durable and affordable percussive therapy device useful for promoting and maintaining muscle comfort, health, strengthening, flexibility, pain management, increased range of muscle motion, some combination thereof or the like.

In view of the prior art shortcomings and the aforementioned object, exemplary embodiments of the present invention provide an adjustable amplitude percussive therapy device.

According to the present invention in one aspect, a real time adjustable amplitude and adjustable frequency percussive therapy device comprises a piston defining a reciprocating member, a handle permitting a user to hold the device, and a housing surrounding a plurality of gears (also referred to herein as a “gear assembly”) positioned on or in close proximity to a frame, a connecting rod, and at least one motor. The plurality of gears may include a planetary gear positioned adjacent to idler gears, rollers, some combination thereof, or the like (referred to herein collectively or independently as “cushioning devices”) wherein the cushioning devices may be adapted to maintain the planetary gear in a substantially central position with respect to the gear assembly. The idler gears, rollers, some combination thereof, or the like may be positioned adjacent to an interior circumference of a ring gear, and above an eccentric drive unit linked to a drive motor. In preferred embodiments, a therapy feature, such as, for example, an attachment having an ellipsoidal or substantially spherical surface, may be positioned at or near a distal end of the reciprocating member and adapted to contact the body of a user. A worm gear, threaded shank, or the like (independently or collectively, “positioning gear(s)”) may be adapted to engage the ring gear directly or indirectly (e.g., engage a ring gear retainer connected to the ring gear) to dictate the stroke of the piston between an infinite number of different strokes within a predetermined range.

A drive motor axle may be adapted to cause rotation of an eccentric drive unit attached thereto, the eccentric drive unit having an off-center axle configured to contact the planetary gear and contribute to movement thereof. An off-center axle of the planetary gear may be adapted to be received by a first bearing of a connection rod (also referred to herein as a “connecting rod”) at a first end of the connection rod, wherein the bearing may be useful to reduce friction between the off-center axle and the connecting rod. The planetary gear may comprise a plurality of gear teeth around a perimeter thereof adapted to engage corresponding gear teeth positioned along an inner circumference of the ring gear. A second bearing of the connection rod, positioned at a second end of the connection rod opposite of the first end, may include an attachment member positioned therein adapted to connect the connection rod to the piston. It will be apparent to one of ordinary skill in the art that any number of different motors may be employed to actuate an exemplary eccentric drive unit without departing from the scope of the present invention.

A lubricated bushing may substantially surround a circumference of the piston, and the lubricated bushing may be adapted to cause the piston to move in a linear fashion. Rotation of the eccentric drive unit caused by the drive motor may cause the planetary gear to rotate and orbit along the inner circumference of the ring gear. The aforementioned movement of the planetary gear may cause the planetary gear off-center axle to move in a substantially ellipsoidal or substantially linear path, which may cause movement of the connecting rod which may drive the piston in a linear, reciprocating motion resulting in a stroke thereof. The drive motor may be adapted to cause the eccentric drive unit to rotate at any number of different velocities. Rotation of the eccentric drive unit may be adjusted in real time, including, for example, during an ongoing percussive therapy session, by a central controller. Adjusting rotation of the eccentric drive unit in real time may directly change the reciprocating member movement frequency in real time.

The worm gear, threaded shank, or the like may be configured to cause rotation of the ring gear in real time, including for example, during an ongoing percussive therapy session. Rotation of the ring gear in real time may cause movement of the planetary gear axle to be repositioned in real time between an infinite number of different pathways (within a predetermined range), resulting in an infinite number of different available strokes within a predetermined range. Movement of the worm gear, threaded shank, or the like (for actuating the ring gear) may be achieved by a button, a stepper motor, a rotatable dial, a rotatable nob, a touch screen control, some combination thereof, or the like.

According to the present invention in another aspect, a motor (e.g., a stepper motor) may cause simultaneous rotation of a motor shaft, an eccentric drive unit, and a planetary gear. A positioning gear (e.g., a worm gear controlled by a stepper motor) may cause simultaneous rotation of a ring gear, ring gear retainer, eccentric drive unit, motor, and a planetary gear. Idler gears may be provided, but such is not required. Assembly and rotation of the motor and gear assembly (e.g., rotation caused by a positioning gear such as a worm gear) may permit control of tolerances between the gears and the motor. The ring gear and the planetary gear may comprise helical gears. The connection rod may be substantially curved in shape such that a first end of the connection rod is positioned higher up than a second end of the connection rod substantially opposite of the first end. The motor and gear assembly may be collectively isolated within an exemplary device (e.g., for noise control).

It will be apparent to one of ordinary skill in the art that an exemplary positioning gear may be any number of different shapes and/or sizes without departing from the scope of the present invention. It will further be apparent to one of ordinary skill in the art that each of the aforementioned gears may be any number of different shapes and/or sizes without departing from the scope of the present invention. It will also be apparent to one of ordinary skill in the art that the present invention may further comprise any number of other different gears without departing from the scope of the present invention. It will additionally be apparent to one of ordinary skill in the art that any number of different modifications to the exemplary gear configurations described herein may be made without departing from the scope of the present invention.

With exemplary embodiments, therapeutic effects/benefits to muscle comfort, tissue health, muscle strengthening, increasing range of muscle motion, tissue flexibility, pain management, some combination thereof, or the like may be achieved in a fraction of the time required to achieve such benefits with traditional massage therapy. The exemplary option to vary stroke in real time between a great many different available strokes, and to vary frequency in real time may permit a user to, for example, loosen up muscles with a smaller amplitude and/or frequency strokes and then maximize treatment efficiency by contacting loosened up muscles with larger amplitude and/or higher frequency strokes later on during a single percussive therapy session.

As another non limiting example, the exemplary option to vary stroke in real time between a great number of different available strokes, and to vary frequency in real time may permit a user to adjust amplitude and/or frequency as preferred during the duration of a single percussive therapy session to achieve and/or maintain a desired muscle comfort level as the session progresses. In the aforementioned example, if a user is not yet feeling anticipated sensations from percussive therapy, the user may increase amplitude and frequency of the reciprocating member to large parameters to increase muscle impacts without first having to end the session. In the aforementioned example, where muscle impacts have been significant for an extended amount of time, the user may decrease amplitude and frequency of the reciprocating member to very small parameters without first having to end the session, such as to, for example, prevent adverse effects on muscle fibers. In certain embodiments, stroke and frequency may be specified and/or adjusted according to digital interface programming before and/or during percussive therapy. In certain embodiments, a user may begin with local vibration therapy on a particularly sore muscle group where percussive therapy may be too painful at that time for the sore muscle group. As the vibration therapy session progresses, pain levels at the muscle group may decrease, permitting the user to progress toward percussive therapy to assist with, for example, range of muscle motion and athletic performance.

Exemplary embodiments of the present invention may reduce and/or delay muscle stiffness and soreness after a workout, and contribute to muscle recovery after a workout. Exemplary embodiments may further promote optimal muscle compliance and movement velocity, and acutely increase range of muscle motion. Exemplary embodiments may also be beneficial for loosening muscles, such as for, e.g., performing a warm-up regiment to improve muscle flexibility without losing muscle performance. Exemplary embodiments may additionally contribute to decreased muscle fatigue.

In another example embodiment, the reciprocating member and/or an attachment thereon at a distal end thereof are configured to vibrate (referred to herein as “local vibration therapy”) during percussive therapy. Local vibration therapy, especially in combination with exemplary percussive therapy, may contribute to prevention of delayed onset muscle soreness. Additionally, local vibration therapy, especially in combination with exemplary percussive therapy, may promote muscle power development and performance, flexibility, kinesthetic awareness, range of motion, blood flow, some combination thereof, or the like. Local vibration therapy may also contribute to a reduced risk of rhabdomyolysis.

According to the present invention in yet another aspect, an exemplary adjustable percussive therapy device comprises a motor, a connection rod, a first piston, and a second piston, aligned with and positioned in front of the first piston. The device may further comprise a stroke adjustment apparatus, which may be adapted to receive the second piston. The motor may be configured to cause motion of the connection rod. The connection rod may be configured to cause reciprocal motion of the first piston. The first piston may be configured to cause motion of the second piston. The stroke adjustment apparatus may be configured to be repositioned to permit reciprocal motion of the second piston to be adjusted between a great number of different amplitudes across a range of amplitudes.

The device may further comprise a barrel, wherein the stroke adjustment apparatus may be configured to be repositioned along the barrel to permit reciprocal motion of the second piston to be adjusted between a great number of different amplitudes across a range of amplitudes. The barrel may comprise threads, and the stroke adjustment apparatus may comprise threads capable of engaging the threads of the barrel to permit repositioning of the stroke adjustment apparatus with respect to the barrel. A shock absorbing spring may be positioned between the first piston and the second piston, and may be advantageous for noise control and tissue impact mitigation. A return spring may be positioned at the second piston, and may be configured to cause retraction of the second piston. The motor may be configured to be adjusted to regulate frequency during active operation of the device. A user may manually adjust the stroke adjustment apparatus position (e.g., with one's hand(s)). Alternatively, or additionally, a motor (e.g., a stepper motor) may adjust the positioning of the stroke adjustment apparatus (e.g., based on user input, based on device instructions, such as for a predetermined variable stroke massage session, some combination thereof, or the like).

Stroke adjustment may occur during treatment without having to stop operation of the device. Alternatively, or additionally, stroke adjustment (as well as frequency adjustment) may occur before and/or after the device is in operation.

In another example embodiment, stroke adjustment may be achieved by moving an eccentric drive axle at varying distances with respect to the centerline of a motor. In this particular embodiment, additional drive gears are not required to cause movement of a reciprocating member. The lack of a requirement, for example, for noise-generating drive gear mechanisms, may promote cost efficiency of the device and optimize the complexity of the device, as well as allow the device to operate at low noise levels. The stroke adjustment apparatus of the device may include a spring-engaged adjustment knob in mechanical communication with a stroke adjustment screw. The stroke adjustment screw may be configured to regulate the position of the eccentric drive axle.

In an alternative example embodiment, the stroke of the piston may be adjusted using a stroke adjustment assembly comprising an adjustment drive gear configured to rotate a ring gear to reposition an eccentric drive axle. The stroke adjustment assembly may be repositioned by an adjustment servo before and after stroke adjustment occurs. Stroke may be calculated according to measurements of a positioning sensor. The positioning sensor may measure the distance between the sensor and a target on a connecting rod, and a system processor may use this calculation with known device measurements in an algorithm to determine stroke of the piston. Where current stroke of the piston is different from a desired piston stroke, a system microcontroller may cause stroke to be adjusted until the measured distance between the sensor and the target corresponds to the desired piston stroke. The aforementioned steps may each occur automatically without manual user input.

In another example embodiment, an exemplary adjustable percussive therapy device comprises a connector box, a solenoid, a slip ring, a motor, a lead screw, a connecting rod, and a piston. The connecting rod may be configured to engage in reciprocal motion to cause reciprocal motion of the piston. The connector box may be configured to route energy to the solenoid to cause the solenoid to engage the slip ring to allow the motor to cause rotation of the lead screw to adjust stroke of the piston. The device may further comprise a second motor in mechanical communication with an axle. The second motor may be configured to cause movement of the axle to cause the reciprocal motion of the connecting rod. The axle may be connected to a base unit, and the base unit may be configured to receive the lead screw. The lead screw may be configured to, when rotated, adjust a horizontal position of the axle to adjust the stroke of the piston.

It will be apparent to one of ordinary skill in the art that exemplary embodiments of the present invention may contribute any number of different benefits to muscle comfort, health, strengthening, flexibility, some combination thereof or the like. It will further be apparent to one of ordinary skill in the art that although embodiments described herein relate to a percussive therapy device for promoting and maintaining muscle comfort, health, strengthening, flexibility, some combination thereof or the like, exemplary embodiments may be useful to any number of other different endeavors.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a perspective view of an exemplary embodiment of the present invention;

FIG. 2 illustrates a top plan view of the FIG. 1 embodiment;

FIG. 3 illustrates a right-side, cross-sectional view of the FIG. 1 embodiment;

FIG. 4 illustrates another top plan view of the FIG. 1 embodiment frame, piston, and gear assembly;

FIG. 5 illustrates top plan views of exemplary stroke variability in accordance with the FIG. 1 embodiment;

FIG. 6 illustrates an exploded perspective view of another exemplary embodiment of the present invention;

FIG. 7 illustrates a top plan view of the FIG. 6 embodiment frame, piston, and gear assembly;

FIG. 8 illustrates a first exemplary stroke of the FIG. 6 embodiment;

FIG. 9 illustrates a second exemplary stroke of the FIG. 6 embodiment;

FIG. 10 illustrates a perspective view of another exemplary embodiment of the present invention;

FIG. 11 illustrates a top view of the FIG. 10 embodiment;

FIG. 12 illustrates exemplary logic for various device interfaces in accordance with a preferred embodiment of the present invention;

FIG. 13 illustrates a top view of another exemplary embodiment of the present invention wherein a planetary gear off-center axle is in a first position;

FIG. 14 illustrates a top view of the FIG. 13 embodiment wherein the planetary gear off-center axle is in a second position;

FIG. 15 illustrates a perspective view of yet another exemplary embodiment of the present invention;

FIG. 16 illustrates a perspective view of an interior of the FIG. 15 embodiment, wherein gear assembly retainers are shown;

FIG. 17 illustrates another perspective view of the interior of the FIG. 15 embodiment, wherein gear assembly retainers are not shown;

FIG. 18 illustrates an exploded perspective view of an exemplary gear assembly of the FIG. 15 embodiment;

FIG. 19 illustrates a rear, cross-section elevational view of the FIG. 15 embodiment;

FIG. 20 illustrates a top plan view of the interior of the FIG. 15 embodiment, at minimum stroke;

FIG. 21 illustrates another top plan view of the interior of the FIG. 15 embodiment, at maximum stroke;

FIG. 22 illustrates top plan views of exemplary stroke variability in accordance with the FIG. 15 embodiment;

FIG. 23 illustrates another exploded perspective view of the exemplary gear assembly of FIG. 15;

FIG. 24 illustrates yet another exploded perspective view of the exemplary gear assembly of FIG. 15;

FIG. 25 illustrates a left-side, cross section elevational view of the FIG. 15 embodiment;

FIG. 26 illustrates a top, cross-sectional view of another exemplary percussive therapy device with real time adjustable stroke of the present invention;

FIG. 27 illustrates a top, cross-sectional view of the device of FIG. 26 in a fully retracted, maximum stroke position;

FIG. 28 illustrates a top, cross-sectional view of the device of FIG. 26 in a fully extended, maximum stroke position;

FIG. 29 illustrates a perspective view of yet another exemplary percussive therapy device with real time adjustable stroke of the present invention;

FIG. 30 illustrates another perspective view of the device of FIG. 29;

FIG. 31 illustrates yet another perspective view of the device of FIG. 29;

FIG. 32 illustrates yet another perspective view of the device of FIG. 29;

FIG. 33 illustrates a top, cross-sectional view of the device of FIG. 29 in a fully extended, minimum stroke position;

FIG. 34 illustrates a left-side, cross-sectional view of the device of FIG. 29 in a fully extended, minimum stroke position;

FIG. 35 illustrates a top, cross-sectional view of the device of FIG. 29 in a fully retracted, minimum stroke position;

FIG. 36 illustrates a left-side, cross-sectional view of the device of FIG. 29 in a fully retracted, minimum stroke position;

FIG. 37 illustrates a top, cross-sectional view of the device of FIG. 29 in a fully retracted, maximum stroke position;

FIG. 38 illustrates a left-side, cross-sectional view of the device of FIG. 29 in a fully retracted, maximum stroke position;

FIG. 39 illustrates yet another exemplary percussive therapy device with real time adjustable stroke of the present invention, in a fully extended, maximum stroke position;

FIG. 40 illustrates a left-side, cross-sectional view of the device of FIG. 39 in a fully extended, maximum stroke position;

FIG. 41 illustrates a top, cross-sectional view of the device of FIG. 39 in a fully retracted, maximum stroke position;

FIG. 42 illustrates a left-side, cross-sectional view of the device of FIG. 39 in a fully retracted, maximum stroke position;

FIG. 43 illustrates a perspective view of a low noise adjustable amplitude percussive therapy device of the present invention, in a retracted position;

FIG. 44 illustrates an exploded perspective view of the device of FIG. 43;

FIG. 45 illustrates a pair of left-side, elevational views of the device of FIG. 43 in a fully retracted and fully extended position;

FIG. 46 illustrates a left-side, cross sectional view of the device of FIG. 43 in a fully retracted position;

FIG. 47 illustrates another left-side, cross sectional view of the device of FIG. 43 where an adjustment socket is engaged with a stroke adjustment screw;

FIG. 48 illustrates a top, cross-sectional view of a portion of the device of FIG. 43;

FIG. 49 illustrates a front, elevational view of another portion of the device of FIG. 43;

FIG. 50 illustrates a perspective view of the portion of FIG. 49 of the device of FIG. 43;

FIG. 51 illustrates a perspective view of the adjustment socket of FIG. 47;

FIG. 52 illustrates a left-side, cross sectional view of the device of FIG. 43 in a minimum stroke, retracted position;

FIG. 53 illustrates a left-side, cross sectional view of the device of FIG. 43 in a maximum stroke, retracted position;

FIG. 54 illustrates an exploded perspective view of a portion of the device of FIG. 43;

FIG. 55 illustrates a top, plan view of an eccentric drive axle of the device of FIG. 43;

FIG. 56 illustrates a top, cross-sectional view of the eccentric drive axle of FIG. 55;

FIG. 57 illustrates a pair of front elevational views, a top plan view, and a top, cross-sectional view of portions of an alternative low noise adjustable amplitude percussive therapy device of the present invention;

FIG. 58 illustrates a perspective view of the device of FIG. 57;

FIG. 59 illustrates a perspective, cross-sectional view of the device of FIG. 57 in an active position;

FIG. 60 illustrates another perspective view of the device of FIG. 57, where the device is in an adjustment position;

FIG. 61 illustrates a perspective, cross-sectional view of the device of FIG. 57 in the adjustment position of FIG. 60;

FIG. 62 illustrates another perspective, cross-sectional view of the device of FIG. in the adjustment position of FIG. 60;

FIG. 63 illustrates an exploded perspective view of another low noise adjustable amplitude percussive therapy device of the present invention;

FIG. 64 illustrates a top perspective view of a stroke adjustment assembly of the device of FIG. 63;

FIG. 65 illustrates a bottom perspective view of the stroke adjustment assembly of FIG. 64;

FIG. 66 illustrates a perspective view of the device of FIG. 63 including a frame;

FIG. 67 illustrates another perspective view of the device of FIG. 66 with the frame removed for illustrative purposes, wherein the device is in a first position;

FIG. 68 illustrates another perspective view of the device of FIG. 67 with the frame removed for illustrative purposes, wherein the device is in a second position;

FIG. 69 illustrates a first top view of the device of FIG. 63 in a first position, and a second top view of the device of FIG. 63 in a second position;

FIG. 70 illustrates another top view of the device of FIG. 63;

FIG. 71 illustrates a first rear, cross-sectional view of the device of FIG. 63 in a first position, and a second rear, cross-sectional view of the device of FIG. 63 in a second position;

FIG. 72 illustrates, from left to right, a rear and front perspective view of the device of FIG. 63, wherein the device includes a handle, housing and digital display;

FIG. 73 illustrates, from left to right, a front and rear perspective view of the device of FIG. 72, wherein an upper portion of the housing of the device is shown as transparent for illustrative purposes;

FIG. 74 illustrates another front perspective view of the device of FIG. 72, wherein multiple portions of the housing of the device are shown as transparent for illustrative purposes;

FIG. 75 illustrates a perspective view of another exemplary adjustable amplitude percussive therapy device of the present invention, wherein the roof of the device has been removed for illustrative purposes;

FIG. 76 illustrates a rear, elevational view of the device of FIG. 75;

FIG. 77 illustrates a bottom perspective view of the device of FIG. 75;

FIG. 78 illustrates a top plan view of the device of FIG. 75;

FIG. 79 illustrates a left-side view of the device of FIG. 75, wherein a portion of the device housing is shown as transparent for illustrative purposes;

FIG. 80 illustrates a perspective view of the device of FIG. 75, wherein various portions of the device are shown as transparent for illustrative purposes;

FIG. 81 illustrates another perspective view of the device of FIG. 75, wherein various portions of the device are shown as transparent for illustrative purposes;

FIG. 82 illustrates a perspective view of a central portion of the device of FIG. 75;

FIG. 83 illustrates yet another perspective view of the device of FIG. 75, wherein various portions of the device are shown as transparent for illustrative purposes;

FIG. 84 illustrates another rear view of the device of FIG. 75, wherein a portion of the housing has been removed for illustrative purposes;

FIG. 85 illustrates a left side view of a central portion of the device of FIG. 75; and

FIG. 86 illustrates another perspective view of the central portion of the device of FIG. 75.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

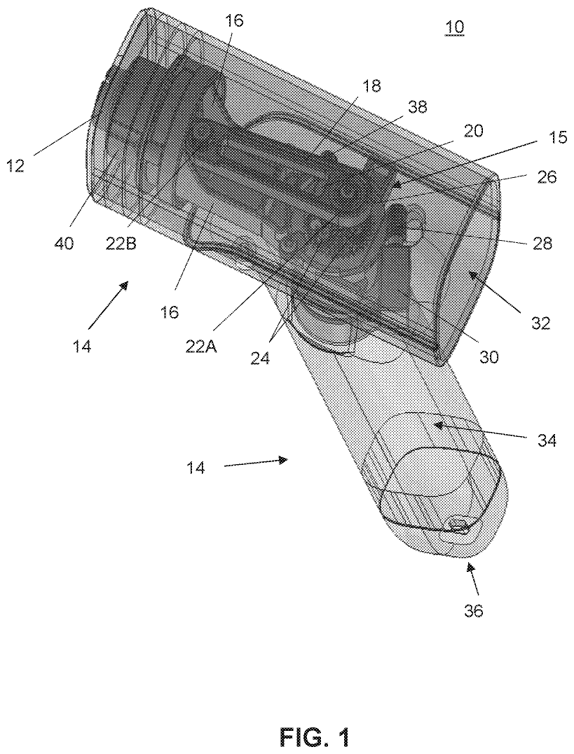

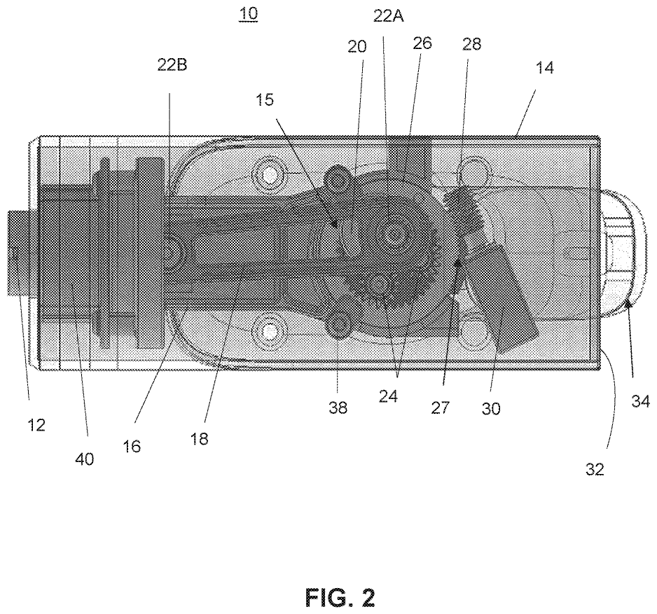

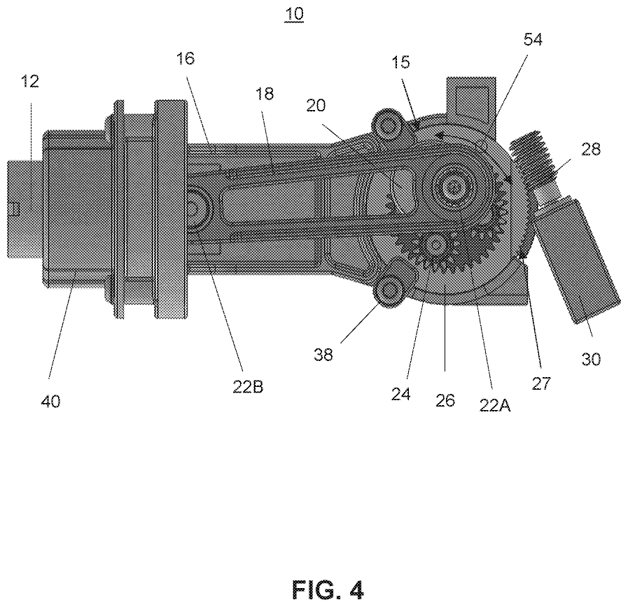

Referring now to FIGS. 1-2 and 4, an exemplary real time infinitely adjustable amplitude and adjustable frequency percussive therapy device 10 is shown, wherein the housing 14 is shown as transparent merely for illustrative purposes. The exemplary device 10 comprises a piston 12 defining a reciprocating member, and a handle 34 permitting a user to hold and position the device 10, such as by hand. The housing 14 may contain therein a gear assembly 15 positioned on or in close proximity to a frame 16, wherein the frame 16 may be adapted to support the gear assembly 15, a bushing (e.g., 40) and a connection rod 18. In this particular embodiment, various gears of the gear assembly comprise spur gears. A motor may be positioned below the gear assembly 15, and may be powered by a battery positioned in the handle 34 with a charge connection 36. In this particular embodiment, the motor is rigidly secured to the frame 16. It will be apparent to one of ordinary skill in the art that there may be any number of different devices or methods available for powering one or more exemplary motors without departing from the scope of the present invention.

The gear assembly 15 may include a planetary gear 20 positioned adjacent to idler gears 24. The idler gears 24 may be adapted to maintain the planetary gear 20 in a substantially central position with respect to the gear assembly 15. In this particular embodiment, the idler gears 24 are adapted to reduce the impact of the gear assembly 15 on the device 10 motor shaft, which may prevent deflection of the motor shaft caused by excessive force from the gear assembly 15, which may prevent the planetary gear 20 from being disengaged from the ring gear 26. Alternatively, or additionally, a roller and/or similar other cushioning device may be positioned adjacent to the planetary gear 20, may be adapted to maintain the planetary gear 20 in a substantially central position with respect to the gear assembly 15, and may further be adapted to reduce the impact of the gear assembly 15 on the device motor shaft. An exemplary roller may also be beneficial for reducing device 10 noise. The gear assembly 15 may be secured to the frame 16 by any number of different fasteners (e.g., 38), clips, bolts, welding, some combination thereof, or the like. It will be apparent to one of ordinary skill in the art that there may be any number of different materials, devices or methods available for preventing exemplary gears from becoming disengaged from one another.

The idler gears 24 may be positioned adjacent to an interior circumference of a ring gear 26. In preferred embodiments, a therapy feature, such as, for example, an attachment having an ellipsoidal or substantially spherical surface, may be positioned at or near a distal end of the piston 12, and may be adapted to contact the body of a user. The attachment may comprise a plug-in head, and the piston 12 may be adapted to receive the plug-in head, such as, for example, through groove and o-ring connection features. The piston and the plug-in head may exert force on a user's tissue through the reciprocating motion of the piston while the device 10 is active. In certain embodiments, the piston is adapted to withstand forces ranging from 40 to 60 pounds without stalling. It will be apparent to one of ordinary skill in the art that an exemplary piston may be adapted to receive any number of different plug-in heads of any number of different shapes and sizes. It will further be apparent to one of ordinary skill in the art that the present invention is not necessarily intended to be limited to a single reciprocating member.

An off-center axle of the planetary gear 20 may be adapted to be received by a first bearing 22A of the connection rod 18 at a first end of the connection rod 18, wherein the bearing 22A may be useful to reduce friction between the off-center axle and the connecting rod 18. The planetary gear 20 may comprise a plurality of gear teeth around a perimeter thereof adapted to engage corresponding gear teeth positioned along an inner circumference of the ring gear 26. A second bearing 22B of the connection rod 18, positioned at a second end of the connection rod 18 opposite of the first end, may include an attachment member positioned therein adapted to connect the connection rod to the piston. It will be apparent to one of ordinary skill in the art that an exemplary connection rod may be any number of different shapes and/or sizes, and is not necessarily limited to two bearings.

A worm gear 28 defining a positioning gear may be adapted to engage the ring gear 26 to determine the stroke of the piston 12 between an infinite number of different strokes within a predetermined range. A stepper motor 30 may cause movement of the worm gear 28, which may cause the ring gear 26 to rotate (e.g., 54). The stepper motor 30 may be in electronic communication with the battery, and electronic controls may cause the stepper motor 30 to drive the worm gear 28 in a forward or backward angular direction (e.g., clockwise or counterclockwise direction). In this particular embodiment, the worm gear 28, actuatable by the stepper motor 30, is adapted to engage corresponding gear teeth 27 positioned on a portion of an outer perimeter of the ring gear 26 to cause the ring gear to rotate 54 a limited angular amount (e.g., within 35 degrees) resulting in a change to the pathway of an off-center axle of the planetary gear 20. The aforementioned change to the pathway may cause a change to the driving motion of the connecting rod 18, which in turn may change the stroke of the piston 12.

Positioned at the rear 32 of the device 10 may be a central controller. The central controller may comprise a digital screen, such as, for example, a touch screen. The central controller may additionally or alternatively comprise a plurality of buttons, rotatable dials, rotatable knobs, some combination thereof, or the like. The central controller at the rear 32 of the device 10 may provide a user the ability to specify and/or adjust amplitude and/or frequency of piston 12 movement in real time, including for example, before or during a percussive therapy session. By way of example and not limitation, the central controller may provide a user control of worm gear 28 positioning by way of the stepper motor 30 to determine ring gear 26 positioning, which may dictate planetary gear 20 off-center axle movement, which may dictate stroke length. In the embodiment shown, the ring gear 26 remains stationary during percussive treatment other than to adjust the stroke of the device 10.

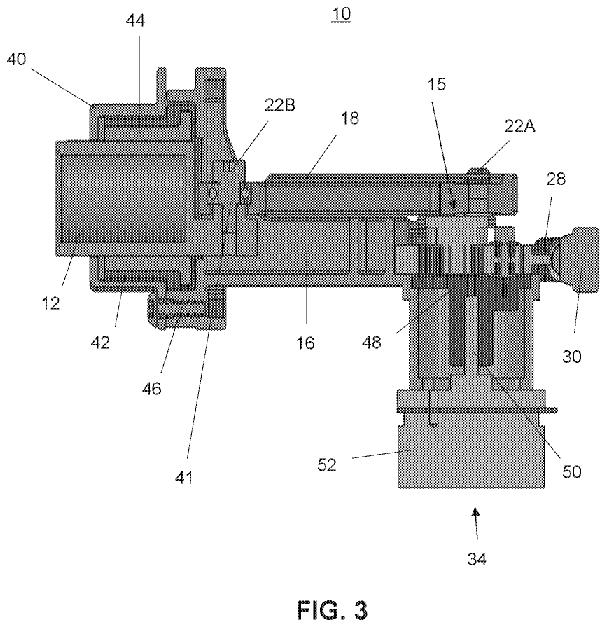

Referring to FIG. 3, a bushing (e.g., 40, 42, 44) may be adapted to cause the piston 12 to move from a retracted position to an extended position in a linear fashion. In this particular embodiment, the bushing comprises a bushing retainer 40, adapted to surround and restrict movement of a lubricated bushing 44. The lubricated bushing 44 may be positioned adjacent to the piston 12 substantially around a circumference thereof, and the piston 12 may be adapted to slide along an interior surface of the lubricated bushing 44. A vibration isolator or elastomer 42 may be positioned between the bushing retainer 40 and lubricated bushing 44, and may be adapted to restrict the propagation of vibrations within the device 10 from piston 12 movement. The bushing may be affixed to the frame 16 of the device 10 by any number of different fasteners (e.g., 46), clips, bolts, welding, adhesive, some combination thereof, or the like. In this particular embodiment, a second bearing 22B of a connection rod 18 opposite of a first bearing 22A includes an attachment member 41 positioned therein, wherein the attachment member 41 may be adapted to secure the connection rod 18 to the piston 12. Thus, movement of the connection rod 18 caused by rotation of an eccentric drive unit 48 may cause movement of the piston 12 secured to the connection rod 18.

Referring now to FIGS. 3-5, various views of the device 10 of the FIG. 1 embodiment are shown, the device 10 having a gear assembly 15 and a piston 12. A drive motor axle or rotating motor shaft 50 of the device 10 may be adapted to rotate upon actuation by a drive motor 52 positioned on the handle 34 of the device 10. Rotation of the rotating motor shaft 50 may cause rotation of an eccentric drive unit 48 attached thereto. The eccentric drive unit 48 may include an off-center axle configured to contact the planetary gear 20 and cause the planetary gear 20 to rotate and orbit along an inner circumference of the ring gear 26. The aforementioned movement of the planetary gear 20 may cause the planetary gear 20 off-center axle to move in a substantially ellipsoidal or substantially linear path. Movement of the planetary gear 20 off-center axle may dictate movement of the connecting rod 18 attached thereto at bearing 22A. Movement of the connecting rod 18 may drive the piston 12 in a linear, reciprocating motion resulting in a stroke thereof. Adjusting rotation of the eccentric drive unit 48 in real time by adjusting drive motor 52 power to the rotating motor shaft 50 may directly change piston 12 movement frequency in real time.

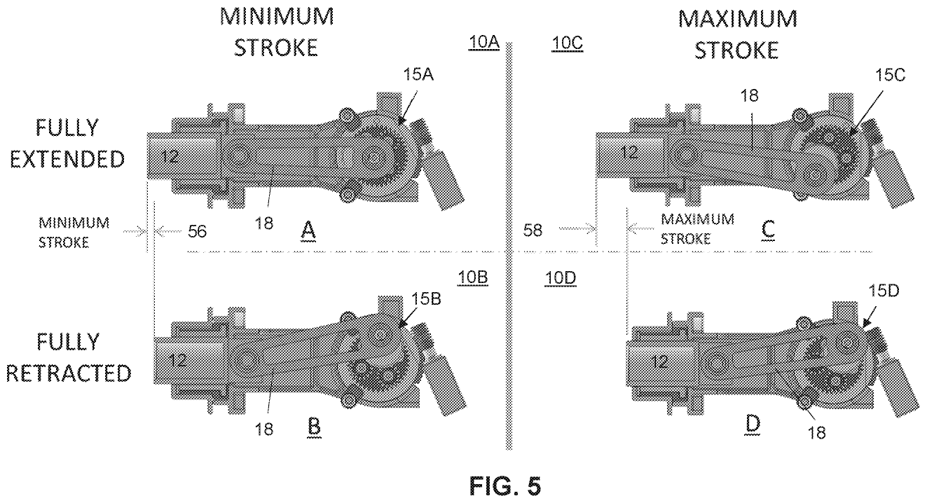

Rotation 54 of the ring gear 26 in real time caused by rotation of the worm gear 28 (actuated by the stepper motor 30) in a first direction may cause the planetary gear 20 axle (positioned within bearing 22A) to be positioned within the ring gear 26 closer to the front of the device when the device 10 is in a fully extended position, resulting in a greater stroke of the piston 12 (as shown by 10C in FIG. 5). Rotation 54 of the ring gear 26 in real time caused by rotation of the worm gear 28 in a second direction opposite of the first direction may cause the planetary gear 20 axle to be positioned within the ring gear 26 further from the front of the device when the device 10 is in a fully extended position, resulting in a smaller stroke of the piston 12 (as shown by 10A in FIG. 5).

Referring specifically to FIG. 5, the device 10A-B comprising a piston 12, connecting rod 18, and gear assembly 15A-B may exhibit a smaller or minimum stroke 56 between a fully extended A and fully retracted B position when the ring gear is rotated counterclockwise such that the worm gear is positioned at a lower angle on the ring gear. The device 10C-D comprising a piston 12, connecting rod 18, and gear assembly 15C-D may exhibit a larger or maximum stroke 58 between a fully extended C and fully retracted D position when the ring gear is rotated clockwise such that the worm gear is positioned at a greater angle on the ring gear. Referring again to FIGS. 3-5, the ring gear 26 may be rotated to one of any infinite number of different positions within a predetermined range in real time by action of a positioning gear (e.g., worm gear 28), thus the connecting rod 18 may move between an infinite number of different pathways (within a predetermined range), resulting in an infinite number of different available strokes (e.g., 56, 58) within a predetermined range of the piston 12. In exemplary embodiments, movement of the positioning gear (e.g., 28) may be achieved by a button, a stepper motor, a rotatable dial, a rotatable nob, a touch screen control, some combination thereof, or the like.

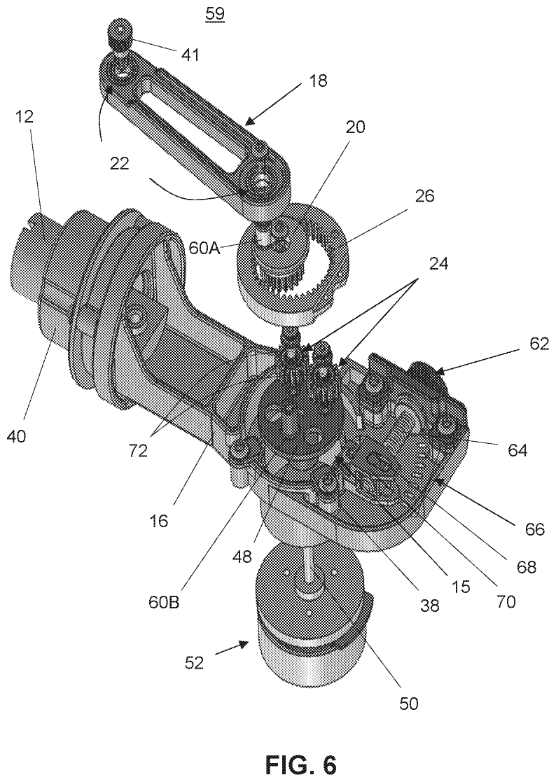

Referring now to FIGS. 6-9, an alternative exemplary device 59 having a bolt positioning gear 64 is shown. In this particular embodiment, the bolt positioning gear 64 may be controlled by a stroke adjustment knob 62. It will be apparent to one of ordinary skill in the art that the present invention is not intended to be limited to either stroke adjustment knobs for controlling bolt positioning gears or stepper motors for controlling worm gears. In other embodiments, there may be any number of different devices or methods available for causing rotation of a ring gear to adjust stroke.

In the embodiment shown, the stroke adjustment knob 62 is adapted to rotate in a first direction (e.g., clockwise or counterclockwise) to move a ring gear engagement apparatus 70 towards the stroke adjustment knob 62, and the stroke adjustment knob 62 is adapted to rotate in a second direction opposite of the first direction to move the ring gear engagement apparatus 70 away from the stroke adjustment knob 62. A connection apparatus 68 may include a threaded slide bushing portion having complimentary threads with respect to the bolt positioning gear 64. Rotation of the bolt positioning gear 64 may cause the connection apparatus 68 to move along the bolt positioning gear 64 in either direction by engagement of the complimentary threads with one another. The connection apparatus 68 may be connected to the ring gear engagement apparatus 70 such that movement of the connection apparatus 68 in either direction along the bolt positioning gear 64 causes rotation of the ring gear engagement apparatus 70. In the embodiment shown, the ring gear engagement apparatus 70 is a bracket rigidly secured to the ring gear 26 by a fastener.

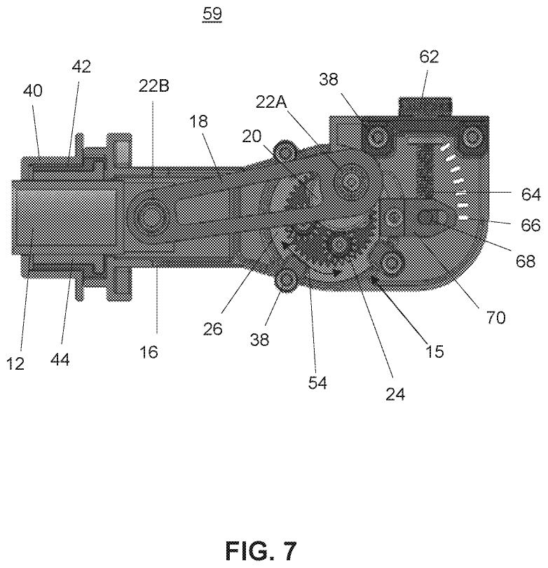

Rotation of the ring gear apparatus 70 in a first direction (e.g., away from the stroke adjustment knob 62) may cause the ring gear 26 to rotate clockwise (e.g., 54), and rotation of the ring gear apparatus 70 in a second direction (e.g., towards the stroke adjustment knob 62) may cause the ring gear 26 to rotate counterclockwise (e.g., 54). In the embodiment shown, the ring gear 26 is adapted to rotate a limited angular range to dictate piston 12 stroke. The ring gear engagement apparatus 70 and the ring gear 26 may each remain substantially stationary before or during percussive therapy until a user engages the stroke adjustment knob 62 to regulate stroke. In the embodiment shown, a locking mechanism for the ring gear 26 is not required. Referring specifically to FIG. 7, the ring gear 26 and ring gear engagement apparatus 70 are shown in position for providing maximum stroke to the piston 12.

Referring again to FIGS. 6-9, a drive motor axle or rotating motor shaft 50 is positioned above a drive motor 52, and is powered by the drive motor 52. It will be apparent to one of ordinary skill in the art that there may be any number of different methods or devices available for actuating a rotating motor shaft without departing from the scope of the present invention. An aperture in the frame 16 securing the gear assembly 15 may permit the drive motor axle 50 to pass therethrough. Positioned below the gear assembly 15 and above the drive motor 52 may be an eccentric drive unit 48, wherein a portion of the eccentric drive unit 48 may be adapted to receive a portion of the drive motor axle 50 and attach the drive motor axle 50 thereto. Thus, the eccentric drive unit 48 may rotate as the drive motor axle 50 rotates.

An off-center axle 60B may be positioned on the eccentric drive unit 48 on a face of the eccentric drive unit 48 opposite of the drive motor 52. A central portion of the planetary gear 20 may be adapted to receive the off-center axle 60B of the eccentric drive unit 48. Thus, the planetary gear 20 may orbit within the ring gear 26 as the eccentric drive unit 48 rotates. Bearings may be incorporated adjacent to any axle connections to reduce friction between component parts. Idler gears 24 are preferably included to, for example, reduce the impact of the gear assembly 15 on the drive motor axle 50. The idler gears 24 may comprise bearings 72 for reducing friction between the idler gears 24 and shafts connecting the idler gears 24 to the eccentric drive unit 48. It will be apparent to one of ordinary skill in the art that exemplary embodiments of the present invention are not necessarily intended to be limited to any particular number, shape, or size of any gear, bearing, motor, part, component, or the like identified herein.

Gear teeth may be positioned along the lower outer perimeter of the planetary gear 20 to engage gear teeth along an inner circumference of the ring gear 26. An off-center axle 60A may be positioned on a planetary gear 20 face opposite of the planetary gear 20 teeth. The gear assembly 15 may be attached to the frame 16 by one or more fasteners 38. The rotatable position of the ring gear 26 may dictate where the off-center axle 60A is positioned when the planetary gear 20 is positioned to cause maximum extension of a piston 12 contained by a bushing (e.g., 40, 42, 44). The rotatable position of the ring gear 26 may be measured by a plurality of stroke setting indicators 66. In the embodiment shown, when the off-center axle 60A is caused by the ring gear 26 to travel a first path 74A, the piston 12 extends farther from the bushing (e.g., 40, 42, 44) in its maximum extended position, resulting in greater stroke of the device 59. When the off-center axle 60A is caused by the ring gear 26 to travel a second path 74B, the piston 12 extend less far from the bushing (e.g., 40, 42, 44) in its maximum extended position, resulting in a smaller stroke of the device 59. With the second path 74B, a maximum extended position of the piston 12 may occur when the off-center axle 60A is positioned substantially at a centerline 78B of the bushing (e.g., 40, 42, 44). In the embodiment shown, a connecting rod 18 having a bearing 22A adapted to receive the off-center axle 60A and reduce friction therebetween drives movement of the piston 12. The connecting rod 18 may adapted to engage in reciprocal, substantially linear movement between the gear assembly 15 and the bushing, wherein reciprocal, substantially linear movement of the connecting rod 18 may be caused by movement of the off-center axle 60A of the planetary gear 20. An end of the connection rod 18 opposite of the planetary gear 20 may include another bearing 22B for receiving an attachment member 41 adapted to connect the connection rod 18 to the piston 12. Thus, the reciprocal, substantially linear movement of the connecting rod 18 may cause reciprocal, linear motion of the piston 12, resulting in a stroke corresponding to the stroke setting.

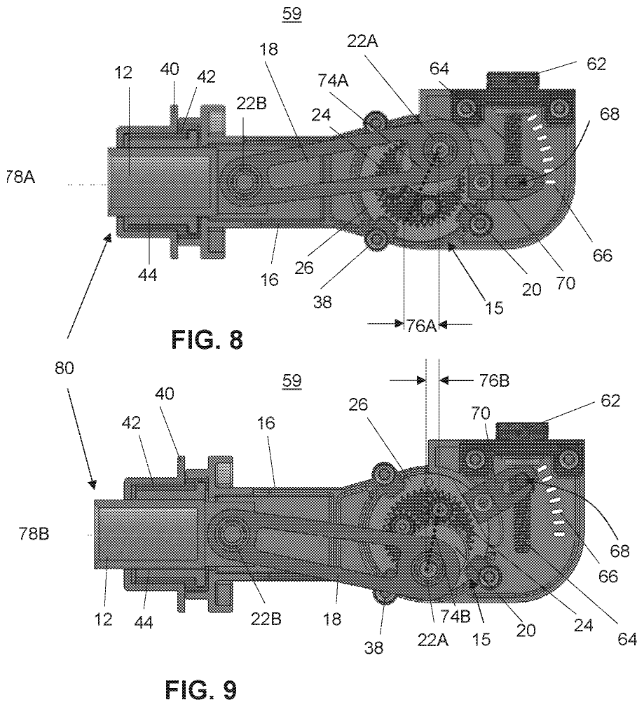

Referring specifically to FIGS. 6, 8, and 9, path lines 74A and 74B illustrate the path of the planetary gear axle 60A during a single stroke of the piston 12. Referring specifically to FIG. 8, the ring gear engagement apparatus 70 is positioned to cause a maximum amplitude (as illustrated by centerline 78A illustrating approximately how far past the bushing retainer 40 the piston 12 may travel). Referring specifically to FIG. 9, the ring gear engagement apparatus 70 is positioned to cause a minimum amplitude (as illustrated by centerline 78B illustrating approximately how far past the bushing retainer 40 the piston 12 may travel). It will be apparent to one of ordinary skill in the art that the aforementioned figures are merely illustrative, and exemplary embodiments of the present invention are not necessarily intended to be limited to any particular minimum or maximum amplitude based on positioning gear configuration.

Referring again to the FIGS. 6, 8, and 9 embodiments, the stroke (e.g., 76A, 76B) of the piston 12 may be equal to the maximum difference in distance of the position of the planetary gear axle 60A when it is closest to and farthest from the front 80 of the device 59, measured parallel to the piston 12 stroke (maximum difference in distance is illustrated by 76A and 76B). It will be apparent to one of ordinary skill in the art, however, that in other embodiments, stroke is not necessarily limited to the maximum difference in distance of the position of the planetary gear axle when it is closest to and farthest from the front of the device, measured parallel to the piston stroke. By way of example and not limitation, the connecting rod may not necessarily be restricted to substantially horizontal movement, and may be adapted for upward and/or downward angular movement to cause retraction of the piston. In the embodiment shown, the maximum difference in distance 76A for FIG. 8 is greater than the maximum difference in distance 76B for FIG. 9, thus stroke of the device 59 is greater in FIG. 8 than it is in FIG. 9. In certain embodiments, the device may be configured for variable stroke velocity, where the piston 12 may retract faster than it advances, or vice versa. The shape of the path (e.g., 74A, 74B) of the planetary gear off-center axle 60A may permit the piston 12 to advance faster than it retracts or vice versa when motor action is altered during a single stroke, such as when, for example, rotation direction of the eccentric drive unit 48 is reversed. It will be apparent to one of ordinary skill in the art that exemplary embodiments of the present invention are not necessarily intended to be limited to any particular stroke velocity.

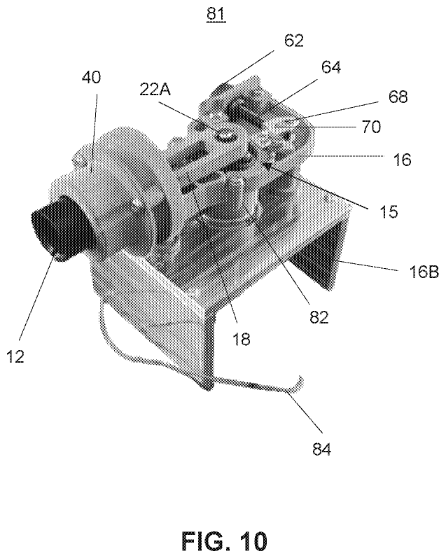

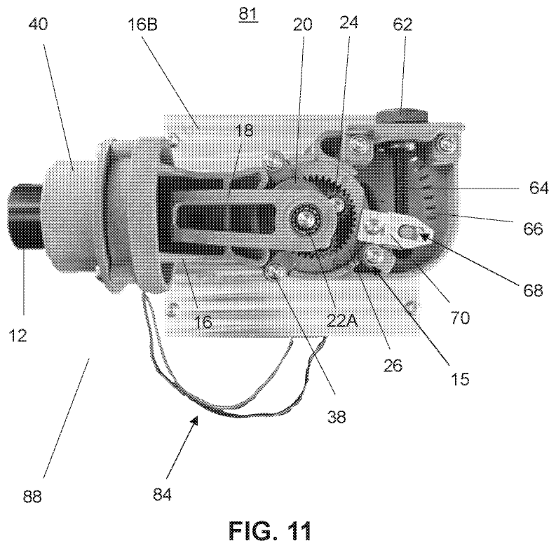

Referring now to FIGS. 10-11, another exemplary real time infinitely adjustable amplitude and adjustable frequency percussive therapy device 81 is shown having a piston 12, frame 16, bushing retainer 40, bearings (e.g., 22A), a connecting rod 18, a gear assembly 15 (including planetary gear 20, idler gears 24, ring gear 26, bolt positioning gear 64) secured (e.g., by fasteners 38) to the frame 16, stroke adjustment knob 62, stroke setting indicators 66, connection apparatus 68 and ring gear engagement apparatus 70. In this particular embodiment, the device 81 is adapted to be supported by a supporting frame 16B over a substantially flat surface 88. Also, in this particular embodiment, a motor shaft 82 including a drive motor and drive motor axle therein is shown. Furthermore, in this particular embodiment, the device 81 comprises wires 84 permitting power requirements for any number of different motors or other electronic components, including for example, a digital display, of the device 81 to be satisfied. In certain embodiments, the device 81 may be adapted to permit vibrations and/or other movement of the reciprocating member (e.g., piston 12) and/or an attachment thereto. An exemplary device may be configured to permit control of the throw of the reciprocating member movement in addition to amplitude and frequency of reciprocating member movement. Throw for local vibrations of an exemplary reciprocating member and/or attachment thereto maybe 0.5-1.5 mm in certain embodiments. It will be apparent to one of ordinary skill in the art that with exemplary embodiments of the present invention, local vibration throw is not necessarily intended to be limited to any particular range.

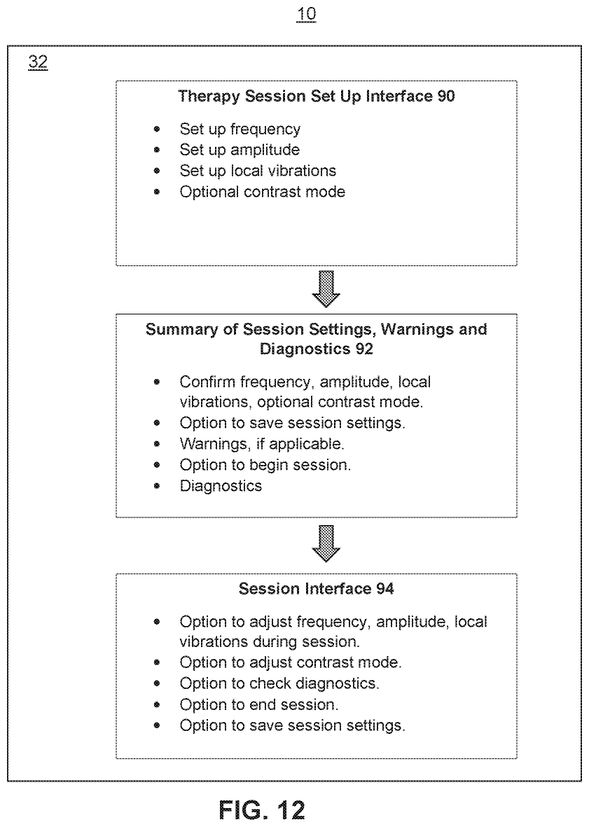

Referring now to FIGS. 6 and 12, exemplary logic for various device interfaces in accordance with a preferred embodiment of the present invention is shown. The drive motor may be adapted to cause the eccentric drive unit to rotate at any number of different velocities, and thus any number of different frequencies for reciprocating member movement may be available. Rotation of the eccentric drive unit, and thus frequency of reciprocating member movement, may be adjusted in real time, including for example, during an ongoing percussive therapy session, by a central controller. The central controller may include a microprocessor and one or more digital interfaces displayed at a rear screen 32 of the device (e.g., 10, 59). Stroke and local vibration settings may also be adjusted according to the central control before and/or during a percussive therapy session.

The digital interfaces may include a therapy session set up interface 90, a summary of session settings, warnings and diagnostics interface 92 and a session interface 94. The set-up interface 90 may permit a user to specify frequency, amplitude, local vibrations, some combination thereof, or the like before a therapy session, and may further permit a user to specify how frequency, amplitude, local vibrations, some combination thereof, or the like change over time during a therapy session (“optional contrast mode”). The settings, warnings and diagnostics interface 92 may provide an option to confirm aforementioned specifications, save aforementioned specifications for later use, some combination thereof, or the like. The settings, warnings and diagnostics interface 92 may further provide any warnings applicable to certain uses of the device, such as for example, warnings about prolonged use of the device, especially at high amplitudes and frequencies, and diagnostics options, such as, for example, options to view device performance characteristics. The session interface 94 may provide options to adjust any aforementioned parameters during a therapy session, end a therapy session, save settings from the therapy session, some combination thereof, or the like. The aforementioned interfaces are meant to be merely illustrative and not exhaustive of examples of device programming.

The aforementioned parameters may be varied throughout a massage session utilizing a programmed “user profile” or any number of different pre-programmed settings to vary the motor speed and reciprocating member movement frequency, stroke (e.g., stepper motor action, positioning gear configuration), local vibrations of the reciprocating member and/or attachments thereof, some combination thereof, or the like. In certain embodiments, the rate of velocity of the drive axle, and in turn reciprocating member movement frequency in percussions per minute (ppm) may be adjusted according to an electronic touch pad, tactile switches, one or more dials or the like. It will be apparent to one of ordinary skill in the art that there may be any number of different devices or methods available for varying the rate of velocity of a drive axle without departing from the scope of the present invention. In certain embodiments, stroke may be adjusted within a range of 0.5 mm to 20 mm, wherein the adjustment may be actuated mechanically, electronically, or by some combination of mechanical and electronic actuation. It will be apparent to one of ordinary skill in the art that an exemplary device may also permit a stroke of less than 2.0 mm or greater than 20 mm. In certain embodiments, reciprocating member movement frequency may be adjusted within a range of 1200 ppm and 7200 ppm, wherein buttons, dials, digital interfaces, some combination thereof, or the like, preferably positioned at or near the rear of the device, may permit frequency adjustment. It will be apparent to one of ordinary skill in the art that exemplary embodiments of the present invention are not necessarily intended to be limited to any particular frequency or stroke range.

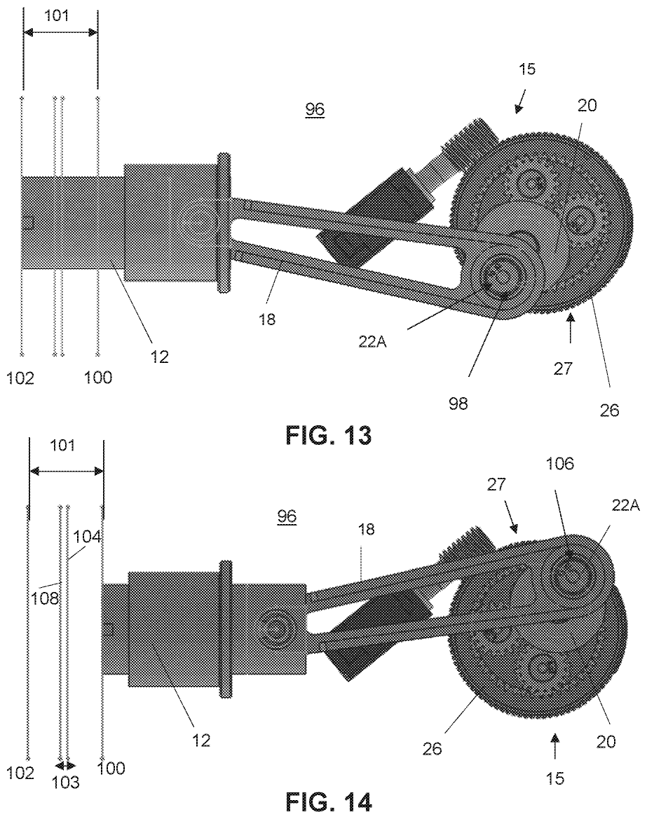

Referring now to FIGS. 13-14, an exemplary device 96 having a gear assembly 15 including a ring gear 26 comprising a plurality of gear teeth 27 positioned substantially across an outer circumference of the ring gear 26 is shown. Referring specifically to FIG. 13, a planetary gear 20 off-center axle substantially positioned in a first bearing 22A of a connection rod 18 is located at a midpoint 98 of an off-center axle movement path corresponding to a midpoint of a motor revolution. The off-center axle movement path may be substantially linear. Here, the front of the piston 12 is at a fully extended position 102, and displacement (stroke) 101 of the piston 12 from a retracted position 100 to the fully extended position 102 is a maximum value 101. The maximum value 101 may be 20 mm. A single percussion of the device 96 may occur when the piston 12 moves from the retracted position 100 to the extended position 102 and back to the retracted position 100.

Referring specifically to FIG. 14, the planetary gear 20 off-center axle substantially positioned in the first bearing 22A of the connection rod 18 is located at a starting part 106 of an off-center axle movement path corresponding to a starting point of a motor revolution. Here, the front of the piston 12 is at a fully retracted position 100 located a distance 101 from the fully extended position 102. The position of the ring gear 26 may be adjusted to cause displacement 103 of the piston 12 from another fully retracted position 104 to another fully extended position 108 to be a minimum value 103. The minimum value 103 may be 0.5 mm. In certain embodiments, the minimum stroke setting results in two percussions of a substantially similar amplitude corresponding to one motor revolution (“multiplier effect”). At a minimum stroke of 0.5 mm, the motor may be configured to rotate at 3600 rpm, which, according to the aforementioned multiplier effect, may result in a frequency of 7200 ppm. The significant increase in frequency caused by the multiplier effect may be advantageous to the patient by greatly increasing number of percussions to a treatment area over a period of time. In other embodiments, the multiplier effect occurs when stroke is set to approximately 2 mm. It will be apparent to one of ordinary skill in the art that the multiplier effect is not necessarily limited to occurring at any single particular amplitude.

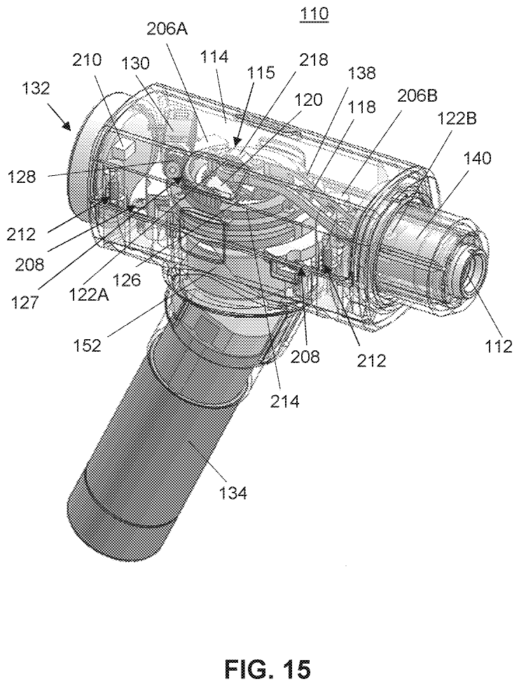

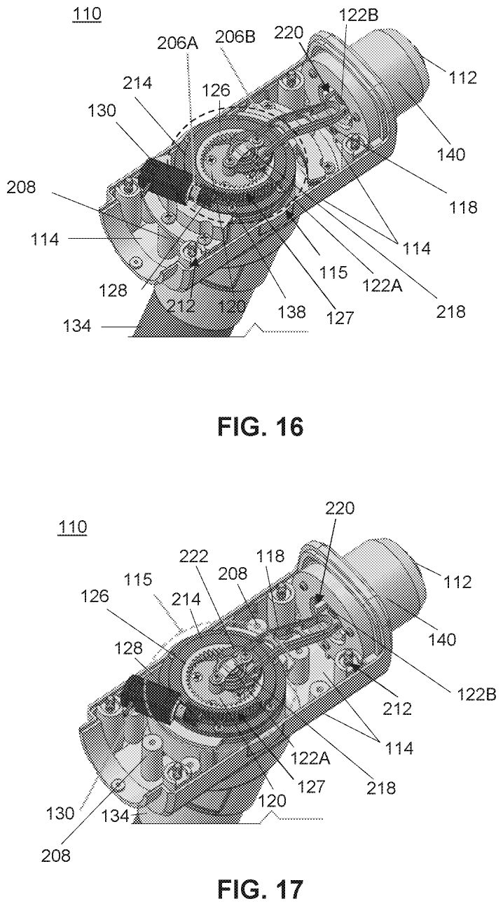

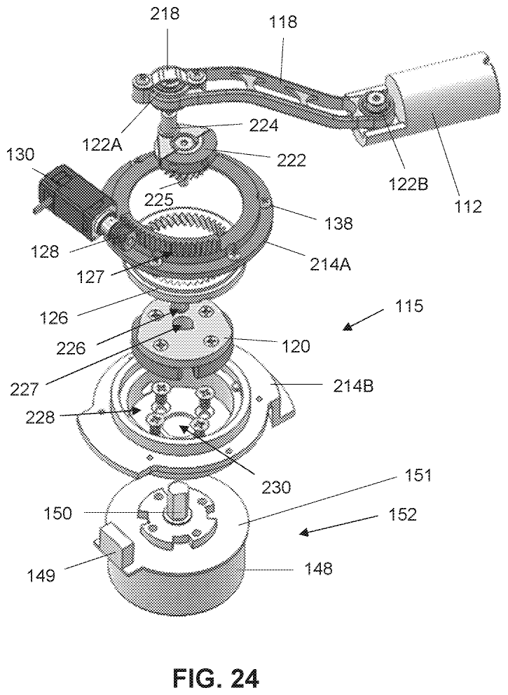

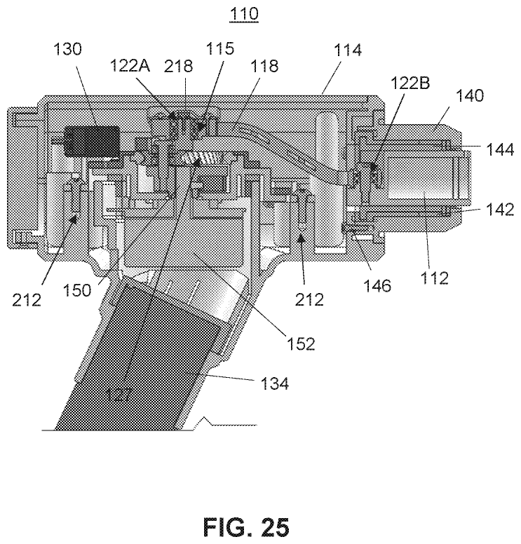

Referring now to FIGS. 15-25, another exemplary real time infinitely adjustable amplitude and adjustable frequency percussive therapy device 110 having a gear assembly 115 is shown. Referring specifically to FIGS. 15-18, 20-21 and 24-25, a housing 114 (shown as transparent in FIG. 15 merely for illustrative purposes) defines an exterior of the device 110. The housing 114 may comprise any number of different substantially rigid materials. Upper and lower portions of the housing 114 may be affixed to one another by positioning fasteners in corresponding threaded channels (e.g., at connection points 212). Loosening of the fasteners may permit the upper and lower portions of the housing 114 to be separated from one another (e.g., to permit user access to an interior of the device 110). It will be apparent to one of ordinary skill in the art that any number of different materials and/or techniques may be employed for assembling and/or adjusting an exemplary housing.

Here, a piston 112 defines a reciprocating member, and a handle 134 permits a user to hold (e.g., using one or two hands) and position the device 110. The piston 112 may extend through a channel 220 in a bushing (e.g., 140). The housing 114 may surround the gear assembly 115. A drive motor 152 may be positioned below the gear assembly 115, and may be configured to cause rotation of a motor shaft 150 and eccentric drive unit 120 connected to the motor shaft 150. In this particular embodiment, the drive motor 152 comprises a rotatable base 148, motor shaft 150 which rotates with the rotatable base 148, a motor mount 151 (which may comprise a printed circuit board and/or other electronic components), and a power input 149 on the motor mount 151. The power input 149 may be configured to receive one or more wires. The motor shaft 150 may extend through the motor mount 151, but drive motor 152-driven spinning of the motor shaft 150 may not cause the motor mount 151 itself to spin. A ring gear 126 may be secured within a ring gear retainer 214, which may be attached to the motor mount 151 (e.g., by fasteners). Drive motor 152-driven spinning of the motor shaft 150 may not cause the ring gear 126 and ring gear retainer 214 to spin together with the motor shaft 150. Here, a planetary gear 222 and an eccentric drive unit 120 are configured to be connected to one another and rotate with one another (e.g., about an axis defined by shaft 150) within the housing 114. Rotation of the eccentric drive unit 120 and planetary gear 222 (along with orbiting of the planetary gear 222 within ring gear 126), driven by rotation of the motor shaft 150 (actuated by motor 152), may cause reciprocating movement of a connection rod 118 attached to the piston 112.

Specifically, the motor mount 151 may be configured to receive and connect to a lower portion 214B of the ring gear retainer 214. Connection of the lower portion 214B of the ring gear retainer 214 to the motor mount 151 may be promoted by positioning fasteners through apertures in the lower portion 214B of the ring gear retainer 214 and in threaded channels in the motor mount 151. A center opening 230 of the lower portion 214B of the ring gear retainer 214 may permit the motor shaft 150 of the drive motor 152 to be positioned through the ring gear retainer 214. The motor shaft 150 of the drive motor 152 may be received by a drive unit shaft receptacle 227 in the eccentric drive unit 120. Thus, rotation of the motor shaft 150 may cause rotation of the eccentric drive unit 120. The eccentric drive unit 120 may be secured to the motor shaft 150 of the drive motor 152. The eccentric drive unit may be positioned proximate to a receptacle 228 of the lower portion 214B of the ring gear retainer 214. The ring gear 126 may be positioned above the eccentric drive unit 120 and secured between (e.g., locked to at least one of) the lower portion 214B and upper portion 214A of the ring gear retainer 214. The lower 214B and upper 214A portions of the ring gear retainer 214 may be affixed to one another by fasteners 138 to secure the ring gear 126 therebetween.

An axle receptacle 226 of the eccentric drive unit 120 may be configured to receive a center axle 225 of the planetary gear 222 (to connect the planetary gear 222 to the eccentric drive unit 120). An off-center axle 224 of the planetary gear 222 may be configured to be received by a first bearing 122A of the connection rod 118 at a first end of the connection rod 118. A fastening apparatus 218 (e.g., connected to the connection rod 118 by fasteners) may be configured to prevent the off-center axle 224 from becoming disengaged from the first bearing 122A. Gear teeth around the perimeter of the planetary gear 222 may engage corresponding gear teeth along an inner circumference of the ring gear 126 during spinning of the eccentric drive unit 120 and spinning and orbit of the planetary gear 222 (the planetary gear 222 may orbit entirely within the ring gear 126). A second bearing 122B of the connection rod 118 may be positioned at a second end of the connection rod 118 opposite of the first end. In this particular embodiment, the connection rod 118 is attached directly to the piston 112. Movement of the planetary gear 222 caused by rotation of the eccentric drive unit 120 may cause reciprocal motion of the connection rod 118, which may cause reciprocal motion of the piston 112. Although not required, idler gears (not shown) may be positioned between the planetary gear 222 and ring gear 126 (e.g., to maintain the planetary gear 222 in a substantially central position with respect to the gear assembly 115, to reduce the impact of the gear assembly 115 on the motor shaft 150, some combination thereof, of the like).

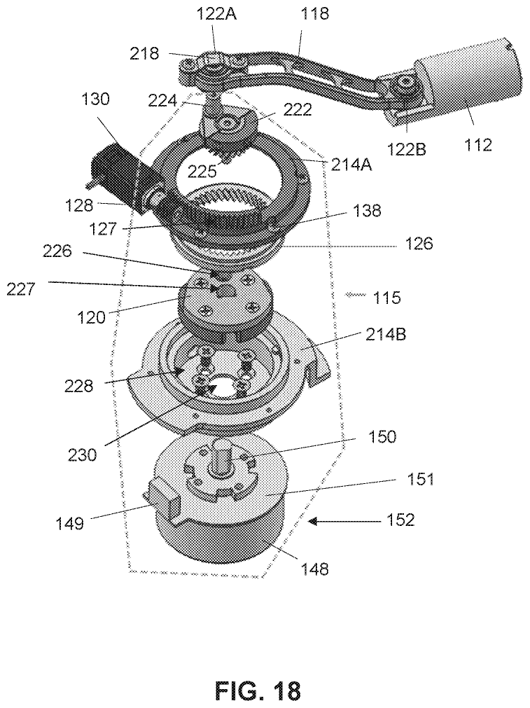

A worm gear 128 defining a positioning gear may be configured to engage gear teeth 127 along a portion of the outer circumference of the upper portion 214A of the ring gear retainer 214 to determine the stroke of the piston 112 between an infinite number of different strokes within a predetermined range. A stepper motor 130 may cause movement of the worm gear 128 (e.g., rotation about an axis of the worm gear 128), which may cause the upper portion 214A of the ring gear retainer 214 to rotate, which in turn may cause angular repositioning of the ring gear 126. Rotation of the ring gear retainer 214 (caused by a positioning gear) may cause rotation of all of the gear assembly 115 (e.g., ring gear 126, ring gear retainer 214) and drive motor 152. Referring specifically to FIG. 18, a dashed line surrounding gear assembly 115 identifies a portion of an exemplary device adapted to rotate together when the worm gear 128 engages gear teeth 127 of the upper portion 214A of the ring gear retainer 214.

Referring again to FIGS. 15-18, 20-21 and 24-25, the gear teeth 127 may permit the ring gear 126 (and in turn, the gear assembly 115 including various gears and the drive motor 152 as a whole) to be rotated by the worm gear 128 along a range of 35 degrees. Said range may be greater than, equal to, or less than 35 degrees in other embodiments. When the ring gear 126 is rotated from 0 to 35 degrees, the gear assembly 115 including various gears and the drive motor 152 may rotate simultaneously through a 35-degree angle (as shown in FIG. 21). The aforementioned configuration may promote tolerance control and cause reduced noise of the device 110.

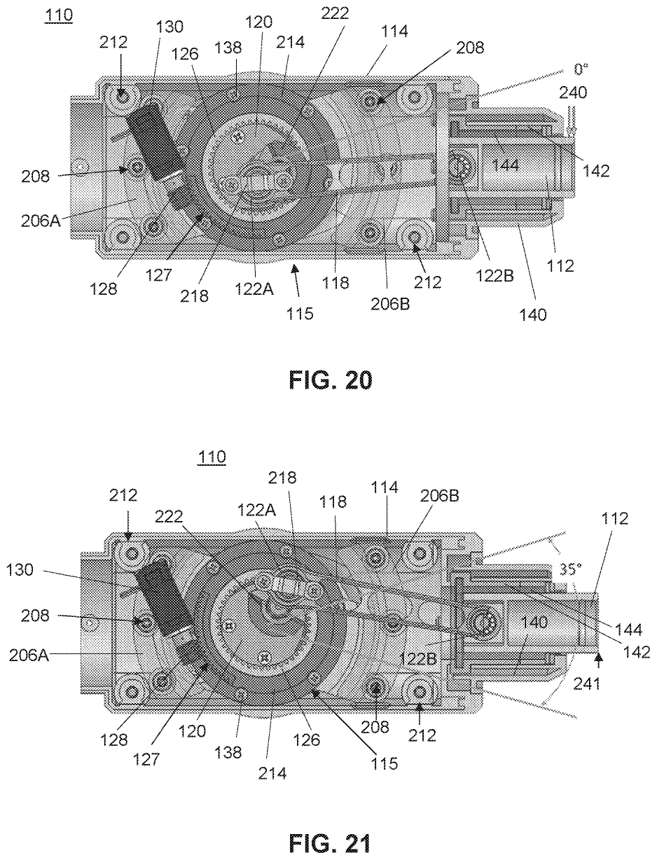

Angular repositioning of the ring gear 126 by a positioning gear (e.g., 128) may define adjustment of the pathway of the off-center axle 224 of the planetary gear 222 during rotation of the gear assembly 115. Referring specifically to FIGS. 20-21, positioning gear-driven rotation of the ring gear 126 along an available range of 0-35 degrees may cause adjustment of where the planetary gear 222 is positioned when the piston 112 is caused by the connection rod 118 to be driven to an outermost position 240, 241. Here, in the 0-degree ring gear 126 position, the piston 112 demonstrates minimum stroke (extends to a minimum outermost position 240). Here, in the 35-degree ring gear 126 position, the piston 112 demonstrates maximum stroke (extends to a maximum outermost position 241). Referring again to FIGS. 15-18, 20-21 and 24-25, adjustment of the pathway of the off-center axle 224 of the planetary gear 222 may change the driving motion of the connecting rod 118 to define adjustment of the piston 112 stroke. Thus, permitting a user to regulate movement of the worm gear 128 (or a similar, alternative positioning gear) may permit the user to in turn regulate stroke of the piston 112. In this particular embodiment, the worm gear 128 is separate from the gear assembly 115, and unlike the eccentric drive unit 120 and planetary gear 222, the worm gear 128 is not configured to rotate about a vertical axis defined by shaft 150.

The stepper motor 130 may be affixed to an interior frame of the device 110, and may be powered by the same power unit (e.g., an internal, rechargeable battery pack) providing power to the drive motor 152. Regulation of worm gear 128 movement may be permitted by a central controller (e.g., positioned at the rear 132 of the device 110, and connected to the device 110 by a connection unit 210). The central controller may be in electronic communication with one or more processors configured to permit the user to monitor and/or adjust any number of different device 110 functions and/or features. Alternatively or additionally, a manual adjustment knob or similar positioning gear may be employed to permit user adjustment of piston 112 stroke. It will be apparent to one of ordinary skill in the art that there may be any number of different methods available to permit monitoring and/or adjustment of device functions and/or features without departing from the scope of the present invention.

Referring specifically to FIGS. 15-18 and 20-21, gear assembly retainers 206A-B may be provided to retain and secure the gear assembly 115 including various gears and the drive motor 152 between said retainers 206A-B. Isolation of the gear assembly 115 including various gears and the drive motor 152 within the device 110 may promote noise control. Each gear assembly retainer 206A-B may be affixed (e.g., by fasteners) to vertical pillars 208 providing base support thereto. The vertical pillars 208 may be affixed and/or formed to one or more frames within the interior of the housing 114. In this particular embodiment, the gear assembly retainers 206A-B permit rotation of the gear assembly 115 including various gears and the drive motor 152. Referring specifically to FIG. 18, of the various components of the gear assembly 115 (here, lower 214B and upper 214A portions of the ring gear retainer 214A-B, eccentric drive unit 120, ring gear 126, and planetary gear 222), the eccentric drive unit 120 and planetary gear 222 may spin together (e.g., in a clockwise or counterclockwise direction) upon motor actuation of the motor shaft 150. The aforementioned components of the gear assembly 115 may each rotate together upon rotation of a positioning gear (e.g., stepper motor 130 causing rotation of worm gear 128). The gear assembly retainers 206A-B may each be curved to accommodate the substantially cylindrical shapes of various components of the gear assembly 115 and drive motor 152.

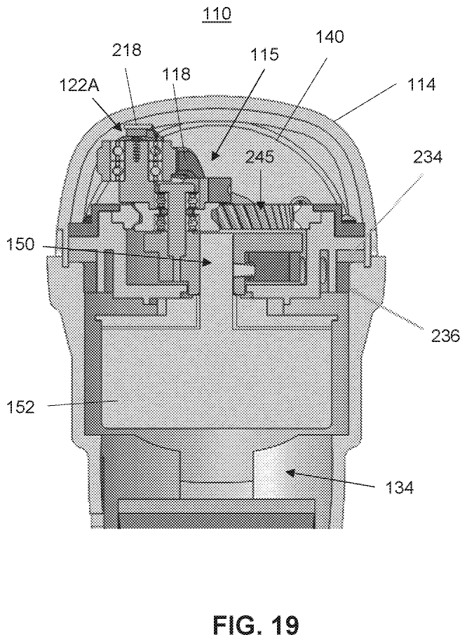

Referring now to FIG. 19, a cross-sectional view of the device 110 having, e.g., a housing 114, handle 134, gear assembly 115, ring gear teeth 245, fastening apparatus 218, connection rod 118 (e.g., having a bearing 122A), bushing retainer 140, drive motor 152, and motor shaft 150 is shown. In this particular embodiment, a first 234 and second 236 vibration isolating and/or sound deadening material is positioned in the device 110 between the housing 114 and the gear assembly 115 including various gears and the drive motor 152. Said material may be a polymer material. It will be apparent to one of ordinary skill in the art that the present invention is not intended to be limited to any particular amount(s), type(s), and/or location(s) of vibration isolating and/or sound deadening material(s). Certain components of the gear assembly 115 including various gears and the drive motor 152 may rotate about a vertical axis in a clockwise or counterclockwise direction.

Referring again to FIGS. 20-21 and 25, a bushing (e.g., 140, 142, 144) may be adapted to cause the piston 112 to move from a retracted position to an extended position in a linear fashion. A bushing retainer 140 may surround a lubricated bushing 144, and the piston 112 may be configured to slide along an interior surface of the lubricated bushing 144. A vibration isolator or elastomer 142 may be positioned between the bushing retainer 140 and lubricated bushing 144, and may be configured to restrict the propagation of vibrations within the device 110 from piston 112 movement. The bushing may be affixed to the remainder of the device 110 by one or more fasteners 146, although such is not required.

In this particular embodiment, the connection rod 118 is substantially curved in shape (the first bearing 122A is positioned above the second bearing 122B) as opposed to being substantially flat in shape. The vertical offset between the location where the off-center axle 224 of the planetary gear 222 connects to the first bearing 122A, and the location where the connection rod 118 attaches to the piston 112 (e.g., at the second bearing 122B) may permit reduced vertical dimensions of the housing 114. Specifically, where the centerline of the piston 112 is lower with respect to the gear assembly 115, the required vertical dimensions of the housing to accommodate the piston 112 and gear assembly 115 is lower. Said reduced vertical dimensions may provide for a smaller, lighter weight device 110.

Referring now to FIGS. 20-22, rotation of the gear assembly 115 (including ring gear 126) in real time caused by rotation of the worm gear 128 (actuated by the stepper motor 130) in a first direction may cause the planetary gear 222 off-center axle 224 (positioned within bearing 122A) to be positioned within the ring gear 126 closer to the front of the device 110 when the piston 112 is in a fully extended position, resulting in a greater stroke of the piston 112. Rotation of the gear assembly 115 (including ring gear 126) in real time caused by rotation of the worm gear 128 in a second direction opposite of the first direction may cause the planetary gear 222 off-center axle 224 (positioned within bearing 122A) to be positioned within the ring gear 126 further from the front of the device when the piston 112 is in a fully extended position, resulting in a smaller stroke of the piston 112. The ring gear may be rotated to one of any infinite number of different positions within a predetermined range in real time by action of a positioning gear (e.g., worm gear 128).

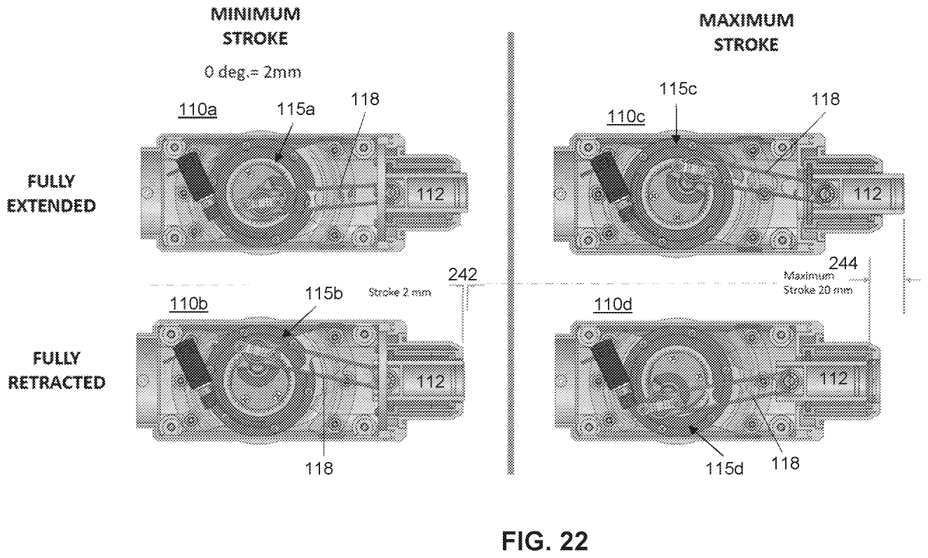

Referring now specifically to FIG. 22, the device 110a-b comprising a piston 112, connecting rod 118, and gear assembly 115a-b may exhibit a smaller or minimum stroke 242 (e.g., 2 mm) between a fully extended and fully retracted position when the gear assembly 115 is rotated counterclockwise such that the worm gear is positioned at a lower angle on the upper portion of the ring gear retainer. The device 110c-d comprising a piston 112, connecting rod 118, and gear assembly 115c-d may exhibit a larger or maximum stroke 244 (e.g., 20 mm) between a fully extended and fully retracted position when the gear assembly 115 is rotated clockwise such that the worm gear is positioned at a greater angle on the upper portion of the ring gear retainer.

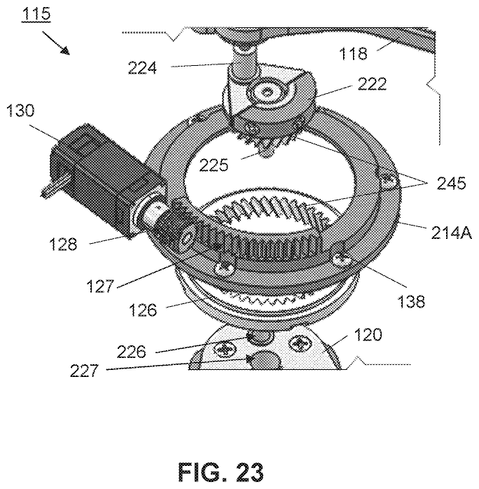

Referring now to FIG. 23, an exploded perspective view of the gear assembly 115 having an eccentric drive unit 120 (with a planetary gear axle receptacle 226 and a drive unit shaft receptacle 227), planetary gear 222 (having an off-center axle 224 connected to a connection rod 118, and center axle 225), ring gear 126, ring gear retainer upper portion 214A (attached to a ring gear retainer lower portion below by fasteners 138, and having gear teeth 127), and a worm gear 128 and stepper motor 130 is shown. In this particular embodiment, the gear assembly 115 comprises a number of helical gears. Specifically, here, gear teeth 245 of the ring gear 126 and planetary gear 222 are helical gear teeth. The helical gear teeth 245 may provide for reduced noise level of an exemplary device.

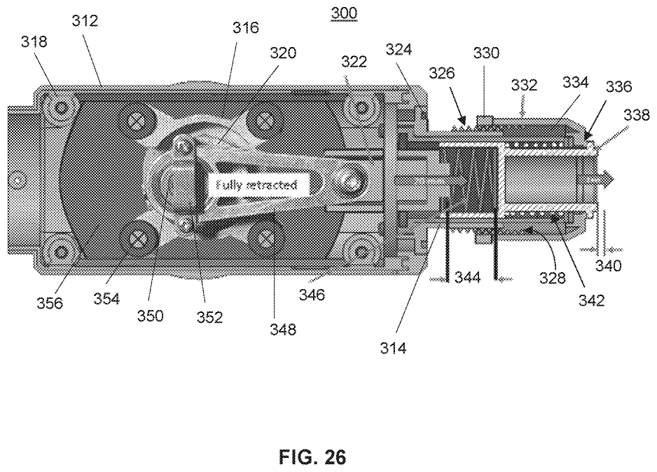

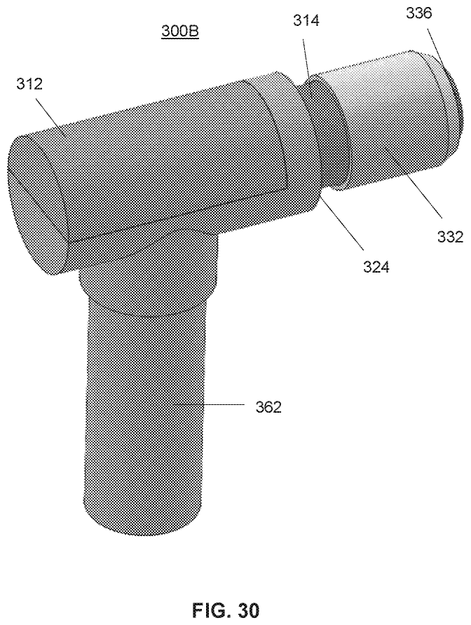

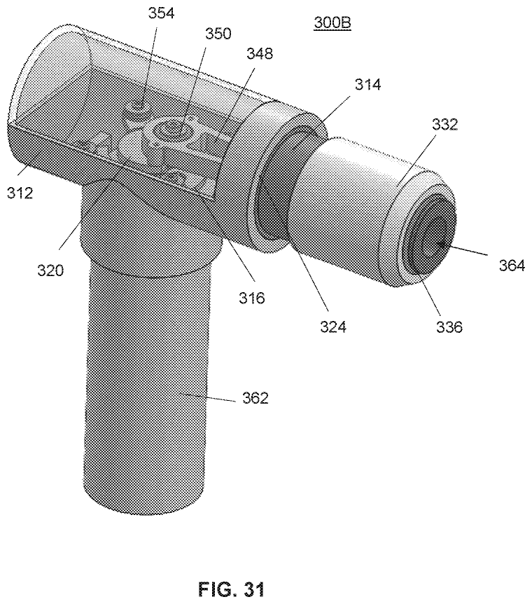

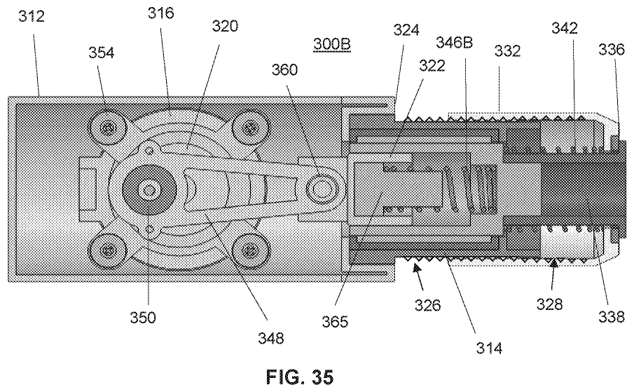

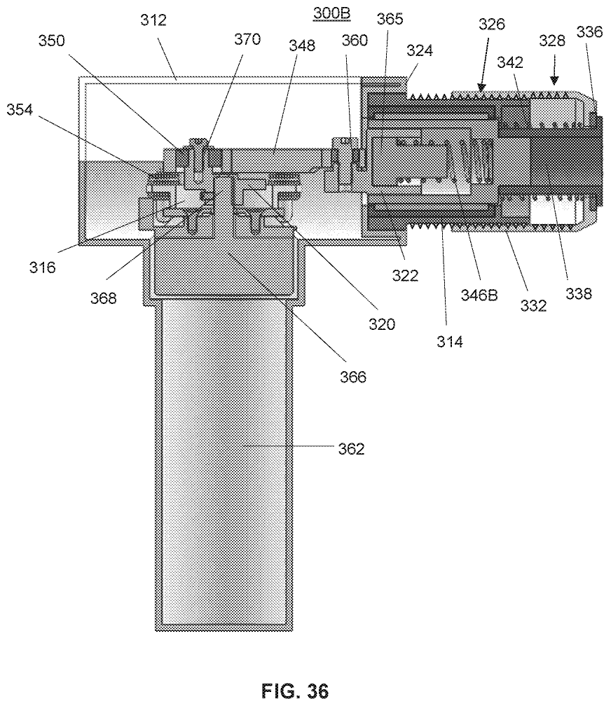

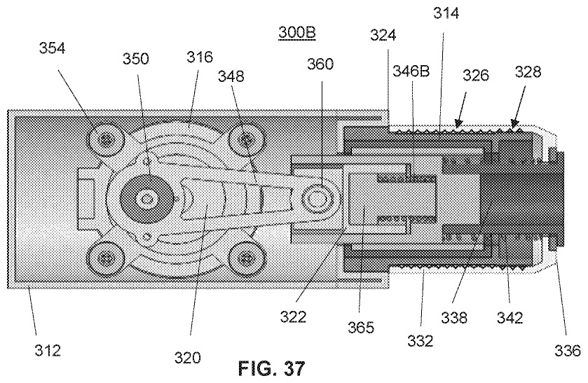

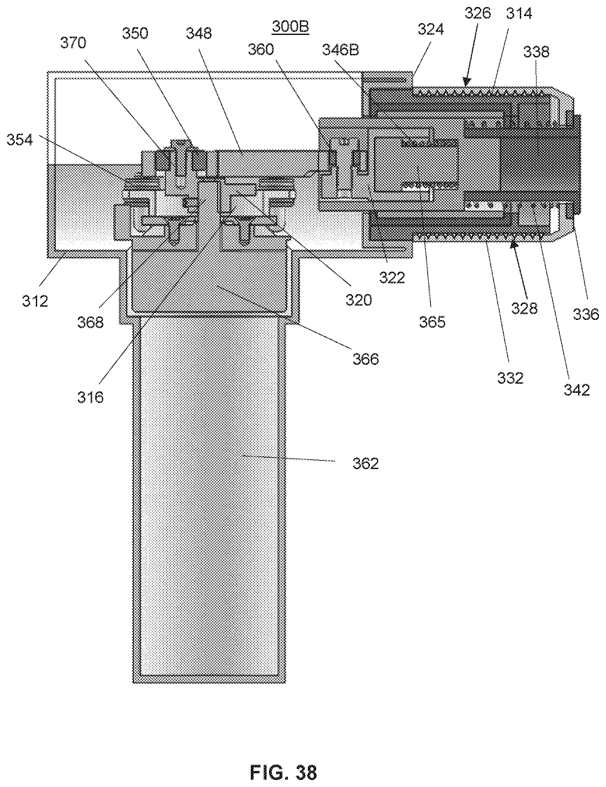

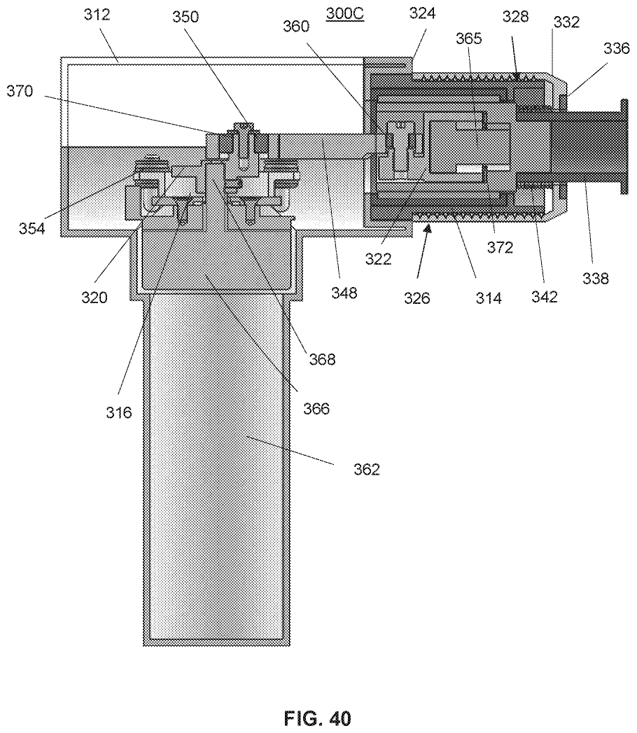

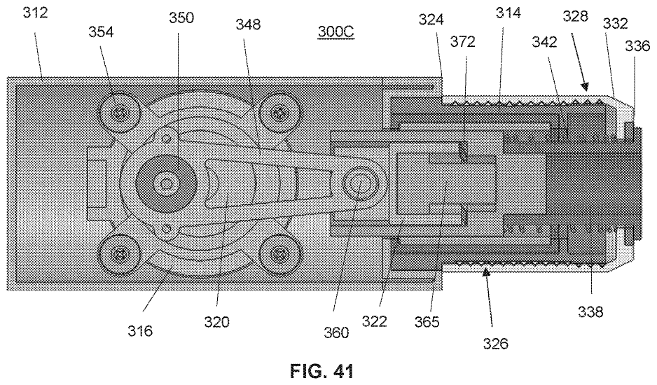

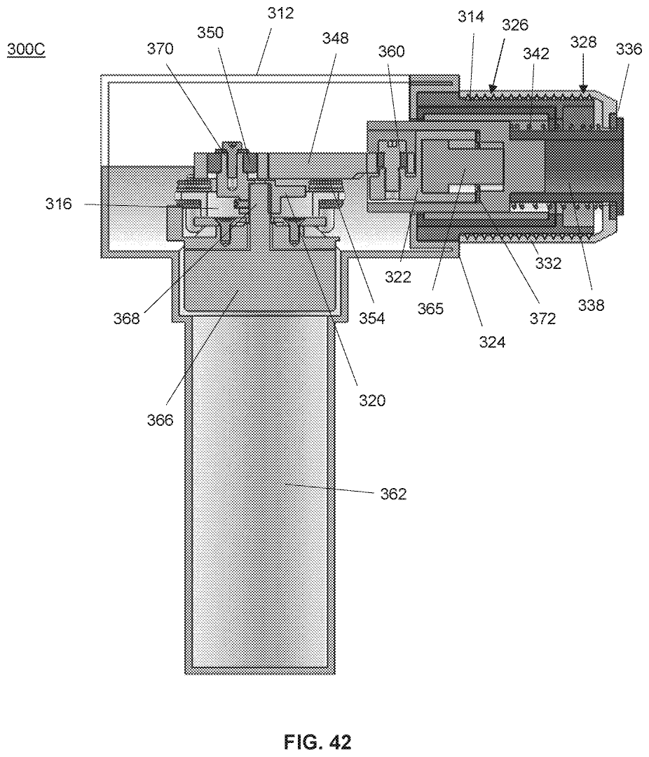

Referring to FIGS. 26-42, various exemplary embodiments of a percussive therapy device 300, 300B-C having a threaded stroke adjustment apparatus 332 are shown. Here, an off-center axle 370 of an eccentric drive unit 320 is positioned in a bearing 350 of a connecting rod 348, and two pistons (primary piston 322, secondary piston 338) are configured to reciprocate to provide percussive therapy to a user. Referring now specifically to FIG. 26, an exemplary percussive therapy device with real time adjustable stroke 300 is shown in a fully retracted, minimum stroke 340 position. A secondary piston 338 of the device 300 may extend 2 mm from this particular position as the device 300 transitions to a fully extended, minimum stroke position (not shown). Referring now to FIGS. 26-28, for illustrative purposes, an upper portion of the housing of the device 300 is not shown. An interior frame 356 of the device may be secured to the housing 312, and a drive assembly frame 316 may be secured to the interior frame 356. The drive assembly frame 316 may regulate movement of an eccentric drive unit 320 positioned therein. In this particular embodiment, the drive assembly frame 316 is secured to the interior frame 356 by multiple fasteners 354, and the upper portion of the housing may be secured to a lower portion of the housing 312 by positioning a fastener in each of multiple fastener channels 318. There may be any number of different techniques, however, for securing various device parts with respect to one another.

Referring again to FIGS. 26-42, the stroke adjustment apparatus 332 of the device 300, 300B-C may permit stroke to be adjusted in real time between an infinite number of different options. The stroke adjustment apparatus 332 may comprise threads 328 spanning a portion of an interior (e.g., 334) surface of the stroke adjustment apparatus 332 (e.g., beginning at a proximal rim portion 330 and extending inwards, as shown in FIGS. 26-28). The threads 328 may engage corresponding threads 326 of an outer surface of a barrel 314 of the device 300, 300B-C to permit regulation of the stroke adjustment apparatus 332 position. The barrel 314 may comprise a bushing (e.g., for vibration isolation). The stroke adjustment apparatus 332 may be rotated a first direction to position the stroke adjustment apparatus 332 closer to a primary front face 324 of the device 300, 300B-C, and may be rotated a second direction to position the stroke adjustment apparatus 332 farther away from the primary front face 324 of the device 300, 300B-C. Although FIGS. 26-42 illustrate threads 326, 328 that permit adjustment of the position of the stroke adjustment apparatus 332 with respect to a barrel 314, in other embodiments, repositioning of an exemplary stroke adjustment apparatus may be additionally or alternatively promoted by one or more magnets, clips, clamps, pins, gear teeth, some combination thereof, or the like. Although in FIGS. 26-42, one stroke adjustment apparatus 332 includes a hollow, substantially cylindrical portion, and a hollow, beveled distal portion, the present invention is not limited to any particular shape, size, position, and/or number of stroke adjustment apparatus. For example, a stroke adjustment apparatus may alternatively include a stroke adjustment knob or gear at any number of different locations of the device.

Referring specifically to FIGS. 26-28, the proximal rim portion 330 of the stroke adjustment apparatus 332 may contact the primary front face 324 when the device 300 is set to a maximum stroke setting, and may be positioned several millimeters or centimeters in front of the primary front face 324 when the device 300 is set to a minimum stroke setting. Referring again to FIGS. 26-42, the stroke adjustment apparatus 332 may be detachable from the barrel 314, although such is not required. A connecting rod 348 may define a reciprocating arm linked to the eccentric drive unit 320, and may cause reciprocal movement of the primary piston 322, which may cause reciprocal movement of the secondary piston 338.

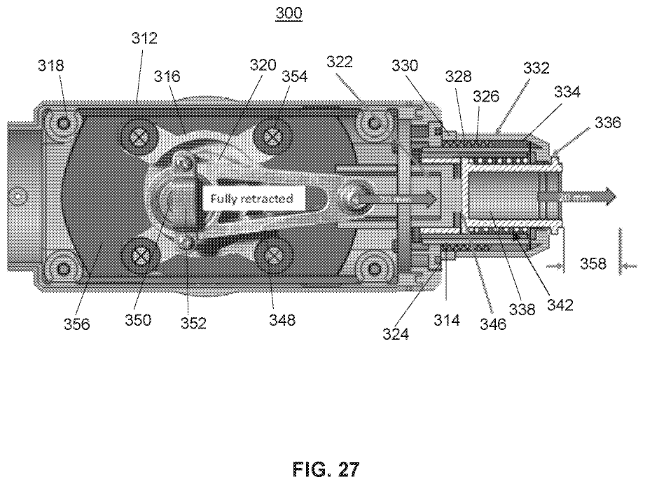

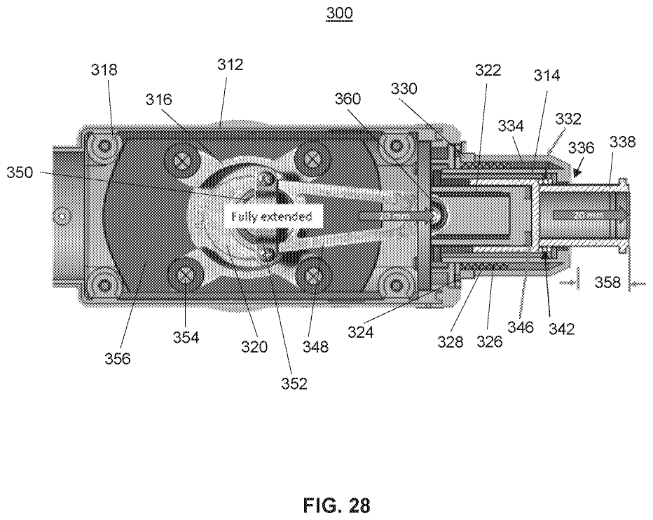

In the illustrative examples of FIGS. 26-42, the primary piston 322 moves forward about 20 mm during each forward movement of the connecting rod 348. However, the primary piston 322 may be permitted to move forward any number of different distances. As the primary piston 322 moves forward, the primary piston 322 may cause corresponding forward movement of the secondary piston 338. The distance the secondary piston 338 moves forward may be equal to (e.g., as illustrated in FIGS. 27-28) or less than (e.g., as illustrated in FIG. 26) the distance the primary piston 322 moves forward. Although FIGS. 26-28 illustrate a possible stroke range of 2 mm-20 mm, the minimum stroke and maximum stroke may be varied within or outside this range.

The position of the stroke adjustment apparatus 332 may determine how far beyond the front end 336 of the device 300, 300B-C the secondary piston 338 may extend (thus affecting stroke). The stroke adjustment apparatus 332 may also be configured to limit the distance the secondary piston 338 may retract into the device 300, 300B-C. Here, the further the stroke adjustment apparatus 332 is positioned from the primary front face 324, the smaller the distance the secondary piston 338 is permitted retract into the barrel 314 and extend from the stroke adjustment apparatus 332 (resulting in smaller stroke). Likewise, here, the closer the stroke adjustment apparatus 332 is positioned to the primary front face 324, the greater the distance the secondary piston 338 is permitted to retract into the barrel 314 and extend from the stroke adjustment apparatus 332 (resulting in greater stroke). Retraction of the secondary piston 338 may be promoted by a return spring 342. The return spring 342 may surround a portion of the secondary piston 338, and may move the secondary piston 338 backwards immediately after the secondary piston 338 is pushed forward by the primary piston 322. The force exerted on the secondary piston 338 by a user's body may also promote retraction of the

### Secondary Piston 338.

The stroke adjustment apparatus 332 may be rotated clockwise or counterclockwise to adjust the stroke in real time. The rotation may occur while the device 300 is in operation. As a non-limiting example, during an ongoing treatment, a user may use one's hand to rotate the stroke adjustment apparatus 332 (e.g., turning the stroke adjustment apparatus 332 clockwise or counterclockwise with one's fingers). The rotating action may cause (from engagement between corresponding threads 326, 328) a change in the distance between the stroke adjustment apparatus 332 and the primary front face 324. As an alternative non-limiting example, during an ongoing treatment, a user may actuate a motor (e.g., a stepper motor) configured to rotate the stroke adjustment apparatus 332 to cause a change in the distance between the stroke adjustment apparatus 332 and the primary front face 324. The stroke adjustment apparatus 332 may be rotated between an infinite number of different angular positions, thus there may be an infinite number of different stroke length options.

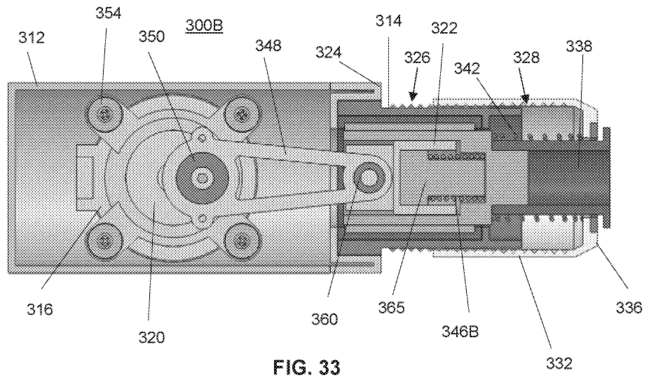

Referring to FIGS. 26-28, a shock absorbing spring 346 may be positioned between the primary piston 322 and the secondary piston 338. In FIG. 26, the spring 346 spans a gap 344 between each piston 322, 338. The gap 344 may be about 18 mm long when the device 300 is in a retracted position and set to a minimum stroke setting, although any number of different gap lengths are contemplated. Referring to FIGS. 33-38, a shock absorbing spring 346B may extend onto and surround at least a portion of a plug 365 positioned at the primary piston 322, and may span a gap between the plug 365 and the secondary piston 338 when the device 300B is in a retracted position and set to a minimum stroke setting. Referring to FIGS. 33-42, the plug 365 may be attached within an opening of the primary piston 322. The plug 365 may define part of the primary piston 322, and may be metal. The plug 365 may alternatively be hard rubber, and may cushion the contact against the secondary piston 338 as the primary piston 322 is driven forward. The plug 325 may maintain its shape, and may maintain the spring 346B, 372 position as the primary piston 322 is driven forward. Referring now to FIGS. 26-42, the shock absorbing spring 346, 346B may be configured to reduce noise of the device 300, 300B as the pistons 322, 338 interact with one another by reducing the impact the primary piston 322 exerts on the secondary piston 338. The shock absorbing spring 346, 346B may also reduce the impact the secondary piston 338 exerts (whether directly or indirectly from a massage attachment) on tissue by reducing the impact the primary piston 322 exerts on the secondary piston 338. The reduced impact of the secondary piston 338 on tissue may reduce the risk of treatment-related issues (e.g., reduced risk of rhabdomyolysis).

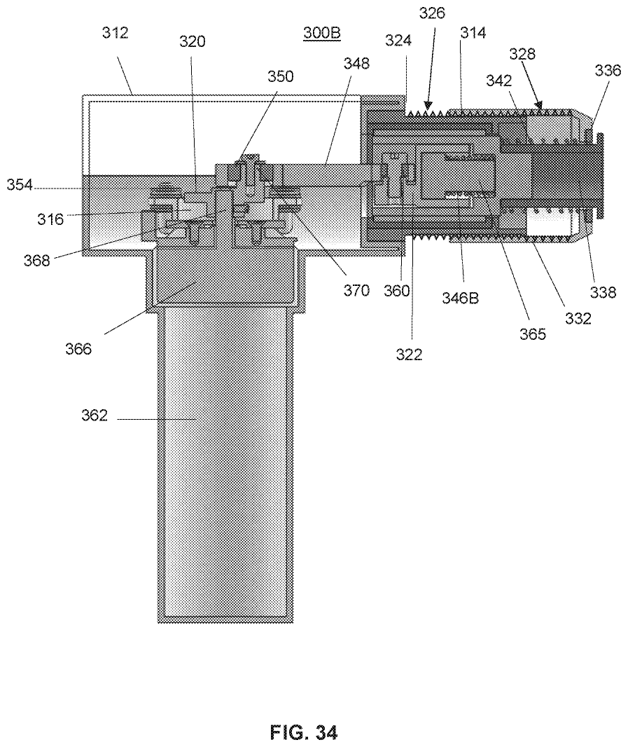

Referring now to FIGS. 34, 36, 38, 40 and 42, a motor 366 may be secured within the device 300B-C. Here, the motor 366 is secured below the eccentric drive unit 320 and drive assembly frame 316, and is positioned partially within a handle 362 of the device 300B-C. However, the motor 366 may be secured to any part of the housing 312, an interior frame, another component of the device, some combination thereof, or the like without departing from the scope of the present invention. The motor 366 may be powered by a power module (not shown). The power module may include a battery (e.g., a rechargeable battery) positioned in the handle 362 of the device 300B-C. The motor 366 may include a drive motor, and a drive motor axle or rotating motor shaft 368. The drive motor may cause the drive motor/rotating motor shaft 368 to spin. There may be any number of different devices and/or techniques available for powering an exemplary motor and/or actuating an exemplary motor shaft.

The rotating motor shaft 368 may be received by the eccentric drive unit 320, and rotation of the rotating motor shaft 368 may cause the eccentric drive unit 320 to spin within the drive assembly frame 316. The spinning/rotation of the eccentric drive unit 320 may cause movement (e.g., ellipsoidal orbit movement) of an off-center axle 370 extending up from the eccentric drive unit 320 and positioned in a bearing 350 of the connecting rod 348. Movement of the off-center axle 370 may cause movement of the bearing 350, which may cause reciprocal movement the connecting rod 348. The movement of the connecting rod 348 may cause reciprocal movement of the primary piston 322. Referring to FIGS. 26-28, a fastening apparatus 352 may prevent the eccentric drive unit 320, bearing 350, and/or connecting rod 348 from becoming disconnected from one another.

In the embodiments shown in FIGS. 26-42, the components (e.g., motor 366, motor shaft 368, eccentric drive unit 320, off-center axle 370) regulating movement of the connecting rod 348 do not include gears. Gearless operation may permit the device 300 to operate at low noise levels, since interaction between gears often results in noise. The low number of components involved here for actuating the connecting rod 348 may allow for low manufacturing costs, low repair costs, low energy usage requirements, low space usage requirements, low device weight, some combination thereof, or the like.

The primary piston 322 may oscillate (e.g., in a straight line) forward and backward between an extended and retracted position. The forward and backward movement of the primary piston 322 may occur with respect to a barrel 314. The secondary piston 338 may be aligned with the primary piston 322, and may be positioned in front of the primary piston 322. Frequency (number of reciprocal motions of the secondary piston 338 per unit time) may be adjusted in real time by adjusting rotation velocity of the motor shaft 368, such as, for example, during operation of the device 300. A motor control (not shown) may permit adjustment of the motor shaft 368 rotation velocity, and may be located on the device 300, 300B-C exterior. The motor shaft 368 rotation velocity may be adjusted between any number of different velocities.

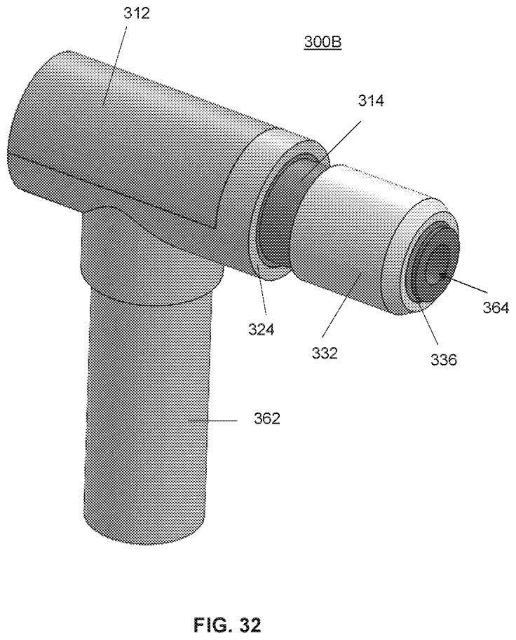

A massage attachment or other therapy feature may be positioned at or near a distal end of the secondary piston 338. Referring to FIGS. 31-32, a portion of a massage attachment may be secured within a channel 364 of the device 300B. Referring again to FIGS. 26-42, the massage attachment or other therapy feature may contact and apply reciprocal forces to the body of a user while the secondary piston 338 oscillates. The massage attachment may be configured to provide local vibration therapy. Any number of different massage attachments may be employed. Furthermore, the shape, size, material composition, and the like of various device 300, 300B-C components may be varied without departing from the scope of the present invention.

Referring again specifically to FIG. 26, when the device 300 is set to a minimum stroke setting (here, the stroke adjustment apparatus 332 is positioned a maximum distance away from the primary front face 324), the primary piston 322 may move forward about 20 mm, and in doing so push the secondary piston 338 forward about 2 mm. Thus, in the FIG. 26 example, the stroke 340 is about 2 mm. As the primary piston 322 retracts, the secondary piston 338 may only be permitted by the stroke adjustment apparatus 332 to retract about 2 mm. Although in the FIG. 26 example, the minimum stroke is 2 mm, the minimum stroke may be lower or greater in other embodiments.

Referring now to FIG. 27, the device 300 is shown in a fully retracted, maximum stroke 358 position. Referring to FIG. 28, the device is shown in a fully extended, maximum stroke 358 position. In FIGS. 27 and 28, the stroke adjustment apparatus 332 is positioned a minimum distance away from the primary front face 324 (the distance is about 0 mm in this particular example). The distance may be greater than 0 mm in other embodiments. The primary piston 322 may move forward about 20 mm, and in doing so push the secondary piston 338 forward about 20 mm. Thus, in the FIGS. 27-28 example, the stroke 358 is about 20 mm. As the primary piston 322 retracts, the secondary piston 338 may be permitted by the stroke adjustment apparatus 332 to retract a full 20 mm. Although in the FIGS. 27-28 example, the maximum stroke is 20 mm, the maximum stroke may be lower or greater in other embodiments.

The distance between each piston 322, 338 in the maximum stroke setting may be about 0 mm. Alternatively, the distance between each piston 322, 338 in the maximum stroke setting may be greater than 0 mm (there may be a small gap between each). A shock absorbing spring 346 may be positioned between each piston 322, 338, and may be substantially compressed when the device 300 is set to a maximum stroke setting. A second bearing 360 may permit attachment and movement between the connecting rod 348 and the primary piston 322.

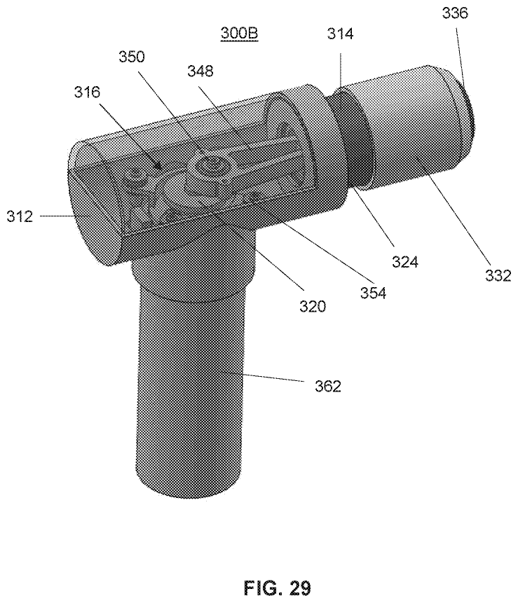

Referring to FIGS. 29-42, a drive assembly frame 316 may be secured within a housing 312 by a number of fasteners 354. The drive assembly frame 316 may regulate movement of an eccentric drive unit 320 positioned therein. An upper portion of the housing 312 is shown as transparent in FIGS. 29 and 31 for illustrative purposes. The color and/or transparency of an exemplary housing may be varied. Still referring to FIGS. 29-42, an exemplary device 300B-C may include at least one handle 362 of any number of different shapes and/or sizes. The handle 362 may permit a user to position the device 300B-C with respect to the user's body. A second bearing 360 may permit attachment and movement between the connecting rod 348 and the primary piston 322. The secondary piston may extend about 2 mm from the front end 336 of the device 300B-C when the device 300B-C is in the fully extended, minimum stroke position. The secondary piston may extend about 20 mm from the front end 336 of the device 300B-C when the device 300B-C is in the fully extended, maximum stroke position.

Magnets (not shown) may regulate positioning of the pistons 322, 338 with respect to one another. As a non-limiting example, a pair of opposing magnets, one magnet on a front face of the primary piston 322, the other magnet on a back face of the secondary piston, 338, may be provided. The poles of the magnets may face each other and oppose one another (the opposing force may increase as the pistons 322, 338 are located closer to one another). The opposing force may cause the magnets to function like a spring in regulating positioning of the pistons 322, 338 with respect to one another. The magnets of this particular example may replace spring 346. Likewise, the return spring 342 may be replaced by magnets. As a non-limiting example, several magnets may be spaced apart from one another and positioned around a perimeter of a front portion of the secondary piston 338. Corresponding magnets may be positioned at or proximate to the opening at the front end 336 of the adjustment apparatus 332. The present invention is not limited to any particular shape, type, location, and/or number of magnets.

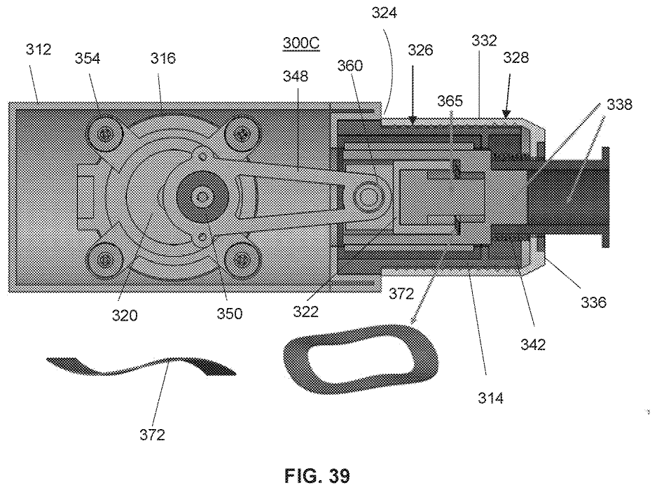

Referring specifically to FIGS. 39-42, the cushion plug 365 may be solid rubber, and may be positioned at the primary piston 322 for engaging the secondary piston 338. The secondary piston 338 may be defined by more than one piece (e.g., multiple pieces may be threaded, and/or fastened together) (e.g., to permit assembly of the stroke adjustment apparatus 332 and return spring 342 with the secondary piston 338). A low-profile wave spring 372 may be provided at the primary piston 322. The low-profile wave spring 372 of the device 300C may replace the shock absorbing spring of the device 300B. The low-profile wave spring 372 may be configured to be compressed and avoid contact with the secondary piston 338 until the primary piston 322 is within a very small distance (e.g., 4 mm) from the secondary piston 338. The aforementioned configuration may prevent the wave spring 372 and the return spring 342 from interfering with one another, and may allow the return spring 342 to have a lower spring rate.

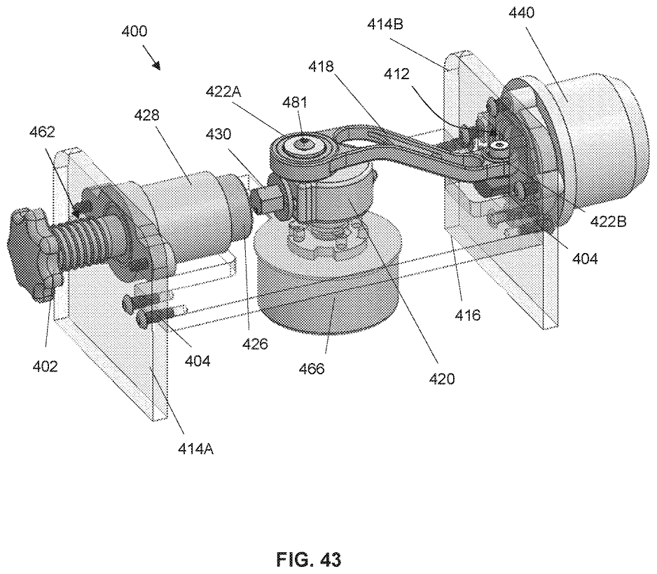

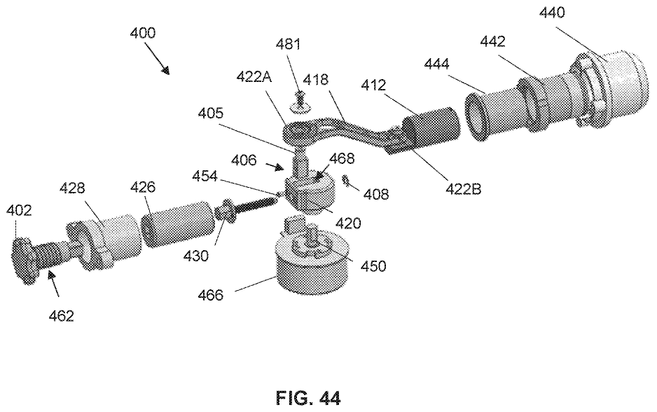

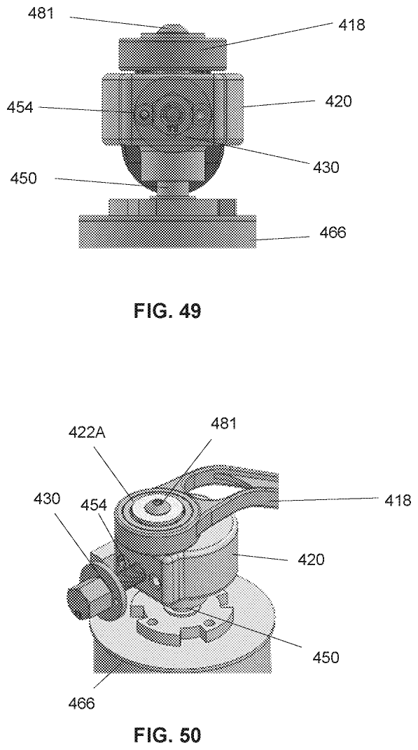

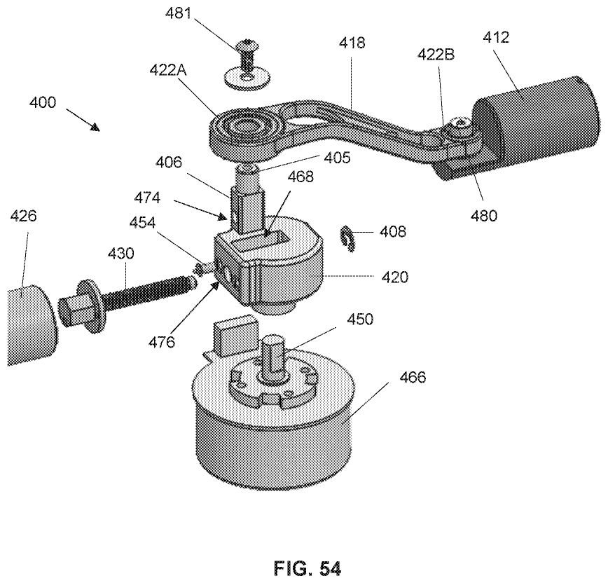

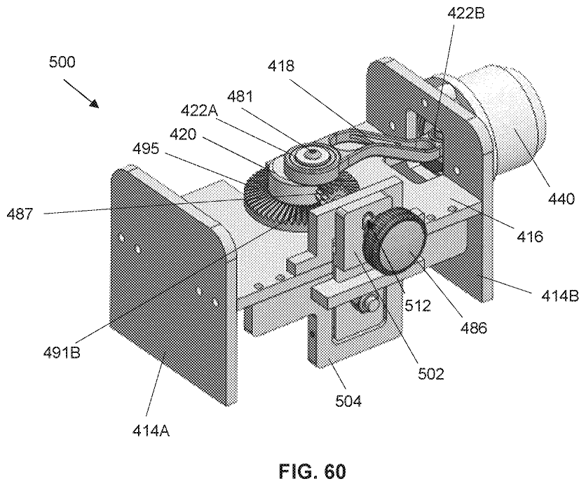

Referring to FIGS. 43-62, in certain exemplary embodiments, stroke/amplitude adjustment may be achieved by moving an eccentric drive axle 406 (where a connecting rod 418 attaches to an eccentric drive 420) at varying distances with respect to the centerline of a motor 466. Here, the lack of a requirement, for example, for noise-generating drive gear mechanisms, provides for a low cost, optimal complexity device that operates at low noise levels. The device 400, 500 may, for example, promote user comfort by operating at low noise levels, and may allow for the user to use the device 400, 500 in any number of different settings as a result of low noise level operation. The optimal complexity of the device 400, 500 may also promote ease of maintaining and repairing the device 400, 500. The device 400, 500 may include horizontal 416 and vertical 414A-B frames as well as a number of fasteners 404, 464 for securing various device components.

Referring specifically to FIGS. 43-56, an exemplary adjustable amplitude percussive therapy device 400 may include a stroke adjustment apparatus (here, collectively including an adjustment knob 402, return spring 462, adjustment knob bushing 428, adjustment socket 426, and stroke adjustment screw 430), motor 466, eccentric drive 420, eccentric drive axle 406, connecting rod 418 and piston 412. The connection rod 418 may be substantially curved in shape (a first bearing 422A of the connection rod 418 may be positioned above a second bearing 422B thereof) as opposed to being substantially flat in shape. The first bearing 422A may be in mechanical communication with the eccentric drive axle 406, and the second bearing 422B may be mechanical communication with a piston connector 480. The vertical offset between the location where the eccentric drive axle 406 connects to the first bearing 422A, and the location where the connection rod 418 attaches to the piston 412 (e.g., at the second bearing 422B) may permit reduced vertical dimensions of device housing (not shown).

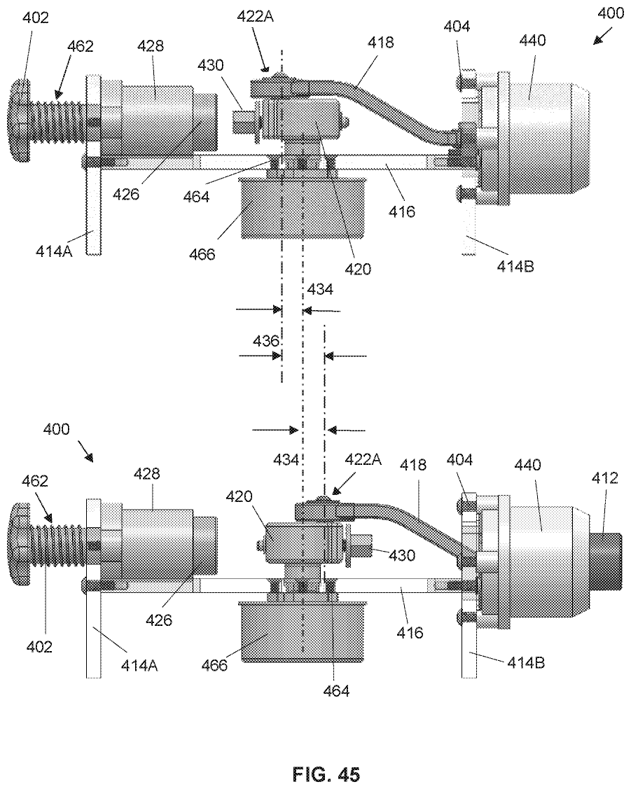

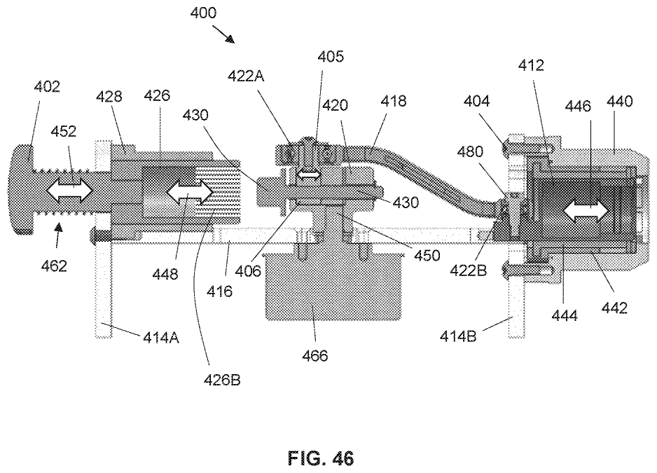

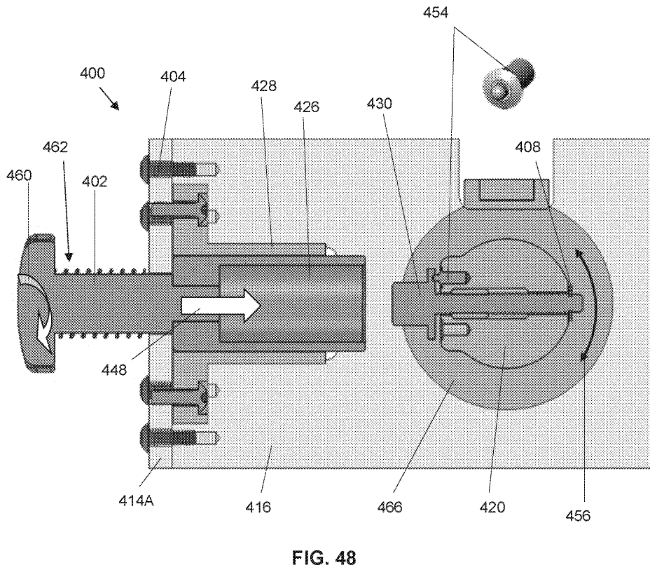

The motor 466 may include a rotating motor shaft 450. Rotation of the motor shaft 450 may cause rotation of the eccentric drive 420 (e.g., as shown by arrow 456 is FIG. 48). Rotation of the eccentric drive 420 may cause movement of the eccentric drive axle 406. Movement of the eccentric drive axle 406 may drive reciprocal motion of the connecting rod 418. Reciprocal motion of the connecting rod 418 may drive reciprocal motion of the piston 412 (e.g., as shown by arrow 446 in FIG. 46) within a piston bushing 440, 442, 444. The position of the eccentric drive axle 406 within an aperture 468 of the eccentric drive 420 may determine stroke of the piston 412. Stroke may be adjusted by moving a connection point 405 (which may be received by the bearing 422A and secured by securing apparatus 481, such as, for example, a fastener and washer) of the eccentric drive axle 406 closer to or farther from the centerline 434 of the motor 466 (such as shown in FIG. 45). For example, here, when the eccentric drive axle 406 is secured within the eccentric drive 420 further away from the piston bushing 440, 442, 444 when the piston 412 is in an extended position, the stroke of the piston 412 is smaller. Here, when the eccentric drive axle 406 is secured within the eccentric drive 420 closer to the piston bushing 440, 442, 444 when the piston 412 is in an extended position, the stroke of the piston 412 is greater. The stroke adjustment screw may be received in channels 476, 474 of the eccentric drive 420 and eccentric drive axle 406. A c-clip 408 may be provided to prevent the stroke adjustment screw 430 from becoming dislodged from the eccentric drive 420.

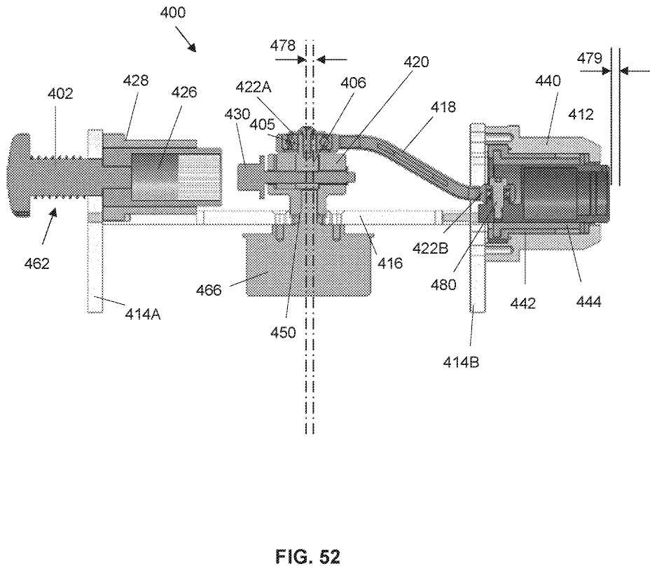

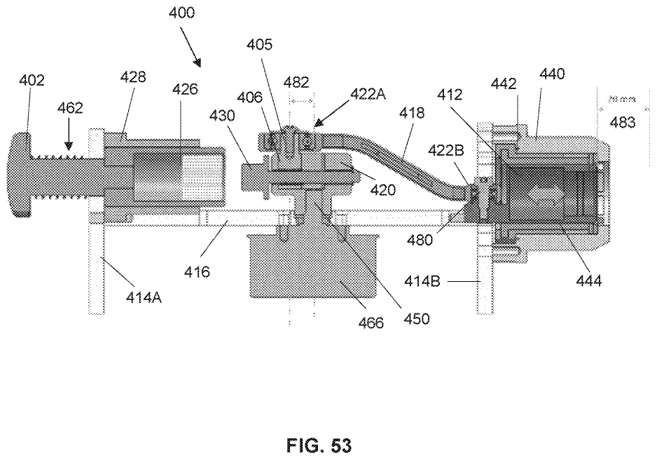

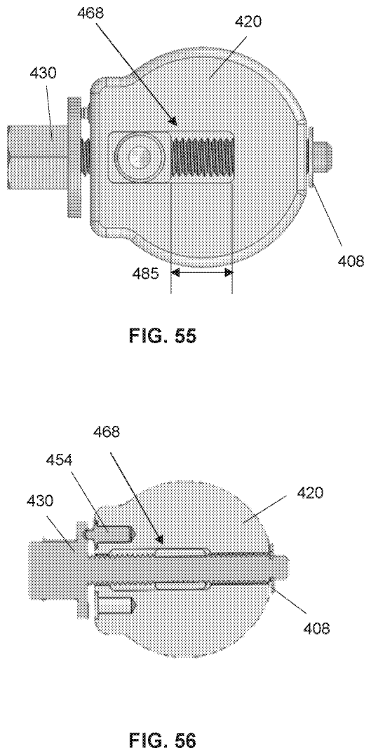

The stroke of the piston 412 may be two times offset with respect to the distance of the centerline 436 of the eccentric drive axle 406 from the centerline 434 of the motor 466 (as shown in FIG. 45). For example, where the eccentric drive axle 406 centerline 436 is 0.5 mm (478 in FIG. 52) from the centerline 434 of the motor 466, the stroke of the piston 412 may be 1 mm (479 in FIG. 52). As another example, where the eccentric drive axle 406 centerline 436 is 10 mm (482 in FIG. 53) from the centerline 434 of the motor 466, the stroke of the piston 412 may be 20 mm (483 in FIG. 53). A 180-degree rotation of the eccentric drive 420 may cause movement of the piston 412 from a retracted to extended position (as shown in FIG. 45-where the offset of the eccentric drive axle 406 alternates from behind the motor axle 450 to in front of the motor axle), and vice versa. A plurality of 360-degree rotations of the eccentric drive 420 may cause a plurality of piston 412 strokes. The present invention is not limited to piston stroke ranging between 1 mm-20 mm. Stroke range may be 1 mm-16 mm in certain embodiments. Minimum stroke may be less than 1 mm in certain embodiments. The stroke range may be altered by adjusting the diameter of the eccentric drive 420 (e.g., the aperture 468 length 485 in FIG. 55 represents stroke adjustment range). Any number of different stroke ranges are contemplated.

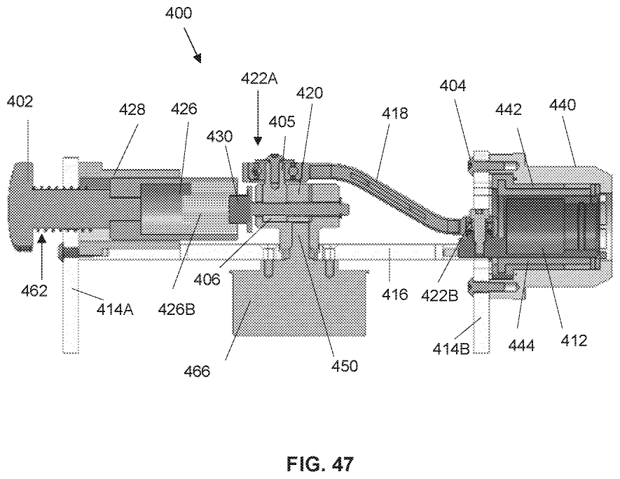

The adjustment socket 426 of the stroke adjustment apparatus may be configured to be pushed forward 448 by forward motion 452 of the adjustment knob 402 to engage the adjustment screw 430 when the motor 466 is off. Said forward motion 452 may be caused by a user (e.g., the user's hand). The return spring 462 may return the adjustment knob 402 to its initial position after the user is done engaging the stroke adjustment apparatus. The adjustment socket 426 may include a plurality of spring-loaded pins 426B, which may accommodate any number of different stroke adjustment screws 430 of varying shapes and/or sizes. The pins of the adjustment socket 426 may surround a head of the stroke adjustment screw 430 (e.g., as shown in FIG. 47) to allow for rotation of the adjustment socket 426 (e.g., caused by rotation of the adjustment knob 402 by a user-as shown by arrow 460 in FIG. 48) to cause rotation of the adjustment screw 430. Rotation of the stroke adjustment screw 430 may cause a change in position of the eccentric drive axle 406 within the eccentric drive 420. For example, where the stroke adjustment screw 430 is rotated a first direction (e.g., clockwise), the stroke of the piston 412 may be increased. Where the stroke adjustment screw 430 is rotated a second direction (e.g., counterclockwise), the stroke of the piston 412 may be decreased. External threads of the stroke adjustment screw 430 may engage corresponding threads of the eccentric drive axle 406 to cause repositioning of the eccentric drive axle 406 along the aperture 468.

The user may press in the stroke adjustment knob 402 inward 452 until the adjustment socket 426 is moved forward 448 enough to engage the adjustment screw 430 (e.g., as shown in FIG. 47). A full rotation of the stroke adjustment knob 402 may adjust the eccentric drive axle 406 position by 1 mm (e.g., resulting in a 2 mm piston stroke change), although such is not required. The stroke adjustment screw 430 may be locked in position by a ball detent 454 while the device 400 is in operation (i.e., the ball detent 454 may prevent the head of the stroke adjustment screw 430 from rotating while the motor 466 is operating). The ball detent 454 may be spring loaded, and may engage an aperture (e.g., among two equally spaced apertures) in the flange of the adjustment screw 430 head. The ball detent 454 may provide for two clicks per rotation of the adjustment screw 430, where each click indicates to a user a certain amount (e.g., 1 mm) of stroke change. The motor 466 may include an integral position sensor including and/or being linked to circuitry for orienting the motor 466 in a correct position. Any number of different devices, materials, and/or techniques may be provided for regulating an exemplary adjustment screw. Furthermore, the adjustment screw is not limited to any particular size and/or shape.

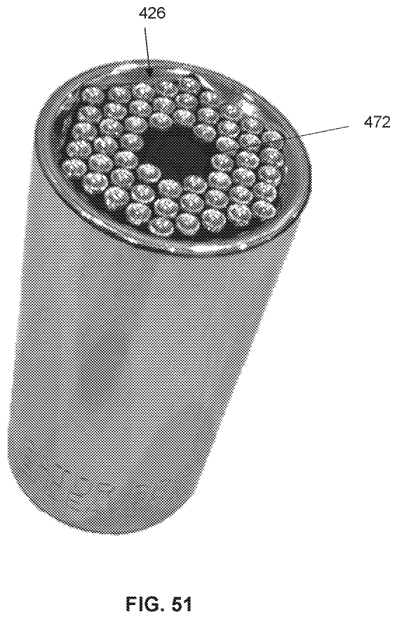

The adjustment socket 426 may include 64 spring loaded pins, although any number of different pins is contemplated. The pins 426B may conform to the shape of the stroke adjustment screw 430 head (e.g., hexagonal shape). The pins 426B may be biased outward. As the socket 426 is pushed onto the stroke adjustment screw 430 head, the pins in contact with the head may be pushed inward (e.g., 472 in FIG. 51) until the socket 426 is fully engaged with the head. The pins 426B remaining fully extended may engage the side of the stroke adjustment screw 430 head when the socket 426 is turned to cause the stroke adjustment screw 430 to rotate. Variations to the shape, size and/or type of the adjustment socket 426 may be made without departing from the scope of the present invention.

The piston bushing may include a bushing retainer 440, and a vibration isolator or elastomer 442 positioned between the bushing retainer 440 and a lubricated bushing 444. The aforementioned configuration may restrict the propagation of vibrations within the device 400 from piston 412 movement. The bushing retainer 440 may be a nose cone, and may include threads, although such is not required. A massage attachment (not shown) may be linked to a distal end of the piston 412. The user may be required to push in the piston 412 before adjusting the stroke. Variations to the stroke adjustment apparatus (e.g., the type and presence of components for engaging the stroke adjustment screw) and other device components may be made without departing from the scope of the present invention.

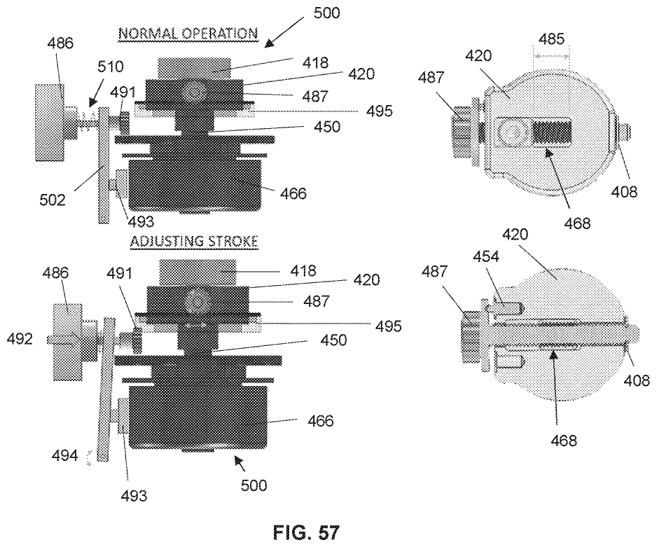

In the alternative exemplary embodiment of FIGS. 57-62, an adjustable amplitude percussive therapy device 500 includes a brake 493 and ring gear 495. Certain other components shown in FIGS. 57-62 (e.g., bushing 440, piston 412, connecting rod 418 having bearings 422A-B, securing apparatus 481, eccentric drive axle 406, c-clip 408, eccentric drive 420 having an aperture 468 with length 485, ball detent 454, threads on the eccentric drive axle 406 and stroke adjustment screw shaft, motor 466 and motor axle 450) may be substantially similar to components of FIGS. 43-56. The ball detent 454 may also be mounted parallel to the motor shaft 450 within the eccentric drive 420 to engage the ring gear 495. The stroke adjustment apparatus may include a stroke adjustment knob 486, stroke adjustment shaft 510, adjustment gear 491, ring gear 495, and stroke adjustment screw 487. Advantages of the FIGS. 57-62 example embodiment include, e.g., user ability to adjust stroke regardless of where a stroke adjustment screw head 487 is located (thus, the user is not required to press in the piston 412 to align the stroke adjustment screw head 487 with an adjustment socket), ability to adjust stroke without directly contacting the stroke adjustment screw 487, and ease of user ability to adjust stroke.

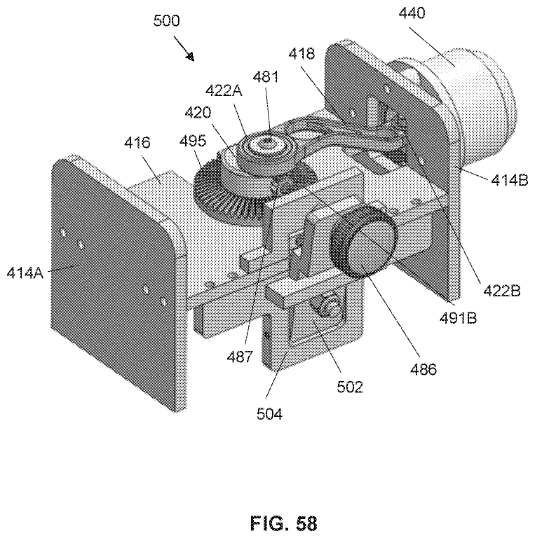

The stroke adjustment knob 486 may be positioned at either side of the device 500. The stroke adjustment knob 486 may be in mechanical communication with the stroke adjustment shaft 510. The stroke adjustment shaft 510 may include a return spring 512. The user may press the stroke adjustment knob 486 inward 492 to cause the adjustment gear 491 (491B in FIGS. 58-62) to engage gear teeth of the ring gear 495. The ring gear 495 may be rotatably mounted to the eccentric drive 420, and engaged with the stroke adjustment screw 487. The user may rotate the stroke adjustment knob 486 after pushing in the stroke adjustment knob 486 to cause rotation of the adjustment gear 491, 491B, which may cause rotation of the ring gear 495. Gear teeth at a perimeter of the head of the stroke adjustment screw 487 may be in mechanical communication with gear teeth of the ring gear 495. Rotation of the ring gear 495 may thus cause rotation of the stroke adjustment screw 487 to cause repositioning of the eccentric drive axle 406 to adjust stroke of the piston 412.

The user may release the adjustment knob 486, and the return spring 512 may return the adjustment knob 486 back to its initial position, repositioning the adjustment gear 491, 491B away from the ring gear 495. A brake shoe 493 may be provided to lock the motor 466 in place (i.e., cause the motor 466 to cease rotation of the motor shaft 450) when the stroke adjustment screw 487 is to be adjusted. A lever 502 may be rotated (e.g., as shown by arrow 494 in FIG. 57) as the adjustment knob 486 is pushed in to cause the brake shoe 493 to press against the rotating body of the motor 466 to cease rotation of the motor shaft 450 (to ensure the eccentric drive 420 is stationary during adjustment of the stroke adjustment screw 487 and eccentric drive axle 406 position within the eccentric drive 420). Thus, the motor shaft 450 may be automatically halted whenever the user engages the adjustment knob 486 to adjust the stroke of the piston 412 by rotating the adjustment gear 491, 491B. A safety switch may also be provided to prevent power to the motor 466 when stroke is being adjusted. Return springs (e.g., 512, 506) may cause the lever 502 to be rotated away from the motor 466 when the device is operating to perform percussive therapy. Stroke may be adjusted between 1 and 16 mm, although any number of different stroke adjustment ranges are contemplated.

Referring specifically to FIG. 57, the adjustment gear 491 may be configured to for substantially linear motion towards the ring gear 495, and may engage the ring gear 495 from an underside thereof. Alternatively, referring to FIGS. 58-62, the adjustment gear 491B may be tapered, and configured to engage the ring gear 495 (e.g., at an angle) from a topside thereof. Any number of variations to the shape, size, and/or configuration of the gears and other device components may be made without departing from the scope of the present invention. The gears may be beveled (e.g., for ease of meshing during adjustment). The motor 466 may be configured to be adjusted to regulate frequency (e.g., even during active operation of the device). Adjustment of amplitude and/or frequency may occur in real time.

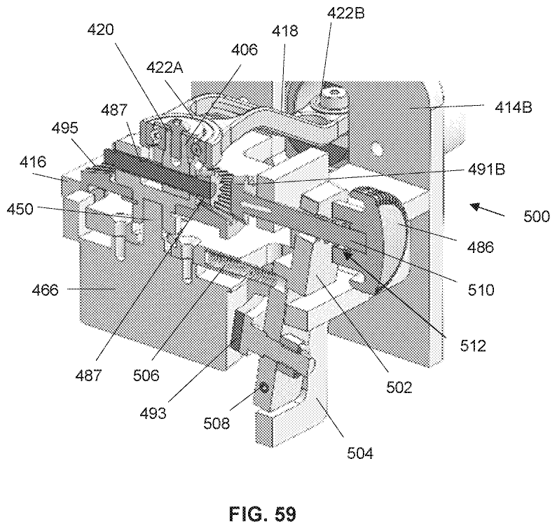

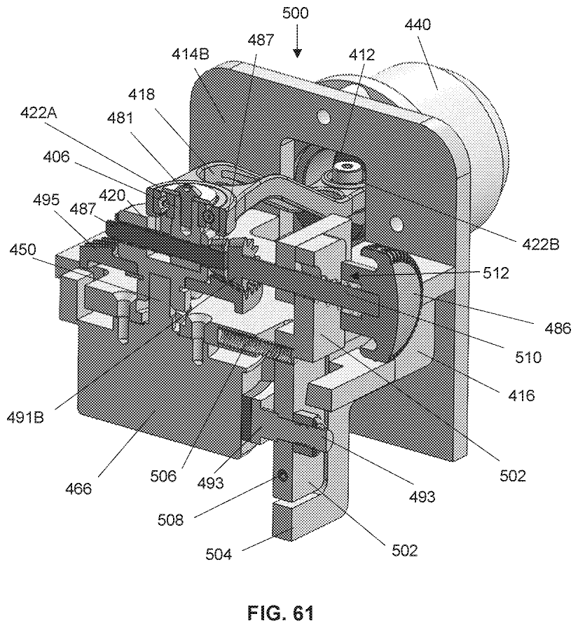

The lever 502 may rotate about a pivot point 508 relative to a lever frame 504. FIG. 61 illustrates an example of the adjustment gear 491B engaging the ring gear 495. The stroke adjustment shaft 510 may move forward linearly as the adjustment knob 486 is engaged by the user, although such is not required. A lever return spring 506 may be in a state of compression before the user presses in the adjustment knob 486. The lever return spring 506 may ensure the brake shoe 493 is positioned away from the motor 466 while the device 500 is operating. An interior portion of the eccentric drive axle 406 may be threaded, and the interior of the eccentric drive 420 may not be threaded (allowing the portion of the stroke adjustment screw 487 in contact with the eccentric drive 420 to rotate without causing movement of the eccentric drive 420. FIG. 59 illustrates an example of the adjustment gear 491B not engaging the ring gear 495.

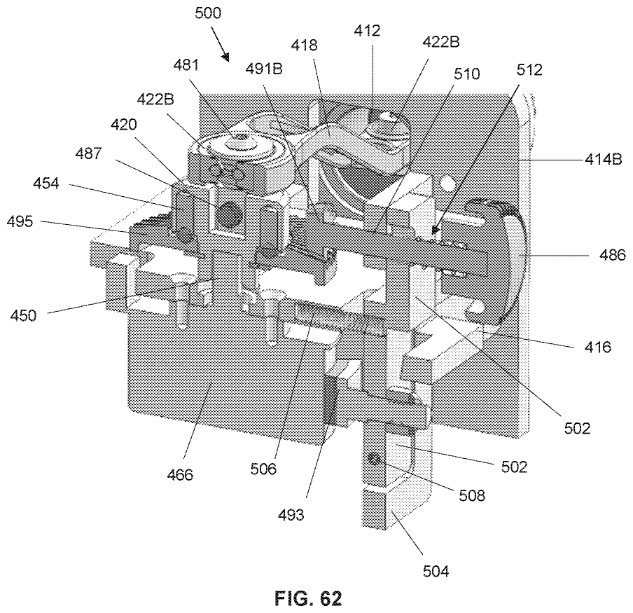

The adjustment knob 486 may be rotated a first direction (e.g., clockwise) to increase stroke, and a second direction (e.g., counterclockwise) to decrease stroke. In FIG. 62, two ball detents 454 are shown, which may cause the stroke adjustment screw 487 to be locked in position while the device 500 is in operation. The ball detents 454 may engage dimples in the ring gear 495 to prevent the ring gear 495 from turning during percussive therapy operation of the device 500. Thus, the ball detents 454 may prevent the stroke of the piston 412 from changing unless intended by the user. The ball detents 454 may also indicate the amount of stroke adjustment to the user (e.g., each click, which may occur after each rotation of the knob 486, may indicate a certain amount of stroke adjustment, such as 1 mm of stroke adjustment).

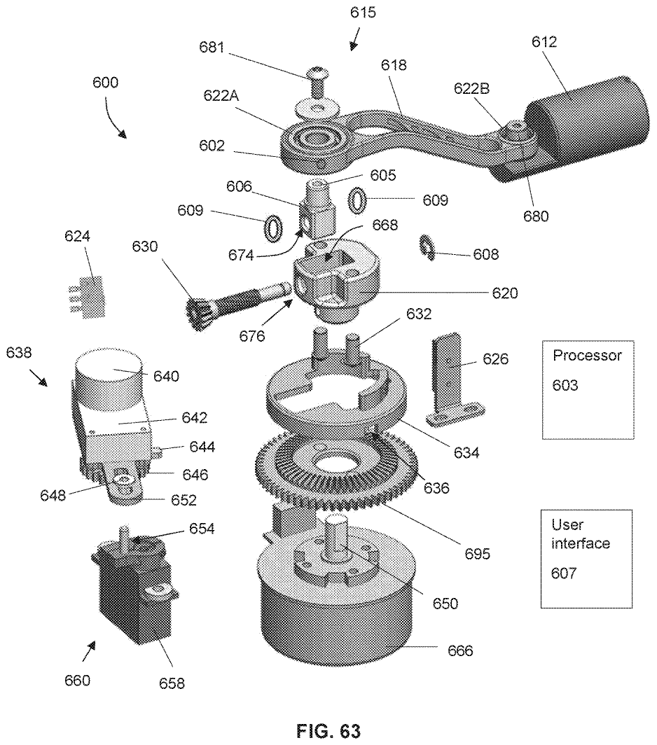

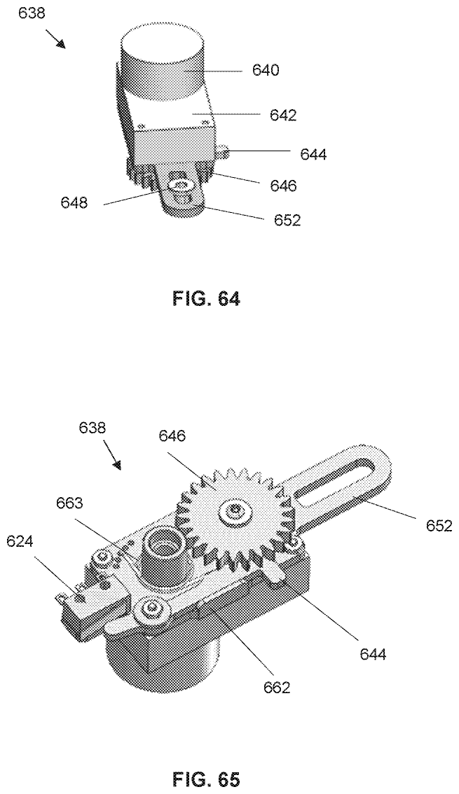

Another exemplary embodiment is shown in FIGS. 63-71. Here, an exemplary adjustable amplitude percussive therapy device 600 includes a stroke adjustment assembly 638, adjustment servo 660, drive assembly 615, connection rod 618, and piston 612. The stroke adjustment assembly 638 may include an adjustment motor 640, micro switch 624, gear reduction box 642, pawl 644, pawl stop 662, adjustment drive gear 646, adjustment arm 652, and servo arm receiver 648. The adjustment servo 660 may include an adjustment servo arm 654 and servo motor 658. The drive assembly 615 may include an eccentric drive axle 606, eccentric drive unit 620, brake rotor 634, ring gear 695, and motor 666 having a shaft 650. The motor 666 may include an integral position sensor including and/or being linked to circuitry for orienting the motor 666 in a correct position. The device 600 may include horizontal 616 and vertical 614A-B frames as well as a number of fasteners (e.g., 686) for securing various device components. Various different materials and/or methods may be employed for linking device components to one another without departing from the scope of the present invention.

The connection rod 618 may be substantially curved in shape (a first bearing 622A of the connection rod 618 may be positioned above a second bearing 622B thereof). The first bearing 622A may be in mechanical communication with the eccentric drive axle 606, and the second bearing 622B may be in mechanical communication with a piston connector 680. The vertical offset between the location where the eccentric drive axle 606 connects to the first bearing 622A, and the location where the connection rod 618 attaches to the piston 612 (e.g., at the second bearing 622B) may permit reduced vertical dimensions of a device housing (not shown).

The motor 666 may include a rotating motor shaft 650. Rotation of the motor shaft 650 may cause rotation of the eccentric drive 620. Rotation of the eccentric drive 620 may cause movement of the eccentric drive axle 606. Movement of the eccentric drive axle 606 may drive reciprocating motion of the connecting rod 618. Reciprocating motion of the connecting rod 618 may drive reciprocating motion of the piston 612 within a piston bushing 641. The position of the eccentric drive axle 606 within an aperture 668 of the eccentric drive 620 may determine stroke of the piston 612. Stroke may be adjusted by moving a connection point 605 (which may be received by the bearing 622A and secured by a securing apparatus 681, such as, for example, a fastener and washer) of the eccentric drive axle 606 closer to or farther from the centerline of the motor 666.

For example, here, when the eccentric drive axle 606 is secured within the eccentric drive 620 further away from the piston bushing 641 (e.g., further to the left in FIG. 63) when the piston 612 is in an extended position, the stroke of the piston 612 is larger. Here, when the eccentric drive axle 606 is secured within the eccentric drive 620 closer to the piston bushing 641 (e.g., further to the right in FIG. 63) when the piston 612 is in an extended position, the stroke of the piston 612 is lesser. A stroke adjustment screw 630 may be provided to engage beveled gear teeth (e.g., the teeth inside the perimeter of the ring gear 695 on the top side thereof in FIG. 63) of a ring gear 695. The stroke adjustment screw 630 may comprise a head with gear teeth, and a shaft having external threads. The stroke adjustment screw 630 may be received in channels 676 and 674 of the eccentric drive 620 and eccentric drive axle 606, respectively. A c-clip 608 may be provided to prevent the stroke adjustment screw 630 from becoming dislodged from the eccentric drive 620.

Rotation of the stroke adjustment screw 630 may cause a change in position of the eccentric drive axle 606 within the eccentric drive 620. For example, where the stroke adjustment screw 630 is rotated a first direction (e.g., clockwise), the stroke of the piston 612 may be increased. Where the stroke adjustment screw 630 is rotated a second direction (e.g., counterclockwise), the stroke of the piston 612 may be decreased. External threads of the stroke adjustment screw 630 may engage corresponding threads of the eccentric drive axle 606 to cause repositioning of the eccentric drive axle 606 along the aperture 668. Various different devices, materials, and/or techniques may be provided for regulating an exemplary stroke adjustment screw. Furthermore, the adjustment screw is not limited to any particular size and/or shape.

The ring gear 695 and the adjustment drive gear 646 may be configured to be in mechanical communication with one another when the eccentric drive 620 is locked by the brake rotor 634 (e.g., by way of the pawl 644), and to be spaced apart from one another when the motor 666 is spinning. When a user and/or system program dictates that stroke is to be adjusted, the adjustment servo motor 658 may move the stroke adjustment assembly 638 close to the ring gear 695, and the adjustment gear 646 may engage gear teeth on the perimeter of ring gear 695. The adjustment motor 640 may be activated once the eccentric drive 620 is locked. The adjustment motor 640 may cause rotation of the adjustment drive gear 646, which in turn may cause rotation of the ring gear 695 (e.g., by way of the adjustment drive gear 646 engaging spur gear teeth at the edge of the ring gear). The gear reduction box 642 may be configured to regulate the speed of the adjustment motor 640. For example, the gear reduction box 642 may reduce the adjustment motor speed 640 to several RPM (e.g., 7-10 RPM). The adjustment drive gear may be positioned at the bottom of the stroke adjustment assembly 638, although such is not required. A rubber bumper 609 may be located proximate to the eccentric drive axle 606 at each end of aperture 668 such that when the largest or shortest stroke is achieved, the rubber bumpers 609 may cushion force exchange from device components as the adjustment motor 640 comes to a stop.

Gear teeth at a perimeter of the head of the stroke adjustment screw 630 may be in mechanical communication with gear teeth of the ring gear 695. Rotation of the ring gear 695 by the adjustment drive gear 646 may thus cause rotation of the stroke adjustment screw 630 to cause repositioning of the eccentric drive axle 606 within the aperture 668 to adjust stroke of the piston 612. A positioning sensor 626 may be spaced apart from (to prevent interference with the connecting rod 618) and positioned adjacent to the drive assembly 615. The positioning sensor 626 may include an optical sensor, an ultrasound sensor, some combination thereof, or the like. The positioning sensor 626 may be configured to determine stroke of the piston 612 based on a detected distance between the connecting rod 618 and the center 675 of the eccentric drive 620. A ball detent 632 at the brake rotor 634 may lock the stroke adjustment screw 630 in position while the device 600 is in operation (i.e., the ball detent 632 may prevent the head of the stroke adjustment screw 630 from rotating while the motor 666 is operating).

The brake rotor 634 may be linked to the motor 666 by way of the eccentric drive 620. The brake rotor 634 may be configured to prevent the motor 666 from spinning when the pawl 644 is engaged in a notch 636 of the brake rotor. The positioning of the pawl 644 in the notch 636 may lock the eccentric drive 620, which is positioned at (e.g., fastened to) the brake rotor 634, in place. The locking of the eccentric drive 620 by way of positioning the pawl 644 in the notch 636 may prevent motor 666 rotation while stroke of the piston 612 is being adjusted (e.g., to allow the adjustment drive gear 646 to engage with the ring gear 695). The brake rotor 634 may include two notches (e.g., located 180 degrees apart from one another at the perimeter of the brake rotor 634). Each notch may be sized to securely receive the pawl 644. The pawl 644 may be linked to a pawl spring 663 configured to keep the pawl 644 biased towards the brake rotor 634. Variations to the shape, size and/or number of the brake rotor, pawl, and notch may be made without departing from the scope of the present invention.

The micro switch 624 at the stroke adjustment assembly 638 may be configured to sense the pawl 644 position, and communicate the pawl 644 position to a processor. For example, the micro switch 624 may communicate to a PCB that the pawl 644 is engaged in the notch 636. The pawl stop 662 may be positioned adjacent to the pawl 644, and may be configured to prevent the pawl 644 from contacting the brake rotor 634 when the motor 666 is active and percussive therapy is occurring (when the stroke adjustment assembly 638 is retracted from the drive assembly 615). The servo motor 658 may move the servo arm 654, which may engage the servo arm receiver 648 at the adjustment arm 652 (slidably connected to the servo arm 654) to reposition the stroke adjustment assembly 638. When a user and/or system program dictates that stroke is to be adjusted, the adjustment servo 660 may cause the stroke adjustment assembly 638 to be repositioned such that the adjustment drive gear 646 is moved to engage the ring gear 695. Before the motor 666 is activated and percussive therapy begins, the adjustment servo 660 may cause stroke adjustment assembly 638 to be repositioned such that the adjustment drive gear 646 is moved away from the ring gear 695.

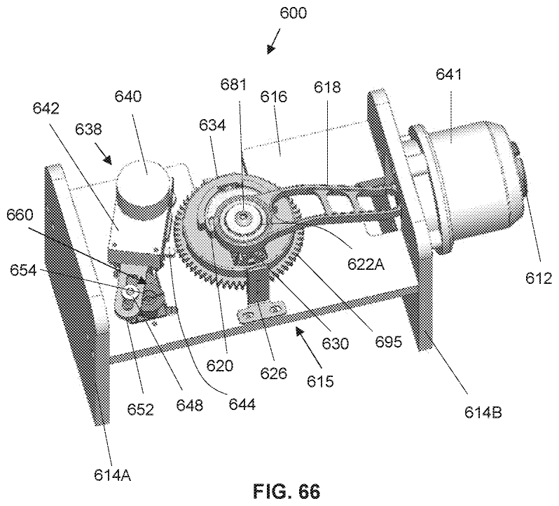

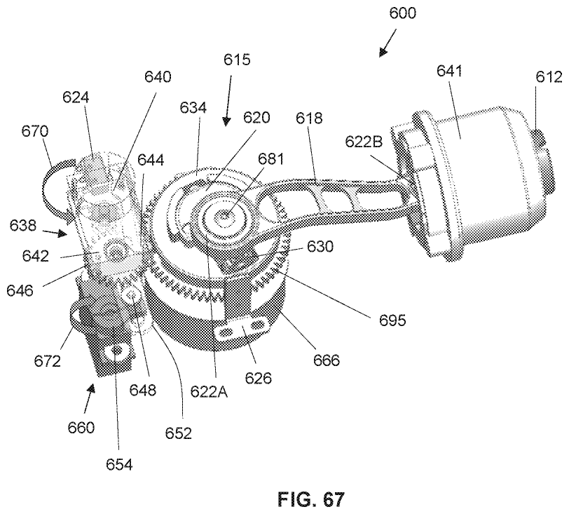

In the FIG. 66 example, the adjustment motor 640 has been moved away from the drive motor 666, and the adjustment drive gear 646 is spaced apart from the ring gear 695. Here, the adjustment servo arm 654 is in a retracted position, and the drive assembly 615 is free to move to cause reciprocal motion of the piston 612. In the FIG. 67 example, a first arrow 670 demonstrates rotation of the stroke adjustment assembly 638. A second arrow 672 demonstrates rotation of the adjustment servo arm 654. As the adjustment servo arm 654 is rotated 672 (e.g., 180 degrees to a position closer to the motor 666), the stroke adjustment assembly 638 may be moved 670 to allow the adjustment drive gear 646 to engage the ring gear 695. Rotation of the adjustment motor 640 may cause the adjustment drive gear 646 to rotate the ring gear 695 to adjust stroke of the piston 612. In this particular example, the pawl spring causes the pawl 644 to deflect while maintaining contact with the side of the brake rotor 634 (before aligning the pawl 644 with a notch in the brake rotor).

Referring again to FIGS. 63-71, the motor 666 may be rotated slowly (e.g., by way of pulsed power to the motor 666) to promote alignment of the notch 636 with the pawl 644 for locking the eccentric drive 620. As the motor 666 rotates slowly, simultaneously, an electronic current sensor circuit may monitor amperage to the motor 666. As the motor 666 rotates slowly, the stroke adjustment screw 630 may turn, causing movement of the eccentric drive axle. As the motor 666 rotates slowly, the adjustment motor 640 may cause the adjustment drive gear 646 to rotate at the same rate as a beveled portion of the ring gear 695 (to prevent turning of the stroke adjustment screw 630 while the motor 666 rotates, which might otherwise cause damage to the device 600). The motor 666 may rotate slowly until a tooth of the pawl falls into a notch of the brake rotor 634 to stop the brake rotor 634 and thus stop the eccentric drive 620 and motor 666 linked to the brake rotor 634. Referring again to FIGS. 63-71, the adjustment drive gear 646 may be rotated, causing the ring gear 695 to rotate. If pawl 644 is not engaged in notch 636, then the motor 666, brake rotor 634 and eccentric drive 620 may be caused to rotate (because the ring gear 695 may be rotationally coupled to the eccentric drive 620 by the ball detents 632). The brake rotor 634 may rotate slowly until a tooth of the pawl 644 falls into the brake rotor 634 to stop the brake rotor 634, and thus stops the eccentric drive 620, and motor 666 linked to the brake rotor 634. The present invention is not limited to any particular device or mechanism for locking and unlocking drive components.

Referring specifically to FIG. 63, the device 600 may include a target 602 at or near a proximal end of the connection rod 618, proximate the eccentric drive axle 606. The positioning sensor 626 may detect a change in the physical position of the target 602 relative to the sensor 626. The positioning sensor 626 may emit and/or detect a signal, and the target 602 may reflect, interrupt, modify, some combination thereof, or the like the signal. The positioning sensor 626 may determine the position of the target 602 (and thus the distance from the connecting rod 618 to the centerline 675 to determine the stroke of the piston 612) based on the reflected, interrupted and/or modified signal, which may be registered by the sensor 626. The positioning sensor 626 may be in electronic communication with a processor 603 and user interface 607.

Referring specifically to FIGS. 63 and 68-69, as the pawl 644 engages the notch 636, the pawl 644 may rotate to activate the micro switch 624 (e.g., a leg at the end of the pawl 644 may engage the micro switch to cut motor 666 power). The micro switch 624, once activated, may send a signal to the processor (e.g., a microprocessor), which may cause the power to the motor 666 to be cut. Thus, the micro switch 624 may ensure that power is not being supplied to the motor 666 as the pawl 644 engages the notch 636 to lock the eccentric drive 620. This particular mechanical brakeage locking mechanism may prevent slipping of gears and/or other unwanted movement of gears. Additionally, or alternatively, a sensing circuit may cut power to the motor after amperage to the motor 666 increases. A microcontroller and/or other processing circuitry may be configured to verify that the motor 666 is not powered before stroke adjustment is allowed to occur.

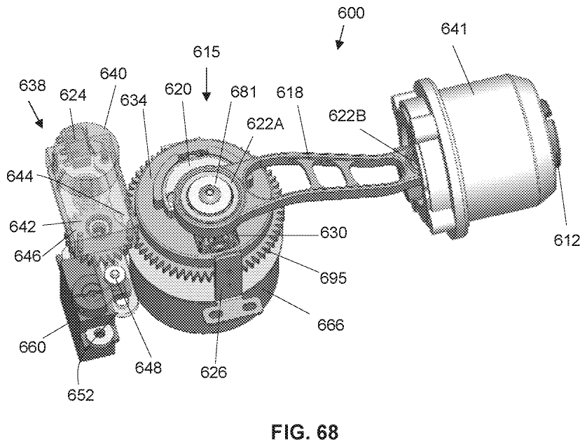

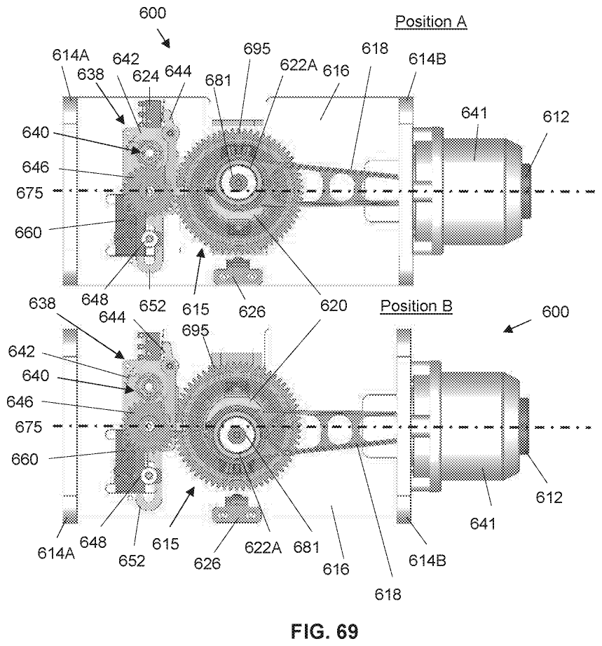

In the FIGS. 68-69 example, the notches 636 in the brake rotor 634 are positioned such that when the pawl 644 is engaged in a notch, the eccentric drive axle 606 is at a maximum distance to the left (when viewed from the rear of the device 600) (“Position A,” as shown in the top example of FIG. 69) or to the right (“Position B,” as shown in the bottom example of FIG. 69) of the centerline 675 of piston 612 motion. A target 602 may be located on the right side of the connecting rod 618 in Positions A and B, at about 90 degrees from the centerline 675. In Position A, the eccentric drive axle 606 may be at a position farthest from the positioning sensor 626. In Position B, the eccentric drive axle 606 may be at a position closest to the positioning sensor 626. Positions A-B may be the two possible positions of the eccentric drive axle 606 when the pawl 644 is engaged in a notch 634. Here, in both Positions A-B, the target 602 is directly in front of the positioning sensor 626. The microcontroller may include or be in electronic communication with a current sensor configured to monitor current of the motor 666. As current increases, the power to the motor may be turned off. Here, because there are two notches 634 in the brake rotor 634 and the brake rotor 634 is keyed to the eccentric drive 620, the connecting rod 618 position is always known, and the gear interface may lock in one of two positions. The two notches 634 may be 180 degrees apart from one another, such that the brake rotor 634 need not rotate more than 180 degrees to align a notch 634 with the pawl 644 (allowing for faster positioning of the pawl 644 at the notch 634). A switch may be provided (e.g., a mechanical micro-switch, electronic sensor, some combination thereof, or the like) to recognize and communicate to the microcontroller when the pawl 644 is engaged. Although a mechanical brakeage mechanism (involving the pawl 644 and notch 634) is employed here, an alternative brakeage mechanism such as friction braking (e.g., friction braking is illustrated in FIG. 62) may be employed in other embodiments.

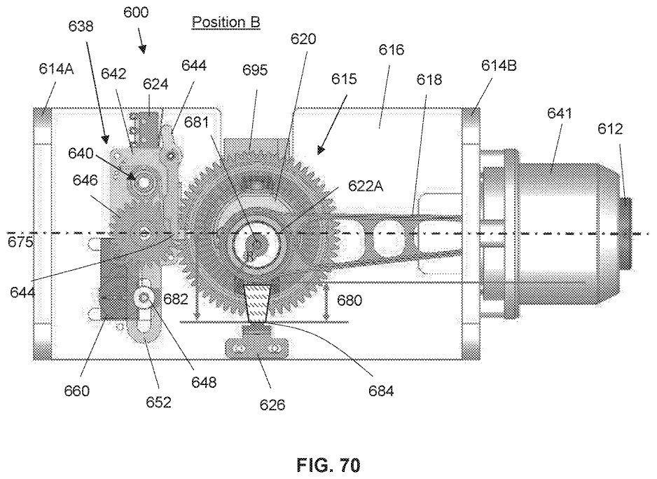

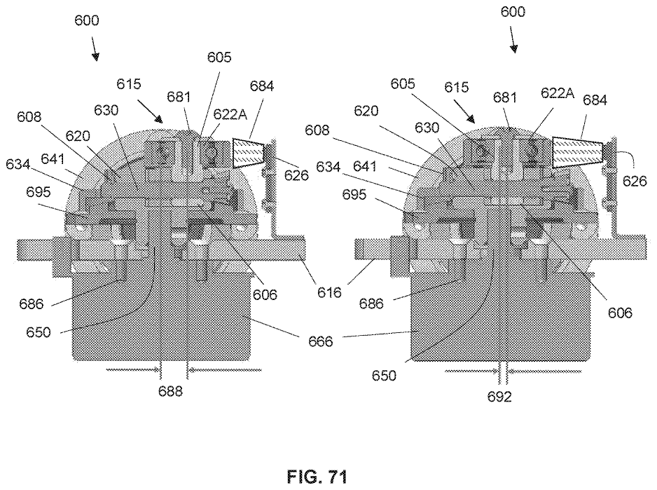

Referring to FIGS. 63 and 70, the distance 682 between the centerline 675 of piston motion of the device 600 and the positioning sensor 626 is shown. The radius R (radius of the proximal end of the connecting rod 618) is also shown. The distance 680 from the target 602 to positioning sensor 626 is also shown. A field of vision 684 of the positioning sensor 626 is also illustrated here. In the FIG. 70 example, the eccentric drive axle 606 is in Position B. The processor may be configured with software instructions to execute an algorithm where Offset=0.5*Stroke, and Offset=Y−R−X, where Y=the distance 682 between the centerline 675 of piston motion of the device 600 and the positioning sensor 626 (fixed), R=the radius of the proximal end of the connecting rod 618 (fixed), and X=the variable distance 680 from the target 602 to positioning sensor 626, said distance measured by the positioning sensor 626 (e.g., in conjunction with a microcontroller). The processor may determine that if X>Y, the eccentric drive axle 606 is to the left of the centerline 675 (Position A), and Stroke=2(X−Y). The processor may determine that if X<Y, the eccentric drive axle 606 is to the right of the centerline 675 (Position B), and Stroke=2(Y−R−X). The processor may, by calculating the stroke of the device, be able to communicate the stroke to the user, and/or adjust the stroke until the stroke meets a user and/or programed specified stroke.

Referring specifically to FIG. 71, cross sectional views of the device 600 having a positioning sensor 626 with a field of vision 684 are shown. When the eccentric drive 620 is locked (e.g., by a pawl in a notch of the brake rotor 634) and the piston is stopped, an original stroke setting may be measured by the positioning sensor 626. The original stroke setting may be compared to a desired stroke setting (e.g., provided by a user or a program). If the processor determines (from the measurement of the positioning sensor 626) that the original stroke is less than the desired stroke, the processor may cause the ring gear 695 to be rotated a first direction (e.g., clockwise) to increase the stroke. Said rotation may be caused by supplying a correct electrical polarity to the adjustment motor. If the processor determines (from the measurement of the positioning sensor 626) that the original stroke is greater than the desired stroke, the processor may cause the ring gear 695 to be rotated a second direction (e.g., counterclockwise) to reduce the stroke (in the FIG. 71 example, this is demonstrated by movement of the eccentric drive axle 606 from a first position 688 to a second position 692). Said rotation may be caused by supplying a correct electrical polarity to the adjustment motor.

Referring to FIGS. 63 and 71, as the ring gear 695 is rotated, the positioning sensor 626 may measure the distance from the sensor 626 to the target 602, and calculate the stroke in conjunction with a microcontroller and/or other processing circuitry. When the desired stroke is achieved, the adjustment motor 640 is stopped (e.g., by the microcontroller and/or other circuitry). After the adjustment motor 640 is stopped, the adjustment servo 660 may retract the stroke adjustment assembly 638 away from the drive assembly 615, and the pawl 644 may thus be disengaged from the notch 636 of the brake rotor 634 to allow percussive operation of the device 600 to commence.

Referring again to FIGS. 63-71, the stroke of the piston 612 may be two times offset with respect to the distance of the centerline of the eccentric drive axle 606 from the centerline of the motor. A 180-degree rotation of the eccentric drive may cause movement of the piston 612 from a retracted to extended position, and vice versa. A plurality of 360-degree rotations of the eccentric drive 620 may cause reciprocal motion of the piston 612 sufficient to provide percussive therapy. The stroke range may be altered by adjusting the diameter of the eccentric drive 620 (e.g., the aperture 668 length in FIG. 63 represents stroke adjustment range). The stroke range of 0 to 16 mm is preferred, but multiple different stroke ranges are obtainable with the present invention.

The user interface may be provided at an electronic display screen (e.g., a touch LCD screen at the rear of the device 600). The stroke of the piston 612 determined by the positioning sensor 626 may be displayed at the user interface. A user may interact with the user interface to regulate stroke. For example, the user may enter a desired stroke at a touch LCD screen at the rear of the device 600, and the processor may adjust stroke until the positioning sensor 626 determines that the user specified stroke has been achieved. Once achieved, the servo motor 658 may be reversed to move the stroke adjustment assembly 638 away from the drive assembly 615 (causing the pawl 644 to be disengaged from the brake rotor 634), and percussive therapy may commence. The user may interact with the user interface to regulate duration of percussive therapy, frequency of percussions, vibrations, some combination thereof, or the like. Various different methods may be employed to permit a user to regulate the stroke adjustment assembly 638 to adjust stroke. Although a touch screen is preferred, a dial, slider, or other input means may be provided in addition or as an alternative to a touch screen.

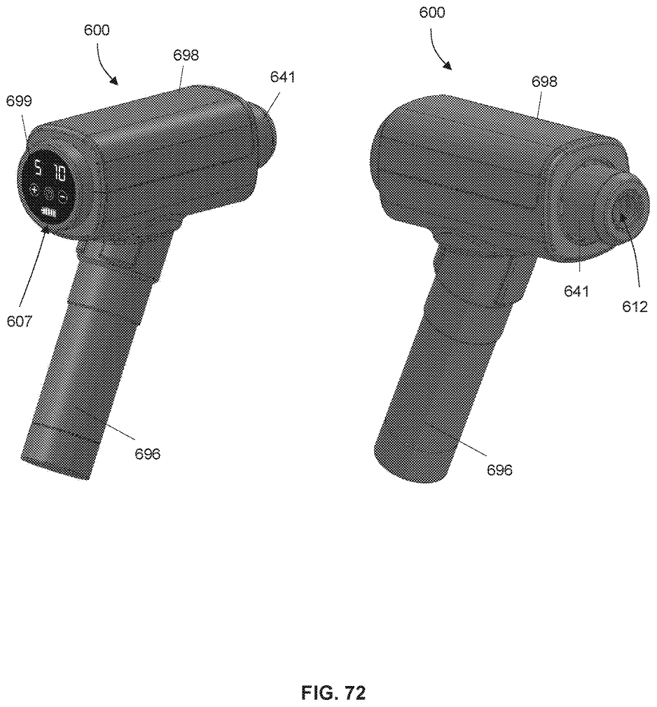

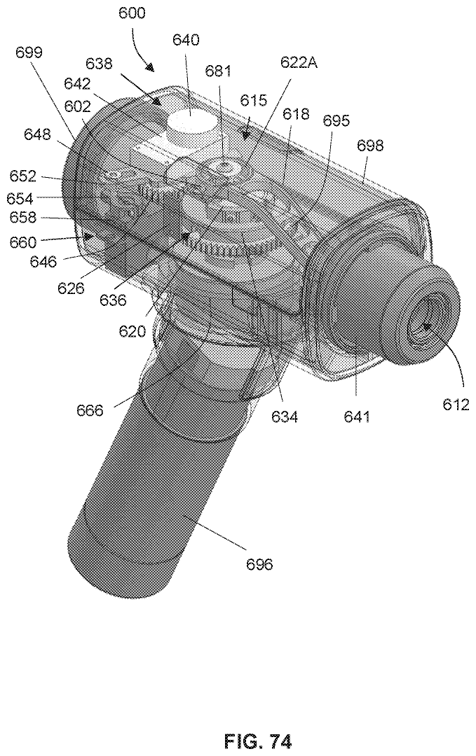

FIGS. 72-74 illustrate an exemplary digital display 699 of the device 600. The device 600 may comprise a positioning sensor 626, drive assembly 615 (having, e.g., an eccentric drive unit 620, brake rotor 634 having one or more notches 636, ring gear 695, and motor 666), stroke adjustment assembly 638 (having, e.g., an adjustment motor 640, gear reduction box 642, adjustment drive gear 646, adjustment arm 652, and servo arm receiver 648), adjustment servo 660 (having, e.g., an adjustment servo arm 654 and servo motor 658), piston 612, connecting rod 618 (e.g., having a target 602, bearings 622A-B, and engaged by securing apparatus 681 and piston connector 680) and piston bushing 641. The device may also include a housing 698 configured to surround and protect interior components of the device 600. The device may also include a handle 696 configured to allow a user to hold the device 600 with one or more hands for administering percussive therapy. A battery may be located at the handle 696, and may provide power to the motor 666 and/or other device components (e.g., the digital display 699).

The digital display 699 may include one or more electronic display screens, such as, for example, a touch LCD screen. The digital display 699 may be in electronic communication with one or more processors. The one or more processors may be internal and/or external to the device 600. The digital display 699 may allow a user to interact with a user interface 607. The user interface 607 may be in communication with the positioning sensor 626, drive assembly 615, stroke adjustment assembly 638, adjustment servo 660, some combination thereof, or the like. Although not required, the digital display 699 is preferably located at the rear of the device 600. An exemplary digital display is not limited to any particular shape and/or size.

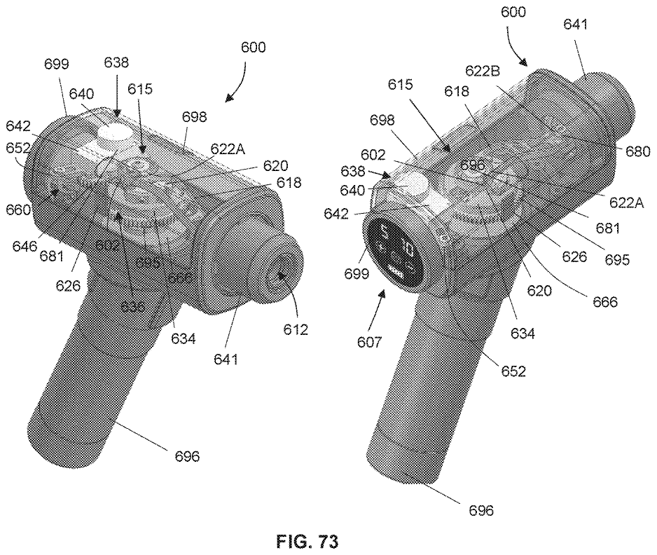

In the embodiment shown, the user interface 607 includes a speed adjustment option (e.g., the user may select the “5” here to adjust the speed of the piston, such as on a scale of 1-10) and stroke adjustment option (e.g., the user may select the “10” here to adjust the stroke of the piston, such as on a scale of 1-10). The user may increase the speed and/or stroke of the piston by touching a plus sign icon at the user interface 607. The user may decrease the speed and/or stroke of the piston by touching a minus sign icon at the user interface 607. The display screen 699 may be powered by a battery located in the device 600 (e.g., in the handle 696). The user interface 607 may indicate the state of charge of the battery (in the specific example of FIGS. 72-73, the user interface 607 indicates the battery is fully charged). The user interface 607 may include a power button that a user may touch to power on or off the display 699 and/or device 600.

Referring to FIGS. 63-74, advantages of this particular embodiment include, for example, the ability of a user to adjust stroke using a user interface, such as a digital user interface (e.g., the user using a touch screen to select stroke length/throw electronically), the ability of stroke to be adjusted automatically (using servos, motors, sensors, and/or switches), the ability of the device to automatically adjust stroke to accurately meet a user and/or program specified stroke, improved braking of the eccentric drive for stroke adjustment, ability of the user to adjust stroke without manually adjusting device components, some combination thereof, or the like. A massage attachment (not shown) may be linked to a distal end of the piston 612. Certain gears may be beveled (e.g., for ease of meshing during adjustment). An exemplary device is also not limited to any particular type or number of positioning sensors. Certain sensors (e.g., positioning sensors) may include a Hall effect sensor. The motor 666 may be configured to be adjusted to regulate frequency. Adjustment of amplitude and/or frequency may occur in real time. Multiple different amplitudes are obtainable. Variations to the stroke adjustment assembly and other device components may be made without departing from the scope of the present invention.

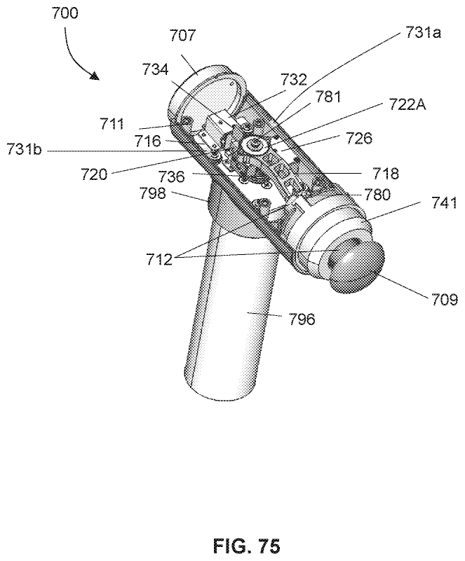

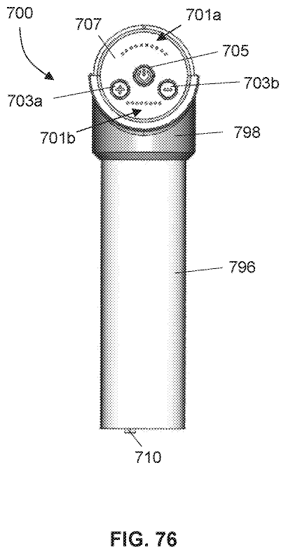

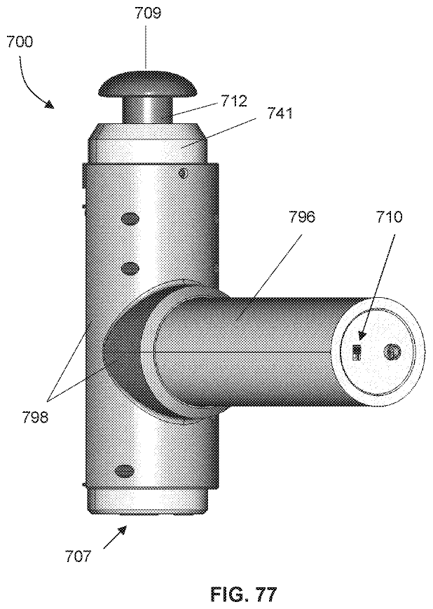

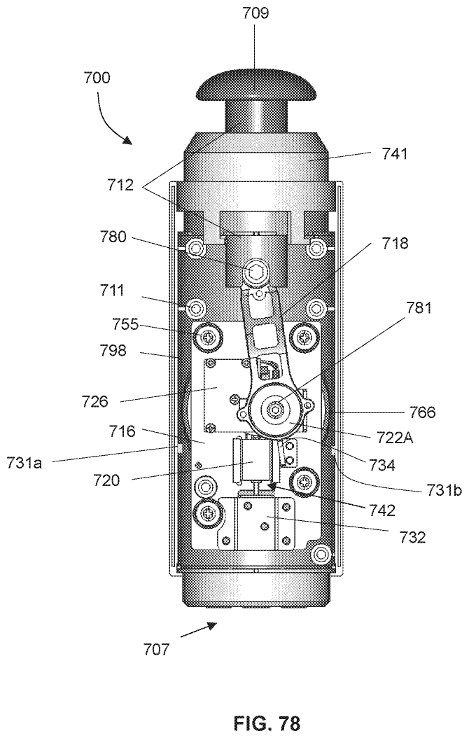

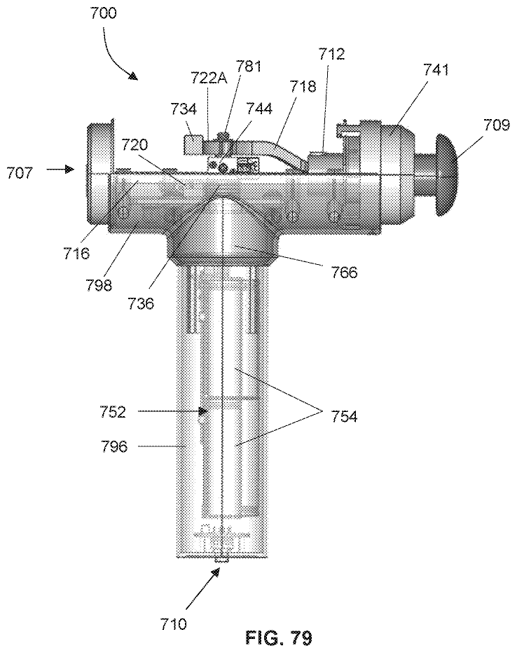

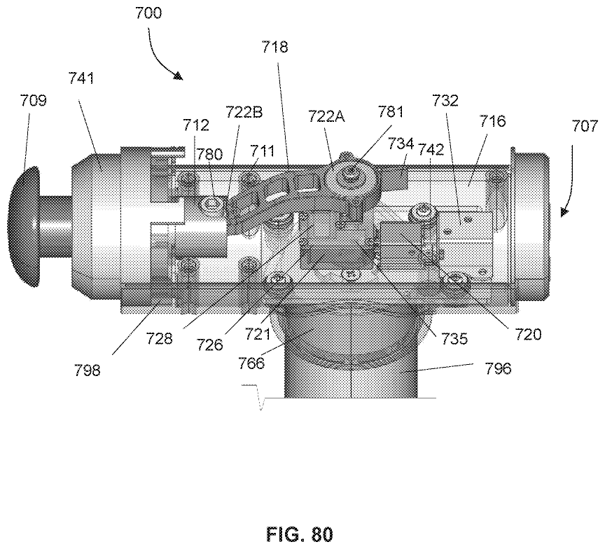

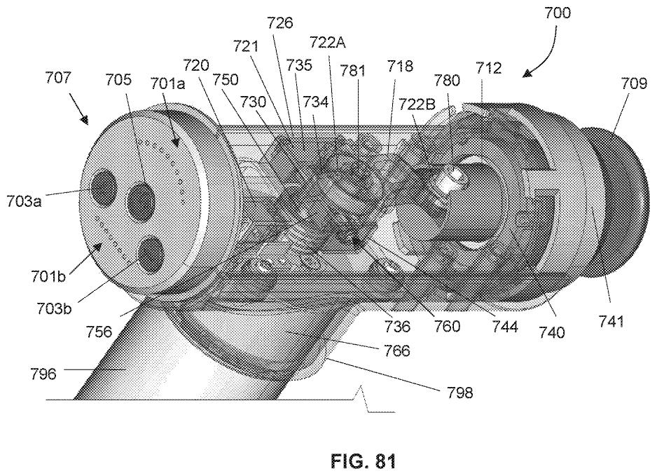

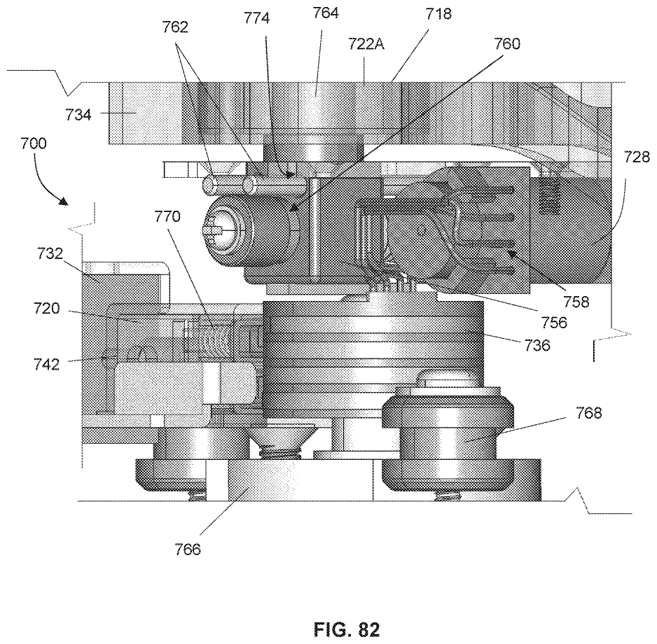

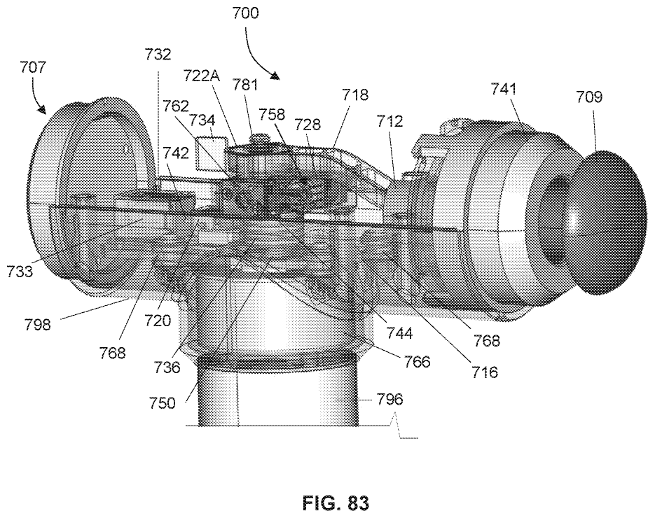

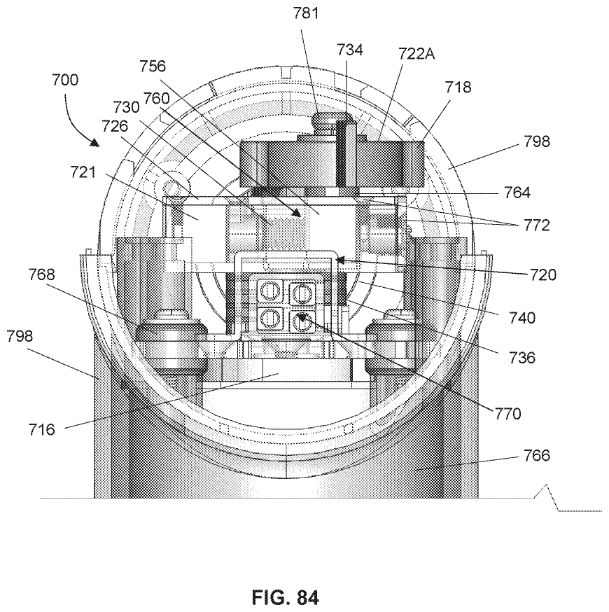

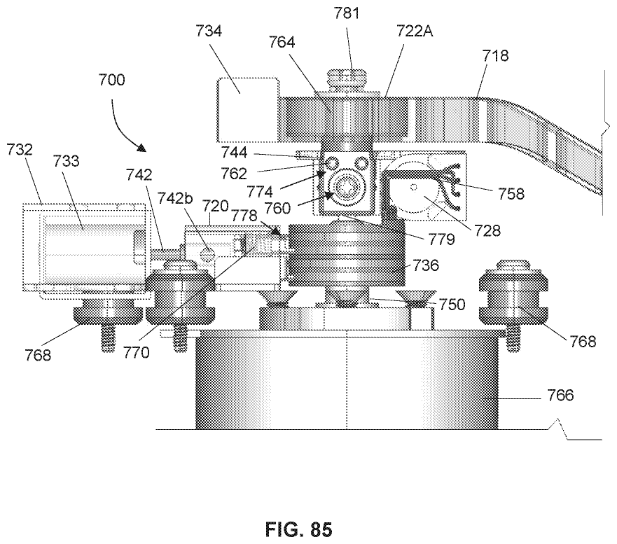

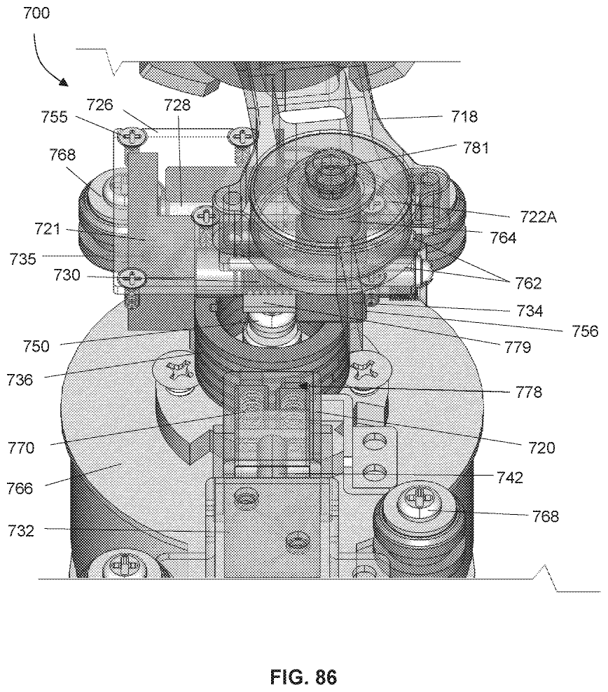

Referring now to FIGS. 75-86, an alternative exemplary adjustable amplitude percussive therapy device 700 is shown. The device 700 may include a motor 766, motor shaft 750, connector box 732, solenoid (e.g., comprising solenoid unit 720, solenoid rod 742, springs 770, and/or linkages 778), slip ring 736, intermediate rotation member 779, axle 764, connection rod 718, and piston 712. The motor 766, motor shaft 750, connector box 732, solenoid unit 720, slip ring 736, intermediate rotation member 779, axle 764, connection rod 718, and the like may be located within a housing 798. The device may also include a handle 796 configured to allow a user to hold the device 700 with one or more hands for administering percussive therapy.

One or more batteries 754 may define a power module 752 (e.g., in the handle 796) of the device 700, which may provide power to the motor 766, connector box 732, and/or other device components. The batteries 754 may be rechargeable, although such is not required. A charging port 710 (e.g., a USB-C port) may allow for the batteries 754 to be recharged. A frame 716 may be positioned within the housing 798 along with a number of fasteners (e.g., 755, 768, 772) and fastener channels (e.g., 711) for securing various device components within the device 700. Various different materials and/or methods may be employed for linking device components to one another without departing from the scope of the present invention.

The connection rod 718 may be substantially curved in shape (e.g., a first bearing 722A of the connection rod 718 may be positioned above a second bearing 722B thereof). The first bearing 722A (e.g., secured by securing apparatus 781, which may include a bolt and washer, and/or similar components) may be in mechanical communication with the axle 764, and the second bearing 622B may be in mechanical communication with the piston 712 (e.g., by way of a piston connector 780). The first bearing 722A may contact the axle 764, and the second bearing 622B may contact the piston connector 780. Reciprocal motion of the connection rod 718 may drive reciprocal motion of the piston 712. A massage attachment 709 may be connected to a distal end of the piston 712, such that the massage attachment 709 contacts a user during percussive therapy.

The connector box 732 may be configured to receive and route energy (e.g., from the power module 752) to a solenoid rod 742 (e.g., by way of mechanical unit 733). The solenoid rod 742 may extend to a solenoid unit 720. The solenoid rod 742 may, when energized, translate linearly to cause a distal region 742b of the solenoid rod 742 to activate one or more linkages 778. The linkages 778 may comprise a plurality of pins (e.g., four pins) configured to contact the slip ring 736. The activated linkages 778 may protrude to engage the slip ring 736 to transmit current thereto to activate the slip ring 736. The solenoid unit 720 may further include one or more coil springs 770 configured to retract each linkage 778 from the slip ring 736 to an initial position (e.g., when the solenoid unit 720 is deenergized). When the slip ring 736 is activated, one or more wires 758 extending from the slip ring 736 may transmit electricity to a gear motor 728. In alternative embodiments, current may be directed to the gear motor 728 from a different source than the slip ring 736.

The gear motor 728, which may be powered by the wires 758 leading from the slip ring 736, may be in mechanical communication (e.g., by way of an intermediate gear 721) with a lead screw 730. The lead screw 730 may comprise a shaft having a plurality of external threads. The lead screw 730 may extend from the gear box 726 to a distal frame 744. The gear motor 728 may cause motion of the intermediate gear 721, which may in turn cause rotation of the lead screw 730 in a clockwise or counterclockwise direction. The gear motor 728 and intermediate gear 721 may each be positioned in a gear box 726. Rotation of the lead screw 730 in the clockwise or counterclockwise direction may cause horizontal movement of a base unit 756 connected to (e.g., formed to) the axle 764. For example, clockwise rotation of the lead screw 730 may cause horizontal movement of the base unit 756 and axle 764 in a first direction, and counterclockwise rotation of the lead screw 730 may cause horizontal movement of the base unit 756 in a second direction opposite the first direction.

The motor 766 may include a motor shaft 750. The power module 752 may provide power to the motor 766 to allow for spinning of the motor shaft 750. The motor shaft 750 may spin at as high as approximately 3000 RPM, though such is not required. The motor shaft 750 may be in mechanical communication with the base unit 756 and axle 764 by way of the intermediate rotation member 779. The intermediate rotation member 779 may comprise a rigid member oriented substantially orthogonal to the motor shaft 750. Spinning of the motor shaft 750 may cause rotation of the intermediate rotation member 779, which may in turn cause rotation and/or orbital motion of the base unit 756 and axle 764 (e.g., motion off-center from the motor shaft 750). Off-center rotation and/or orbital motion of the axle 764 may in turn cause reciprocal motion of the connecting rod 718 secured (e.g., substantially orthogonally) to the axle 764. Reciprocating motion of the connecting rod 718 may drive reciprocating motion of the piston 712 within a piston bushing (e.g., internal bushing 740 and external bushing 741). As the intermediate rotation member 779 rotates, the gear box 726 and lead screw 730 may rotate with the base unit 756 and axle 764 in the same direction as the intermediate rotation member 779.

The slip ring 736 may prevent tangling, damage, and the like to the wires 758 leading therefrom to the gear motor 728 as the gear box 726 rotates. The lead screw 730 may extend through a main aperture 760 of the base unit 756. The main aperture 760 may include internal threads configured to be engaged by external threads of the lead screw 730, such that when the lead screw 730 rotates, the base unit 756 moves horizontally along a length of the lead screw 730. One or more guide rods 762 (e.g., extending from the gear box 726) may be positioned substantially parallel to the lead screw 730, and may each extend through one or more secondary apertures 774 of the base unit 756. The guide rods 762 may provide additional structural support to the base unit 756. The guide rods 762, base unit 756, axle 764, and the like may comprise one or more of a variety of different rigid materials.

The horizontal position of base unit 756 (and in turn, axle 764) with respect to the vertical axis centerline of the motor 766 may determine stroke of the piston 712. Stroke may be adjusted by horizontally repositioning the base unit 756 closer to or farther from the centerline of the motor 766. When the base unit 756 is aligned with the centerline of the motor 766 (in this particular embodiment, such would occur when the base unit 756 is at a central position along the length of the lead screw 730), the stroke of the piston is at or at least is about at 0 mm. When the base unit 756 is moved furthest from the centerline of the motor 766 (in this particular embodiment, such would occur when the base unit is farthest to the right or left from said central position along the length of the lead screw 730), the stroke of the piston is maximized (e.g., >20 mm). Thus, the stroke of the piston may be increased when the gear motor 728 causes the intermediate gear 721 to rotate the lead screw 730 clockwise or counterclockwise to move the base unit 756 further from the centerline of the motor 766. The stroke of the piston may be decreased when the gear motor 728 causes the intermediate gear 721 to rotate the lead screw 730 clockwise or counterclockwise to move the base unit 756 closer to the centerline of the motor 766.

Various different devices, materials, and/or techniques may be provided for regulating an exemplary lead screw and other device components. For example, a microcontroller may be provided to regulate various device components. Furthermore, the motor, lead screw, intermediate gear, gear motor, slip ring, solenoid unit, connector box, and/or other device components are not limited to any particular number, type, dimensions, shape, location, material composition and/or size.

A user interface 707 may be located at a rear face of the device 700. The user interface 707 may include a first group of lights 701a, a second group of lights 701b, a power button 705, an addition button 703a, and a subtraction button 703b. The first group of lights 701a may indicate stroke magnitude, and the second group of lights 701b may indicate battery state of charge, or vice versa. A user may interact with the user interface 707 to regulate stroke of the piston 712. For example, the user may select a plus sign button 703a to increase stroke of the piston 712 (e.g., by way of action of the connector box 732, solenoid 742, 778, slip ring 736, gear motor 728, intermediate gear 721, lead screw 730, and base unit 756), and the user may select a minus sign button 703b to decrease stroke of the piston 712 (e.g., by way of action of the connector box 732, solenoid 742, 778, slip ring 736, gear motor 728, intermediate gear 721, lead screw 730, and base unit 756). The power button 705 may be pressed by the user to power on or off the device 700. The user interface 707 may additionally or alternatively comprise an electronic display screen (e.g., a touch LCD screen). An exemplary user interface is not limited to any particular type, shape, size, and/or number of buttons, screens, lights, combinations thereof, and the like. Various different methods may be employed to permit a user to adjust piston stroke.

System processing circuitry (e.g., one or more processors, microcontrollers, some combination thereof, or the like) may also be in electronic communication with the connector box 732 (and/or other device components) to permit adjustment (e.g., automatic adjustment) of the piston 712 stroke. For example, system processing circuitry may dictate that during a treatment session, piston 712 stroke (and/or frequency) starts at a low magnitude, and automatically increases over time to increase blood flow and lactic acid breakdown. Piston 712 stroke and/or frequency may be adjusted in real time, including during active operation of the device 700. In this particular embodiment, stroke may be adjusted between an unlimited number of different amplitudes, including during active operation of the device 700 (while the motor shaft 750 is spinning). Other advantages of an exemplary embodiment include, for example, the compact nature of the device 700, and the low noise level of the device 700 while it is active.

The device 700 may include a laser range finder target 734 for allowing the stroke of the piston 712 to be determined. The laser range finder target 734 may comprise a rigid member in mechanical communication with the connection rod 718. For example, the laser range finder target 734 may comprise a rigid flag-shaped structure formed to or otherwise connected to a rear portion of the connection rod 718. The device 700 may further include one or more laser modules (e.g., a pair of laser modules 731a-b each located at an opposing side of the housing 798). The laser modules 731a-b may be positioned to be aligned with the target 734 when the target 718 is in a measurement position (e.g., when the lead screw 730 is positioned approximately perpendicular to the solenoid rod 742). The laser modules 731a-b may each be configured to emit a laser at the laser range finder target 734 to allow the distance of the target 734 from the laser module 731a, 731b (when the target 734 is in the measurement position) to be determined. The laser modules 731a-b may include one or more laser diodes, laser distance sensors, connection means (adhesive, clips, fasteners, some combination thereof, or the like) for attaching the modules 731a-b to the housing and/or another device 700 structure, some combination thereof, or the like.

The laser modules 731a-b may be in electronic communication with a microcontroller and/or other processing circuitry of the system 700. Each laser module 731a, 731b may communicate the distance of the laser range finder target 734 from the laser module 731a, 731b to the microcontroller and/or other processing circuitry. For example, each laser module 731a, 731b may measure (e.g., by way of an optical laser distance sensor when the target 734 is in the measurement position) a length of a beam extending from the module 731a, 731b to the target 734 to determine said distance. The microcontroller and/or other processing circuitry may compare the length of the beam emitted from the first module 731a to the length of the beam emitted from the second module 731b to determine the stroke of the piston 712.

The following algorithm may be employed by the system 700: S=|B1−B2|, i.e., the stroke(S) of the piston 712 equals the absolute value of the difference between the beam length (B1) of the laser emitted from the first laser module 731a when the target 734 is in the measurement position and the beam length (B2) of the laser emitted from the second laser module 731b when the target 734 is in the measurement position. As a specific, non-limiting example, when B1 is approximately 4 mm greater than B2 when the target 734 is in the measurement position, the vertical centerline of the base unit 756 (which may be aligned with and located proximate to the target 734) is approximately 2 mm offset to the right from the vertical centerline of the motor 766, and the stroke is approximately 4 mm. The offset distance of the vertical centerline of the base unit 756 from the vertical centerline of the motor 766 may be approximately half the value of the stroke. Thus, in the aforementioned example, when the vertical centerline of the base unit 756 is moved another 8 mm to the right to be approximately 10 mm offset to the right from the vertical centerline of the motor 766, the stroke of the piston is approximately 20 mm, which may be the maximum stroke of the piston 712 (though not required).

The system 700 may additionally or alternatively determine stroke of the piston 712 with only one laser module. For example, it may be known that the laser module (e.g., 731a) is a particular distance D in the x/horizontal dimension from the vertical centerline of the motor 766. The stroke(S) of the piston 712 may be calculated by taking the absolute value of the difference between the beam length (e.g., B1) of the laser emitted from the laser module (e.g., 731a) when the target 734 is in the measurement position and the distance D, and multiplying said value by two (to convert the offset distance to stroke value).

Alternatively, or additionally, the device 700 may include a motor encoder 735 for allowing stroke of the piston 712 to be determined. The encoder 735 may extrapolate data (e.g., from the slip ring 736, gear motor 728, intermediate gear 721, lead screw 730, some combination thereof, or the like) to allow the stroke to be determined. The encoder 735 may be located in the gear box 726, though such is not required. The encoder 735 may be located at a shaft (e.g., of the gear motor 728, intermediate gear 721, or the like).

The encoder 735 may comprise at least one sensor and encoder circuitry for receiving a measurement, and communicating said measurement to system 700 processing circuitry. System processing circuitry may correspond said measurement to a magnitude of lead screw 730 movement. The sensor may be an electromechanical sensor. The measurement may be an electrical current measurement. For example, the measurement may be a measurement of current at the slip ring 736, which the encoder 735 and/or other system circuitry may correspond to movement of the lead screw 730 (since current from the one or more wires 758 extending from the slip ring 736 may cause movement of the gear motor 728, which may cause corresponding movement of the intermediate gear 721, which may cause corresponding movement of the lead screw 730).

The system may correspond movement of the lead screw 730 to adjusted stroke of the piston 712. As a specific, non-limiting example, when the system 700 by way of the encoder 735 determines that the lead screw 730 has rotated to cause the vertical centerline of the base unit 756 to be moved from alignment with the vertical centerline of the motor 766 to a position approximately 10 mm offset to the right of the vertical centerline of the motor 766, the system 700 may calculate that the stroke of the piston has been increased by approximately 20 mm, and is now approximately 20 mm. The encoder 735 may be located at a box positioned in the gear box 726. The encoder 735 may include a magnet and coil, though such is not required.

The stroke of the piston 712 may be displayed at the user interface (e.g., 707). The user may adjust stroke of the piston 712, for example, while the motor 766 and connection rod 718 are stationary/powered off. In the aforementioned example, the linkages 778 may contact the slip ring 736 while the wires 758 extending from the slip ring 736 are stationary. Alternatively, or additionally, the user may adjust stroke of the piston 712 while the motor 766 and connection rod 718 are active. The user interface (e.g., 707) may allow the user to select a piston 712 stroke among a large number of different piston 712 stroke options. As a specific, non-limiting example, the piston 712 stroke may be adjusted from 0-16 mm in 0.5 mm increments (i.e., 32 different stroke options may be available). The present invention is not limited to any particular number of different stroke options.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers or specialized computing devices. The electronic devices may comprise one or more personal computers, smartphones, tablets, databases, servers, or the like, internal or external to the device, and when internal may be small or miniature in size. The electronic connections and transmissions described herein may be accomplished by wired or wireless means. The computerized hardware, software, components, systems, steps, methods, and/or processes described herein may serve to improve the speed of the computerized hardware, software, systems, steps, methods, and/or processes described herein.

What is claimed is:

1. An adjustable percussive therapy device, comprising:
a solenoid;
a slip ring;
a motor;
a connecting rod; and
a piston;
wherein the connecting rod is configured to engage in reciprocal motion to cause reciprocal motion of the piston; and
wherein the solenoid is configured to engage the slip ring to allow the motor to cause stroke of the piston to be adjusted.

2. The device of claim 1, further comprising a connector box, configured to route energy to the solenoid.

3. The device of claim 1, further comprising a second motor and an axle, wherein the second motor is configured to cause movement of the axle to cause the reciprocal motion of the connecting rod.

4. The device of claim 3, wherein the axle is in contact with the connecting rod.

5. The device of claim 4, wherein the connecting rod is curved between a distal and a proximal end thereof.

6. The device of claim 1, further comprising a user interface configured to allow a user to adjust the stroke of the piston between a plurality of different amplitudes.

7. An adjustable percussive therapy device, comprising:
a connector box;
a solenoid;
a slip ring;
a motor;
a lead screw;
a connecting rod; and
a piston;
wherein the connecting rod is configured to engage in reciprocal motion to cause reciprocal motion of the piston; and
wherein the connector box is configured to route energy to the solenoid to cause the solenoid to engage the slip ring to allow the motor to cause rotation of the lead screw to adjust stroke of the piston.

8. The device of claim 7, further comprising a second motor and an axle, wherein the second motor is configured to cause movement of the axle to cause the reciprocal motion of the connecting rod.

9. The device of claim 8, wherein the axle is connected to a base unit, and the base unit is configured to receive the lead screw.

10. The device of claim 9, wherein the lead screw is configured to, when rotated, adjust a horizontal position of the axle to adjust the stroke of the piston.

11. The device of claim 10, further comprising an intermediate gear configured to, when engaged by the motor, rotate the lead screw.

12. The device of claim 9, wherein the lead screw is configured to increase the stroke of the piston by moving the base unit further away from a centerline of the second motor, and the lead screw is configured to decrease the stroke of the piston by moving the base unit closer to the centerline of the second motor.

13. The device of claim 11, further comprising a gear box, wherein the motor and the intermediate gear are positioned inside the gear box.

14. The device of claim 8, wherein the second motor is positioned below the slip ring.

15. The device of claim 9, further comprising one or more guide rods configured to provide support to the base unit.

16. The device of claim 7, further comprising one or more springs at the solenoid.

17. The device of claim 7, wherein the piston is configured to be connected to a massage attachment.

18. The device of claim 7, further comprising at least one selected from the group of a laser range finder target and an encoder for allowing the stroke of the piston to be determined.

19. The device of claim 18, wherein the handle is configured to receive one or more batteries.

20. The device of claim 18, wherein the handle includes a charging port.
